(19) United States
(12) Patent Application Publication
(10) Pub. No.: US 2021/0200943 A1
(43) Pub. Date: Jul. 1, 2021

(54) WEBSITE IMPROVEMENTS BASED ON NATIVE DATA FROM WEBSITE BUILDING SYSTEM

(71) Applicant: WIX.COM LTD., Tel Aviv (IL)

(72) Inventors: Yuval Aviyam, Rishon Le Zion (IL); Yacov Gamliel, Ramat Gan (IL)

(73) Assignee: WIX.COM LTD., Tel Aviv (IL)

(21) Appl. No.: 17/135,555

(22) Filed: Dec. 28, 2020

Related U.S. Application Data
(60) Provisional application No. 63/046,538, filed on Jun. 30, 2020.
(60) Provisional application No. 62/992,469, filed on Mar. 20, 2020.
(60) Provisional application No. 62/955,525, filed on Dec. 31, 2019.

(51) Int. Cl. G06F 40/186; G06F 16/958; G06F 16/951; G06F 16/953; G06Q 30/02; G06F 40/143

(52) U.S. Cl. CPC G06F 40/186; G06F 16/972; G06F 16/951; G06F 40/143; G06Q 30/0251; G06Q 30/0277; G06Q 30/0276; G06F 16/953

(57) ABSTRACT

Disclosed embodiments relate to analyzing and recommending improvements for structural attributes of websites. Techniques may include hosting a first website, the first website being built based on at least a subset of the plurality of website building elements and a subset of the plurality of website design rules; identifying a plurality of structural attributes of the first website; identifying a vertical or template associated with the first website; and developing a recommended change to the first website based on the plurality of structural attributes of the first website and the vertical or template associated with the first website.

### CROSS-REFERENCE TO RELATED APPLICATIONS

This application claims the benefits of priority to U.S. Provisional Application No. 63/046,538, filed on Jun. 30, 2020; U.S. Provisional Application No. 62/992,469,filed on Mar. 20, 2020; and U.S. Provisional Application No. 62/955,525, filed on Dec. 31, 2019, the entirety of each of which are hereby incorporated by reference.

### TECHNICAL FIELD

Disclosed embodiments relate generally to website building systems with technological integration of various forms of electronic advertising. More particularly, various disclosed techniques relate to developing customized websites, promotional services and tools, and targeted advertisements. Disclosed techniques allow for both websites, and electronic advertisements, to be highly customized and targeted based on data available within the environment of a website building system.

Further disclosed embodiments relate to management and optimization of advertising campaigns. Websites may be associated with businesses of various forms that wish to conduct advertising, both online and through other media. According to the techniques described below, advertising campaigns can be managed through interaction between a website building system and a separate advertising platform. Through native website building system data, and native advertising platform data, the performance and content of advertising campaigns can be optimized. This optimization can occur both during the initial setup and creation of an advertising campaign, and on an ongoing basis as a campaign is deployed. The performance of the campaign can be tracked over time, compared to the performance of other similar campaigns. Further, the performance of the campaign can be compared on one or more different advertising platforms to compare

### BACKGROUND

Promotions of offerings provided by a website may take the form of advertisements generated by advertising platforms or advertisement exchanges, as well as various other types of content, such as promotional posts prepared by users or owners of the website. Such promotional content is often reliant on what data is publicly accessible and visible. These promotional efforts also do not consider structural attributes of websites (e.g., native data available only from the website development system) when preparing promotional content. Nevertheless, a deeper understanding of the website would help with the generation of promotional content more closely relevant to the website being promoted. Presently, this type of understanding based on native website building system data is unavailable. Also, the current forms of promotion for websites do not consider the behavior of users on the websites and similarly structured websites.

Accordingly, in view of these shortcomings in website development and targeted electronic advertising, there are several technological deficiencies in the art that give rise to needs for improved integration of promotional content generation systems and optimizing the content used for promotional content generation. There are technological needs for techniques that tightly integrate and share native information of a website (e.g., from a website building system) from a unified interface. Such integration should advantageously manage the website promotion and achieve promotional goals from visitors to the website.

### SUMMARY

Certain embodiments of the present disclosure relate to a website building system configured for analyzing and recommending improvements for structural attributes of websites. The website building system may include one or more website building databases storing at least a plurality of website building elements, and a plurality of website design rules; and one or more processors configured to execute software instructions to perform operations for analyzing the structural attributes of websites and developing recommendations for the websites. The operations include hosting a first website, the first website being built based on at least a subset of the plurality of website building elements and a subset of the plurality of website design rules, identifying a plurality of structural attributes of the first website, identifying a vertical or template associated with the first website, developing a recommended change to the first website based on the plurality of structural attributes of the first website and the vertical or template associated with the first website.

According to some disclosed embodiments, the operations may further include accessing a structural attributes database storing pluralities of verticals or templates and corresponding pluralities of structural attributes.

According to some disclosed embodiments, the plurality of structural attributes of the first website may include at least one of: a landing page, a contact page, a feedback page, a questions page, a press release page, a real-time communications interface, fillable form content, shopping cart data, text content, image content, or video content.

According to some disclosed embodiments, the plurality of structural attributes of the first website may include at least one of: backend code, backend site profile information, a backend database, calendar data, schedule data, catalog data, or search engine optimization metadata or keywords.

According to some disclosed embodiments, the recommended change may include modifying search engine optimization metadata or keywords for the first website.

According to some disclosed embodiments, the recommended change includes adding, removing, or modifying content to the first website.

According to some disclosed embodiments, the content may include at least one of: textual elements, graphical elements, video elements, layout formats, color formats, background formats, or the plurality of structural attributes.

According to some disclosed embodiments, the recommended change may include adding a web page to the first website.

According to some disclosed embodiments, the recommended change may include adding a communications interface to the first website.

According to some disclosed embodiments, the recommended change may be developed based on application of an artificial intelligence algorithm.

According to some disclosed embodiments, the recommended change may be developed based on a date and/or time.

Certain embodiments of the present disclosure relate to a non-transitory computer readable medium including instructions that, when executed by at least one processor, cause the at least one processor to perform operations for analyzing and recommending improvements for structural attributes of websites. The operations may include hosting a first website, the first website being built based on at least a subset of the plurality of website building elements and a subset of the plurality of website design rules, identifying a plurality of structural attributes of the first website, identifying a vertical or template associated with the first website, developing a recommended change to the first website based on the plurality of structural attributes of the first website and the vertical or template associated with the first website.

According to some disclosed embodiments, the operations may further include accessing a structural attributes database storing pluralities of verticals or templates and corresponding pluralities of structural attributes.

According to some disclosed embodiments, the plurality of structural attributes of the first website may include at least one of: a landing page, a contact page, a feedback page, a questions page, a press release page, a real-time communications interface, fillable form content, shopping cart data, text content, image content, or video content.

Certain embodiments of the present disclosure relate to a computer implemented method for analyzing and recommending improvements for structural attributes of websites. The method may include hosting a first website, the first website being built based on at least a subset of the plurality of website building elements and a subset of the plurality of website design rules, identifying a plurality of structural attributes of the first website, identifying a vertical or template associated with the first website, developing a recommended change to the first website based on the plurality of structural attributes of the first website and the vertical or template associated with the first website.

According to some disclosed embodiments, the recommended change may include adding a web page to the first website.

According to some disclosed embodiments, the recommended change may include adding a communications interface to the first website.

According to some disclosed embodiments, the recommended change may be developed based on application of an artificial intelligence algorithm.

According to some disclosed embodiments, the recommended change may be developed based on a date and/or time.

Certain embodiments of the present disclosure relate to a non-transitory computer readable medium including instructions that, when executed by at least one processor, cause the at least one processor to perform operations for developing cross-medium electronic advertisements. The operations may include hosting a first website, the first website being built based on at least a subset of the plurality of website building elements and a subset of the plurality of website design rules, identifying a plurality of structural attributes of the first website, developing an advertising profile for the first website, the advertising profile being based on at least the subset of the plurality of website building elements, the subset of the plurality of website design rules, and the plurality of structural attributes, accessing an inventory of non-website advertisement formats, matching the advertising profile with the inventory of non-web site advertisement formats, and identifying, based on the matching, a recommended non-website advertisement.

According to some disclosed embodiments, the inventory of non-website advertisement formats may include identifications of influencers.

According to some disclosed embodiments, the influencers may be associated with a vertical or template of the first website.

According to some disclosed embodiments, the inventory of non-website advertisement formats may include scheduling meetings.

According to some disclosed embodiments, the inventory of non-website advertisement formats may include contacting customers.

According to some disclosed embodiments, the inventory of non-website advertisement formats may include identifications of advertisement creation firms.

According to some disclosed embodiments, the inventory of non-website advertisement formats may include identifications of advertising agencies.

According to some disclosed embodiments, the plurality of structural attributes of the first website may include at least one of: a landing page, a contact page, a feedback page, a questions page, a press release page, a real-time communications interface, fillable form content, shopping cart data, text content, image content, or video content.

According to some disclosed embodiments, the plurality of structural attributes of the first website may include at least one of: backend code, backend site profile information, a backend database, calendar data, schedule data, catalog data, or search engine optimization metadata or keywords.

According to some disclosed embodiments, the advertising profile may be developed, at least in part, automatically by the website building system.

According to some disclosed embodiments, the advertising profile may be configurable by a user.

According to some disclosed embodiments, the non-website advertisement may be generated by a source other than the first website.

According to some disclosed embodiments, the non-website advertisement may be an advertisement for the first website.

According to some disclosed embodiments, the operations may further include tracking the identified non-website advertisement without tracking code.

According to some disclosed embodiments, the matching of the advertising profile with the inventory of non-website advertisement formats may include applying an artificial intelligence algorithm to the plurality of website building elements, the first subset of the plurality of website design rules, and the plurality of structural attributes.

Certain embodiments of the present disclosure relate to a non-transitory computer readable medium including instructions that, when executed by at least one processor, cause the at least one processor to perform operations for allowing users to generate customized websites and to integrate with electronic advertising platforms. The operations may include identifying a first website that was built using the website building system, determining an advertising parameter for the first website based on at least one of: at least one of the plurality of website building elements associated with the first website, at least one of the plurality of website design rules associated with the first website, at least one of the plurality of categories of different website verticals or templates associated with the first website, or at least one of the plurality of advertisement targeting parameters associated with the first website, accessing, from an interface of the website building system, an advertising parameter interface of the electronic advertisement platform, and transmitting, to the electronic advertisement platform, the advertising parameter for the first website for use by the electronic advertisement platform in developing one or more electronic advertisements customized for the first website.

According to some disclosed embodiments, the advertising parameter may define at least one of: age range, topic of interest, gender, economic status, income, race, educational level, purchase history, editing history, browsing history, personality, attitudes, opinions, lifestyles, interests, or geographic location.

According to some disclosed embodiments, the advertising parameter may be determined based on application of an artificial intelligence algorithm.

According to some disclosed embodiments, the artificial intelligence algorithm may be a statistical algorithm based on at least one of: the plurality of website building elements associated with a plurality of other websites, at least one of the plurality of website design rules associated with the plurality of other websites, and at least one of the plurality of categories of different website verticals or templates associated with the plurality of other websites.

According to some disclosed embodiments, the advertising parameter is determined based on application of a trending algorithm that considers current trends among a plurality of websites.

According to some disclosed embodiments, the plurality of website design rules is based on one or more templates that define at least one of: placement of webpage elements, sizing of webpage elements, or a webpage color scheme.

According to some disclosed embodiments, the plurality of website design rules may be based on templates.

According to some disclosed embodiments, the plurality of website design rules may be based on user-controlled editing with dynamic layout rules.

According to some disclosed embodiments, the plurality of website design rules may be automatically generated and included in the first website.

According to some disclosed embodiments, the one or more templates may define how the website building elements are integrated into webpages.

According to some disclosed embodiments, the plurality of categories of different website verticals or templates may define different industries, business types, or application areas.

According to some disclosed embodiments, the plurality of categories of different website verticals or templates may further include a plurality of sub-verticals or templates.

According to some disclosed embodiments, the plurality of categories of different website verticals or templates each may have a corresponding advertising parameter.

According to some disclosed embodiments, transmitting the advertising parameter may include modifying the advertising parameter to have a format accepted by the electronic advertisement platform.

According to some disclosed embodiments, the one or more electronic advertisements customized for the first website may be configured for display on the first website.

According to some disclosed embodiments, the one or more electronic advertisements customized for the first website may be configured for display on one or more websites other than the first website.

According to some disclosed embodiments, the one or more electronic advertisements customized for the first website are configured for display on the electronic advertising platform.

According to some disclosed embodiments, the display of the customized advertisements may include obtaining the customized advertisement from the electronic advertising platform; and modifying a format of the customized advertisement by the website building system.

Certain embodiments of the present disclosure relate to a non-transitory computer readable medium including instructions that, when executed by at least one processor, cause the at least one processor to perform operations for developing customized electronic catalogs for websites and to support catalog-based electronic advertisements. The operations may include receiving from a user an edit to a first editable catalog from the plurality of editable catalogs, the first editable catalog being based on a catalog schema, wherein the first editable catalog corresponds to a first website hosted by the website building system, and the user edit relates to at least one of: products identified on the first website, services identified on the first website, inventory identified on the first website, or events identified on the first website, updating the first editable catalog based on the user's edit, developing, based on the updated first editable catalog, an advertising parameter for the first website, and transmitting, to the electronic advertisement platform, the advertising parameter for the first website for use by the electronic advertisement platform in developing one or more electronic advertisements customized for the first website.

According to some disclosed embodiments, the operations may further include uploading or importing the first editable catalog.

According to some disclosed embodiments, the operations may further include automatically updating the first editable catalog without a specific update instruction from the user.

According to some disclosed embodiments, the developing the advertising parameter for the first website includes converting the updated first editable catalog into a format accepted by the electronic advertisement platform.

According to some disclosed embodiments, the developing the advertising parameter for the first website may include applying an artificial intelligence algorithm to data from the updated first editable catalog.

According to some disclosed embodiments, the advertising parameter may include a portion of the first editable catalog.

According to some disclosed embodiments, the transmitting the advertising parameter may occur in response to the updating of the first editable catalog.

According to some disclosed embodiments, the operations may further include identifying a change to content of the first website and automatically updating the first editable catalog.

According to some disclosed embodiments, the operations may further include updating, based on the automatically updated first editable catalog, an advertising parameter for the first website.

Certain embodiments of the present disclosure relate to a non-transitory computer readable medium including instructions that, when executed by at least one processor, cause the at least one processor to perform operations for collecting native website data for use in developing targeted advertisements. The operations may include identifying a first website hosted by the website building system, generating, for the first website, based on at least a subset of the plurality of website building elements that are associated with the first website, a custom electronic catalog, the custom electronic catalog being based on a catalog schema, identifying content from the custom electronic catalog based on the catalog schema, and transmitting, to the electronic advertisement platform, the identified content for use by the electronic advertisement platform in developing one or more electronic advertisements based on the identified content.

According to some disclosed embodiments, the identifying content from the custom electronic catalog may be performed based on an advertising parameter associated with the first website.

According to some disclosed embodiments, the identifying content from the custom electronic catalog may be performed based on a vertical or template associated with the first website.

According to some disclosed embodiments, the identifying content from the custom electronic catalog may be performed by applying an artificial intelligence algorithm to data from the catalog schema.

According to some disclosed embodiments, the one or more electronic advertisements may include the identified content.

According to some disclosed embodiments, the identified content may include at least one of: an image, a video, textual content, or an event.

According to some disclosed embodiments, the catalog schema of the custom electronic catalog may be generated in the generating step.

According to some disclosed embodiments, the catalog schema of the custom electronic catalog was previously created and may not be generated in the generating step.

According to some disclosed embodiments, the catalog schema of the custom electronic catalog may be a pre-generated schema.

According to some disclosed embodiments, the catalog schema of the custom electronic catalog may be generated by the website building system by analyzing the first website data.

According to some disclosed embodiments, the data analyzed by the website building system may include web page data, web page elements, backend database content, or calendar data.

Certain embodiments of the present disclosure relate to a non-transitory computer readable medium including instructions that, when executed by at least one processor, cause the at least one processor to perform operations for automatic integration between website development interfaces and separate electronic advertising interfaces. The operations may include identifying a first website generated based on at least a subset of the plurality of website building elements and a subset of the plurality of website design rules, accessing, through an interface of the website building system, an account creation interface of the electronic advertisement platform, and generating, for the first website, an advertising account at the electronic advertisement platform.

According to some disclosed embodiments, the one or more website building databases may further include a plurality of categories of different website verticals or templates.

According to some disclosed embodiments, the one or more website building databases may further include a plurality of advertisement targeting parameters.

According to some disclosed embodiments, the one or more website building databases may further include a plurality of advertisement targeting parameters.

According to some disclosed embodiments, the operations may further include receiving from the electronic advertisement platform an advertising pixel to be integrated into the first website.

According to some disclosed embodiments, the operations may further include transmitting to the electronic advertisement platform an electronic catalog associated with the first website.

According to some disclosed embodiments, the operations may further include transmitting to the electronic advertisement platform vertical or template information associated with the first website.

According to some disclosed embodiments, the operations may further include transmitting to the electronic advertisement platform demographic targeting information associated with the first website.

According to some disclosed embodiments, the demographic targeting information may be collected by the website building system and associated with the first website.

According to some disclosed embodiments, the demographic targeting information may be collected by a server in communication with the website building system.

According to some disclosed embodiments, the website building system may receive the demographic targeting information from an intermediary server.

According to some disclosed embodiments, the demographic targeting information may be collected from the first website.

According to some disclosed embodiments, the demographic targeting information may be collected from other websites with characteristics determined to be similar to the first website.

According to some disclosed embodiments, generating the advertising account at the electronic advertisement platform may include receiving, from a user associated with the first website, a user credential associated with the electronic advertisement platform.

According to some disclosed embodiments, the operations may further include synchronizing an attribute of the advertising account with an attribute of the first website.

According to some disclosed embodiments, the attribute of the advertising account may be determined to correspond to the attribute of the first website.

According to some disclosed embodiments, the correspondence may be determined through an artificial intelligence technique.

According to some disclosed embodiments, the corresponding attribute of the first website may include content identified in a catalog associated with the first website.

According to some disclosed embodiments, the corresponding attribute of the first website may include at least one of: a vertical or template category, a demographic attribute, or an editing history attribute.

Certain embodiments of the present disclosure relate to a non-transitory computer readable medium including instructions that, when executed by at least one processor, cause the at least one processor to perform operations for allowing users to adjust advertisement targeting parameters on a separate advertising platform. The operations may include hosting a first website, the first website being built based on at least a subset of the plurality of website building elements and a subset of the plurality of website design rules, generating an electronic advertisement targeting interface, the electronic advertisement targeting interface being associated with the electronic advertisement platform, receiving user input, within the electronic advertisement targeting interface, the user input identifying one or more changes to the advertisement targeting criteria associated with the first website, and transmitting, to the electronic advertisement platform, the one or more changes, wherein the electronic advertisement platform is configured to receive the one or more changes and update the advertisement targeting criteria associated with the first website.

According to some disclosed embodiments, the electronic advertisement targeting interface may include a plurality of pre-configured options for selecting the advertisement targeting criteria.

According to some disclosed embodiments, the transmitting, to the electronic advertisement platform, the one or more changes may include accessing an application programming interface associated with the electronic advertisement platform.

According to some disclosed embodiments, the transmitting, the advertisement targeting criteria may be based on structural attributes of the first website.

According to some disclosed embodiments, the website building system automatically may provide a set of the advertisement targeting criteria based on the structural attributes of the first website.

According to some disclosed embodiments, structural attributes of the first website may include at least one of: a website parameter, a template, a template hint, a vertical or template category, a demographic classification, or a geographic location.

According to some disclosed embodiments, the electronic advertisement targeting interface may further include user feedback metrics for the first website.

According to some disclosed embodiments, the user feedback metrics may include at least one of: likes, dislikes, recommendations, referrals, comments, redistribution, sharing.

According to some disclosed embodiments, the operations may further include classifying a first advertisement performance measure and a second advertisement performance measure in terms of a vertical associated with the first website.

According to some disclosed embodiments, the operations may further include associating the first website with a second website sharing a common vertical.

According to some disclosed embodiments, the transmitting to the electronic advertising platform, the one or more changes may occur in real-time in a continuous manner, or batch processing at periodic times, or on meeting a threshold requirement.

Certain embodiments of the present disclosure relate to a non-transitory computer readable medium including instructions that, when executed by at least one processor, cause the at least one processor to perform operations for assembling and dynamically previewing electronic advertisements generated by a separate advertising platform. The operations may include hosting a first website, the first website being built based on at least a subset of the plurality of website building elements and a subset of the plurality of website design rules, generating an electronic advertisement preview interface associated with the advertising platform, receiving user input specifying one or more advertisement targeting criteria associated with the first website, transmitting, to the advertising platform, the one or more advertisement targeting criteria, receiving, from the advertising platform, data corresponding to an electronic advertisement, wherein the advertising platform is configured to transmit the electronic advertisement to third-party advertising targets based on the one or more advertisement targeting criteria, and generating, within the electronic advertisement preview interface, a preview version of the electronic advertisement based on the data corresponding to the electronic advertisement.

According to some disclosed embodiments, the one or more advertisement targeting criteria may be based on a structural attribute of the first website.

According to some disclosed embodiments, the one or more advertisement targeting criteria may automatically be provided by the website building system.

According to some disclosed embodiments, the one or more advertisement targeting criteria may be based on one or more of the plurality of website building elements associated with the first website.

According to some disclosed embodiments, the one or more advertisement targeting criteria may be based on one or more of the plurality of website design rules associated with the first website.

According to some disclosed embodiments, the electronic advertisement preview interface may be integrated into a website development interface of the website building system.

According to some disclosed embodiments, the preview version of the electronic advertisement may be a simulation of an interface of the advertising platform.

According to some disclosed embodiments, the preview version of the electronic advertisement is a rendering, within the electronic advertisement preview interface, of an interface of the advertising platform.

According to some disclosed embodiments, the preview version of the electronic advertisement may be generated by an application programming interface in communication with the advertising platform.

Certain embodiments of the present disclosure relate to a non-transitory computer readable medium including instructions that, when executed by at least one processor, cause the at least one processor to perform operations for dynamically predicting electronic advertisement performance across a plurality of separate advertising platforms.

The operations may include hosting a first website, the first website being built based on at least a subset of the plurality of website building elements and a subset of the plurality of website design rules, generating a comparative advertisement interface, receiving user input specifying one or more advertisement targeting criteria associated with the first website, developing a first advertisement performance measure based on at least the one or more advertisement targeting criteria, the first advertisement performance measure based on at least historical data associated with a first advertising platform, developing a second advertisement performance measure based on at least the one or more advertisement targeting criteria, the second advertisement performance measure based on at least historical data associated with a second advertising platform, and displaying, in the comparative advertisement interface, a first representation of the first advertisement performance measure and a second representation of the second advertisement performance measure indicating an optimum advertisement performance.

According to some disclosed embodiments, the historical data associated with the first advertising platform and the historical data associated with the second advertising platform may be filtered based on the advertisement targeting criteria.

According to some disclosed embodiments, developing the first advertisement performance measure may include simulating running an electronic advertisement, based on the advertisement targeting criteria, on the first advertising platform.

According to some disclosed embodiments, developing the second advertisement performance measure may include simulating running the electronic advertisement, based on the advertisement targeting criteria, on the second advertising platform.

According to some disclosed embodiments, the first advertisement performance measure may be expressed in at least one of: impressions, clicks, purchases, conversions, or actions.

According to some disclosed embodiments, the first advertisement performance measure may be a key performance indicator for the first website.

According to some disclosed embodiments, the key performance indicator may be developed by the website building system.

According to some disclosed embodiments, the key performance indicator may be developed by at least one of the first or second first advertising platforms.

According to some disclosed embodiments, the operations may further include receiving the first advertisement performance measure and the second advertisement performance measure at an advertisement performance mediator resource.

According to some disclosed embodiments, the advertisement performance mediator resource may be configured to translate the format of the first advertisement performance measure and the second advertisement performance measure.

According to some disclosed embodiments, the advertisement performance mediator resource may be configured to conform the first advertisement performance measure and the second advertisement performance measure to a unified format.

According to some disclosed embodiments, the operations may further include generating a recommendation, based on the advertisement targeting criteria, between the first advertising platform and the second advertising platform.

According to some disclosed embodiments, the first advertisement performance measure and the second advertisement performance measure may be classified in terms of a revenue level associated with the first website.

According to some disclosed embodiments, the operations may further include associating the first website with a second website sharing a common revenue level.

According to some disclosed embodiments, the first advertisement performance measure and the second advertisement performance measure may be classified in terms of a vertical associated with the first website.

According to some disclosed embodiments, the operations may further include associating the first website with a second website sharing a common vertical.

According to some disclosed embodiments, the first advertisement performance measure associated with the advertisement may be used for recommending to a second website an advertisement channel or method used for the advertisement by the first advertising platform.

According to some disclosed embodiments, the recommending to the second website the advertisement channel or method may be based on a similarity of characteristics of the first website and the second website.

Certain embodiments of the present disclosure relate to a non-transitory computer readable medium including instructions that, when executed by at least one processor, cause the at least one processor to perform operations for collecting native website data for use in advertisement optimization. The operations may include hosting a first website, the first website being built based on at least a subset of the plurality of website building elements and a subset of the plurality of website design rules, collecting a diversity of different types of interaction data based on users' interactions with the first website, accessing a catalog associated with the first website, the catalog identifying at least one of: products identified on the first website, services identified on the first website, or events identified on the first website, determining, based on the collected diversity of different types of interaction data and the catalog, a recommended modification to advertising parameters associated with the first website, and presenting, in an interface of the website building system, the recommended modification to the advertising parameters associated with the first website.

According to some disclosed embodiments, the diversity of different types of interaction data may include at least one of: viewing data, clicking data, shopping cart data, purchase data, or download data.

According to some disclosed embodiments, the recommended modification may include selecting a particular product to advertise.

According to some disclosed embodiments, the recommended modification may include identifying a recommended demographic for an advertisement.

According to some disclosed embodiments, the recommended modification may pertain to at least one of: age range, topic of interest, gender, economic status, income, race, educational level, purchase history, editing history, browsing history, personality, attitudes, opinions, lifestyles, interests, or geographic location.

According to some disclosed embodiments, the operations may further include transmitting the recommended modification to the advertising parameters to an advertising platform.

According to some disclosed embodiments, the advertising platform may be configured to generate the advertisement based on the recommended modification to the advertising parameters.

According to some disclosed embodiments, the recommended modification may include identifying a recommended vertical or template for an advertisement.

Certain embodiments of the present disclosure relate to a non-transitory computer readable medium including instructions that, when executed by at least one processor, cause the at least one processor to perform operations for cross-website learning techniques for electronic advertisement performance improvements. The operations may include hosting a first website, the first website being built based on at least a subset of the plurality of website building elements and a subset of the plurality of website design rules, hosting a second website, the second website being built based on at least a second subset of the plurality of website building elements and a second subset of the plurality of website design rules, identifying a first electronic advertisement campaign associated with the first website, the first electronic advertisement campaign having at least a targeting criterion and a vertical or template criterion, analyzing a performance of the first electronic advertisement campaign, and developing, based on the analyzed performance, a recommendation for a second advertisement campaign associated with the second website.

According to some disclosed embodiments, the developing of the recommendation for the second advertisement campaign may be based on at least the targeting criterion and the vertical or the template criterion.

According to some disclosed embodiments, the developing of the recommendation for the second advertisement campaign may be based on the first website and the second website sharing a common vertical or template criterion.

According to some disclosed embodiments, the first advertisement campaign and the second advertisement campaign may share a common targeting criterion.

According to some disclosed embodiments, the operations may further include hosting a plurality of other websites, the plurality of other websites being built based on at least a third subset of the plurality of website building elements and a third subset of the plurality of website design rules.

According to some disclosed embodiments, the operations may further include developing, based on the analyzed performance, a recommendation for a third advertisement campaign associated with one or more of the plurality of other websites.

Certain embodiments of the present disclosure relate to a non-transitory computer readable medium including instructions that, when executed by at least one processor, cause the at least one processor to perform operations for developing electronic advertisement performance measures based on a combination of website-native data and advertiser-native data. The operations may include hosting a first website, the first website being built based on at least a subset of the plurality of website building elements and a subset of the plurality of website design rules, collecting website-native data associated with the first website, the website-native data being based on users' interactions with the first website, receiving, from a separate advertising platform, advertiser-native data, the advertiser-native data representing advertisement targeting parameters tracked by the separate advertising platform, and developing, based on the collected website-native data and the received advertiser-native data, hybrid analytics regarding a performance of an advertisement campaign associated with the first website.

According to some disclosed embodiments, an advertisement from the advertisement campaign may be displayed on a second website separate from the first website.

According to some disclosed embodiments, an advertisement from the advertisement campaign may be displayed on the first website.

According to some disclosed embodiments, an advertisement from the advertisement campaign may be displayed on a non-website medium.

According to some disclosed embodiments, the non-website medium may include at least one of: television, an augmented reality platform, a virtual reality platform, a digital billboard platform, an in-vehicle display platform, or a video game platform.

According to some disclosed embodiments, the website-native data may include at least one of: web page structure data, website structure data, embedded content, label data, vertical data, search engine optimization data, post data, comment data, and transaction data.

According to some disclosed embodiments, the website-native data associated with the first website may include at least one of: communications data from a communications interface of the first website, form data from a fillable form of the first website, feedback data entered by a user on the first website, purchase data from purchases made on the first website, shopping cart data from a shopping cart component of the first website, booking data from a booking component of the first website, or conversion data indicating users who became paying customers of the first website.

According to some disclosed embodiments, the advertiser-native data may include at least one of: demographic data, impression data, click data, action data, post data, and cookie data.

According to some disclosed embodiments, the advertiser-native data may be collected by the separate advertising platform based on a cookie developed by the separate advertising platform.

According to some disclosed embodiments, the advertiser-native data is collected by the separate advertising platform based on an advertising pixel.

According to some disclosed embodiments, the advertiser-native data may be collected by the separate advertising platform based on tracking a unique user identifier.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A is a block diagram of a promotion system, according to some embodiments of the present disclosure.

FIG. 1B is a block diagram depicting various classes of users interacting with a website building system and with external platforms, according to some embodiments of the present disclosure.

FIG. 2A is a block diagram depicting a website building system hosting a website, according to some embodiments of the present disclosure.

FIG. 2B is a block diagram depicting elements of a hosted website, according to some embodiments of the present disclosure.

FIG. 3 is a flow diagram depicting communication between a hosted website and a third-party platform, according to some embodiments of the present disclosure.

FIG. 4 is a block diagram of interfaces of a website building system used to communicate with external platforms, according to some embodiments of the present disclosure.

FIG. 5 is a schematic diagram of a user action triggering promotion system operations, according to some embodiments of the present disclosure.

FIG. 6A is a flowchart of a method depicting operations performed by a promotion system, according to some embodiments of the present disclosure.

FIG. 6B is a flowchart of a method depicting operations performed by a promotion system upon a hosted website using a website building system, according to some embodiments of the present disclosure.

FIG. 6C is a flowchart of a method depicting operations performed by a promotion system using a hosted website in a website building system, according to some embodiments of the present disclosure.

FIG. 7 is a flowchart of a method to generate recommendations to optimize a website, according to some embodiments of the present disclosure.

FIG. 8 is a flowchart of a method to develop and track cross-medium electronic advertisements, according to some embodiments of the present disclosure.

FIG. 9 is a flowchart of a method to generate and distribute content on a third-party platform using a website building system, according to some embodiments of the present disclosure.

FIG. 10 is a flowchart of a method to generate content on a third-party platform based on updates to a website using a website building system, according to some embodiments of the present disclosure.

FIG. 11 is a flowchart of a method to generate content on a third-party platform based on updates to website catalogs using a website building system, according to some embodiments of the present disclosure.

FIG. 12A is a flowchart of a method to prepare an account for content campaigns on a third-party platform using a website building system, according to some embodiments of the present disclosure.

FIG. 12B is a flowchart of a method to access and track content campaign accounts on a third-party platform using a website building system, according to some embodiments of the present disclosure.

FIG. 13 is a flowchart of a method for adjusting targeting criteria parameters using a website building system, according to some embodiments of the present disclosure.

FIG. 14 is a flowchart of a method to preview content generated by external platforms, according to some embodiments of the present disclosure.

FIG. 15 is a flowchart of a method to generate a comparative interface to review campaign performance and optimize campaigns, according to some embodiments of the present disclosure.

FIG. 16 is a flowchart of a method to update advertisements based on updates to targeting parameters using a website building system, according to some embodiments of the present disclosure.

FIG. 17 is a flowchart of a method to adapt a second campaign based on an evaluation of a first campaign, according to some embodiments of the present disclosure.

FIG. 18 is a flowchart of a method to generate analytics of advertisement campaigns based on native data of a website, according to some embodiments of the present disclosure.

FIGS. 19A-19B are a flowchart of a method to manage campaign flow, according to some embodiments of the present disclosure.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms thus cover both active forms, and passive forms, of sending and receiving.

Fig. lA is a block diagram of a promotion system 100, according to some embodiments of the present disclosure. The promotion system 100 may comprise a website building system (also referred to sometimes as “WBS”) 110 to aid in building and hosting websites, and promoting content of the hosted websites. As discussed further below, promotion system 100 may thus have access to native data from website building system 110 or constituent websites, which may be useful in targeted advertisements. The promotion system 100 may further include a storage 120 and software utilities 150. The storage 120 may include multiple databases for including both components to build websites (e.g., images, text, shapes, colors, backgrounds, videos, audio content, windows, frames, banners, widgets, plugins, advertisement tracking elements, etc.) and websites built using those components. In some embodiments, the information related to components needed to build websites and the information of the websites may be stored in separate databases: system database 130 and site database 140, respectively. Alternatively, system database 130 and site database 140 may be a common database. Although Fig. lA illustrates promotion system 100 as a monolithic system, it may actually consist of multiple sub-elements which are distributed geographically and connected via a communication network (such as the Internet). Further, some or all of promotion system 100's elements may be resident on a cloud system, or multiple such cloud systems.

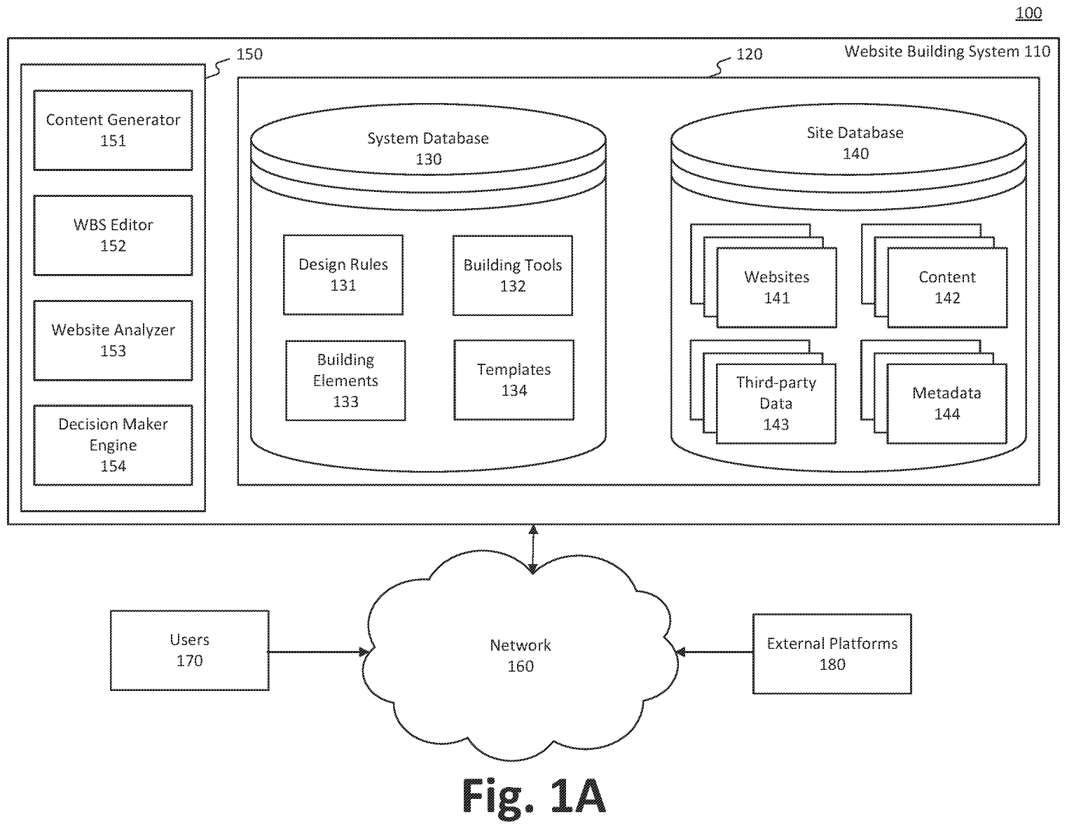

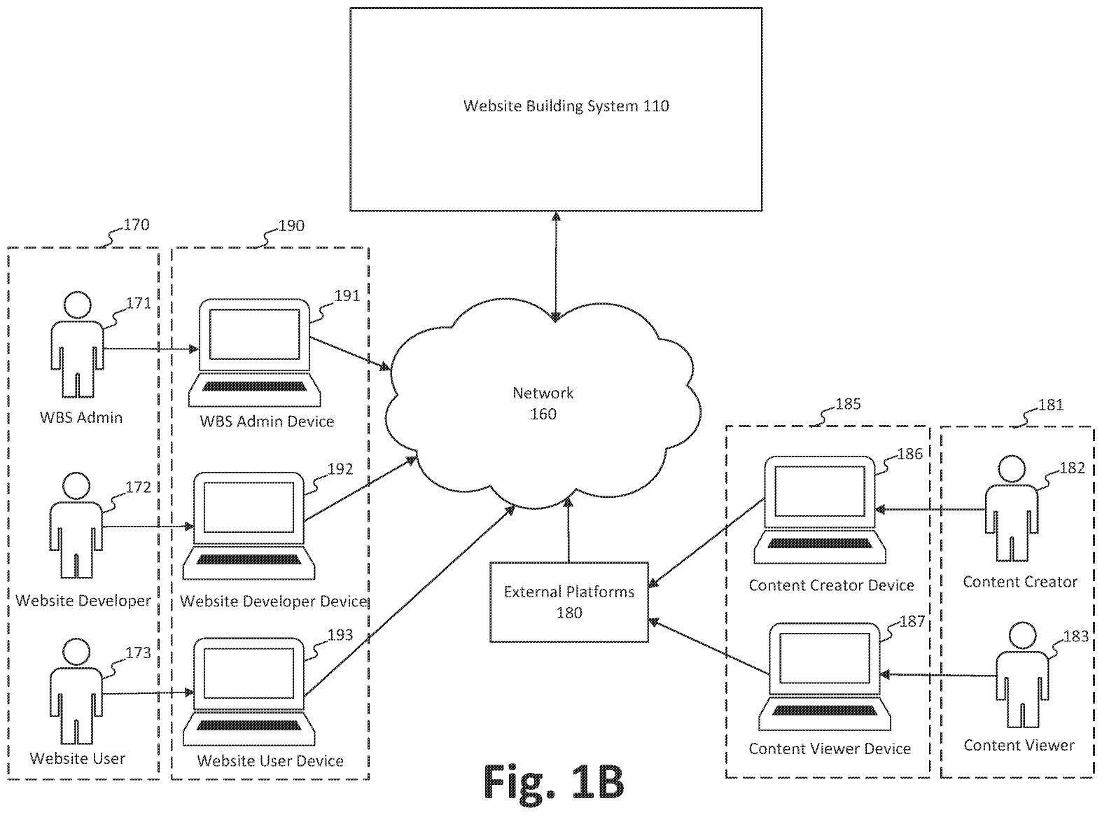

As illustrated in FIG. 1A, a system database 130 may include the following components, among others: design rules 131, building tools 132, building elements 133, and templates 134. The system database 130 contents may be utilized in building one or more websites, each including one or more webpages. The contents of the system database 130 may include software code that forms part of, or is used by, websites (e.g., the websites 141). Design rules 131 may include software code or parameter data that may help determine the design and/or structure of a website (e.g., absolute placement of content, relative placement of content, triggering of events, etc.). Design rules 131 may be selected by a website developer (for example, users 170) to determine the first set of building blocks to be included in a website. The building blocks may include different widgets, size and position of the widgets in a webpage, and a set of pages to be included in the website, among various other possibilities. In some embodiments, the building blocks may be combined together to form larger reusable building blocks. For example, building blocks could include a contact form that includes multiple HTML widgets (e.g., text boxes, text areas, radio buttons, menus, submit button, etc.). The larger reusable building blocks may include both frontend and backend code in addition to a collection of building block widgets. For example, a chatbot can be a building block that includes widgets such as text area, textbox, and submit button in addition to frontend code to layout these elements in a chat window and a backend code to analyze the questions from website visitors and prepare a response. In some embodiments, the building blocks may also be customizable. For example, a survey building block may be customized based on the questions included in a website. The design rule selection may occur by selecting the domain or field of business for which the website is being built. For example, the design rules 131 may be based on business verticals such as restaurants, e-commerce, education, news, fitness, technology, etc. The selection of design rules 131, along with other elements of system database 130, may result in building a customized website, such as one of websites 141.

The design rules 131 may be shared between (or available among) multiple groups of users or enterprises. For example, design rules 131 associated with restaurants and e-commerce business verticals may both include a shopping cart to checkout and order restaurant food items or e-commerce site products. But certain design rules 131 may be unique to a particular business vertical. For example, design rules specific to streaming video content from a website in wesbites 141 may be uniquely associated with a vertical that includes streaming video providers.

In some embodiments, the design rules 131 may be based on a design style such as an infinitely scrollable web page, tabbed web pages, paginated web pages, webpages with frames, or other styles of web pages/website. A single web site may implement multiple sets of design rules based (for example) on parameters or configurations of display device or viewport, through mechanisms known as responsive or fluid design, as described in U.S. patent application Ser. No. 16/879,350, filed on May 20, 2020 by the common assignee of this patent application and which is incorporated in its entirety by reference. The design rules 131 may also be based on a particular author (e.g., user, enterprise, account, etc.) of a set of website templates used to build websites.

The design rules 131 may include a default set of building elements 133 and a set of optional elements that may be selected by a website developer. For example, design rules 131 associated with an e-commerce business vertical may include a shopping cart building element by default but may allow the selection of a chat widget building element. The default building elements associated with a set of design rules of a business vertical may be customizable using a web interface of website building system 110. The customized design rules with new settings may be stored to design rules 131 and accessible to users 170 of the promotion system 100.

Access to design rules 131 may be restricted to a limited set of users of the promotion system 100 or a particular business vertical. In some embodiments, the design rules 131 may be created manually by a website developer. The design rules 131 may be customized by a website developer and shared with other website developers. The website developer may choose to publish the manually created design rules for others to use. In some embodiments, the website developer may restrict access to website developers belonging to their company or enterprise.

The business verticals information may be separate from the design rules 131 and stored in the system database 130 in some embodiments. The business verticals may be associated with one or more design rules 131. In some embodiments, the business verticals may be associated with templates 134.

Building elements 133 may include widgets used to build websites. The widgets may be based on HTML, for example, and may include menus, lists, buttons, checkboxes, forms, video interfaces, calculators, recommenders or wizards, upload interfaces, download interfaces, containers, internal/external database or content integration modules (such as repeaters or galleries), third party application or services, etc. References to HTML widgets herein may include various types of building elements based on HTML and other related languages (markup or procedural such as CSS or JavaScript, etc.), widget template languages, data specification language (such as XML or JSON, etc.), transformation languages (such as XSLT, etc.), hybrid languages (such as React JSX, etc.), server-side languages (such as PHP, etc.), applet development languages (such as Java) and other widget construction languages and technologies. The widgets may be developed dynamically from the widget definitions in markup languages (such as XML, etc.) upon request to access the webpages in a website hosted by website building system 110.

In some embodiments, widgets may be custom-built using, for example, JavaScript, Python, C/C++, etc., or a specialized widget builder or customizer included in website building system 110. The set of building elements 133 to be included in a website may be determined based on design rules 131 as described earlier or may be selected individually by a website developer at a later time. The selection of building elements 133 to be included in a website may be made using the WBS editor 152. The WBS editor 152 may include a WYSIWYG editor interface to allow users to select building elements 133 by dragging and dropping them onto a website representation on the desired webpage and in a desired location on the webpage. Similarly, WBS editor 152 may utilize building tools 132 and templates 134 to build customized websites.

In some embodiments, building elements 133 may include components of a website that include frontend code, backend code, or both frontend and backend code. The building elements 133 may be software code linked to other building elements. For example, a shopping cart may be a building element that may be included by a website developer building an e-commerce website. Inclusion of the shopping cart building element may result in multiple webpages with code for the shopping cart, forms for filling address, and bank details. These webpages and forms may include building elements that are widgets such as radio buttons to select from a set of previously entered addresses, text boxes to provide the bank details for payment, etc.

The building elements 133 may be developed by a website developer and shared with other website developers. A website developer may associate a developed building element with a business vertical, in turn resulting in its association with design rules 131. The developed building element may also be associated with templates 134. The website developer may publish a website template that in turn may provide newly developed building elements. The website building system 110 may analyze the published website template in templates 134 to automatically determine the associated building elements.

Some or all users 170 may be able to access the building elements 133. In some embodiments, access to the building elements 133 may be restricted to website developers or administrators of the website building system 110 (e.g., restricted through an authentication requirement, authorization requirement, etc.). Access to the building elements 133 may also depend on who is approved by a website developer who developed the building elements, website template, or design rules associated with the building element.

In some embodiments, the set of building elements accessible to a user may depend on the templates 134 or design rules 131 selected by a website developer 172 developing a website. The templates 134 and design rules 131 may be associated with a class of building elements providing similar functionality. For example, if a website template 254 selected by a website developer 172 includes the ability for social media integration using a social networking widget, then the building elements 133 may include all possible social media plugin building elements. Templates 134 may authorize only certain vendors of building elements 133 to be associated with the website template.

The templates 134 may be a set of webpages with placeholders for building elements 133 and other content available in site database 140 to populate a website. The templates 134 may be instances of design rules 131 pre-configured with certain styles. For example, design rules 131 may define the structure of an e-commerce website to include a product listing portion, a shopping cart portion, a purchase portion, and various others. The templates 134 associated with the design rules 131 of an e-commerce website may describe in one or more ways how these portions of an e-commerce website can be presented. The website template may describe the filters available on a product page.

Building tools 132 may include a set of software tools to develop building blocks of websites and actual websites. The building tools 132 may include a user interface to control the access to design rules 131, building elements 133, and templates 134. In some embodiments, the building tools 132 may be accessed using the WBS editor 152. Building tools 132 may include software code to compile and interpret the website frontend and backend code. Building tools 132 may help process requests from users 170 to access a website among websites 141. Building tools 132 may help transform the templates used in websites 141 to include the content. For example, the websites 141 may have a frontend that includes templating language (for example, mako or smarty, etc.).

As illustrated in FIG. 1A, a site database 140 may contain the information related to websites 141. The information related to the websites 141 in site database 140 may be used to populate individual websites. The site database 140 may include multiple websites 141, content 142, third-party data 143, and metadata 144, among other data.

Websites 141 may be the software code, markup code and data (e.g., JSON, XML, HTML, CSS, JavaScript, Java, etc.) required to render individual websites on a web browser (e.g., Chrome™, Safari™, Internet Explorer™, etc.) using server side, client side or hybrid rendering. Websites 141 may store both the frontend and backend code in the site database 140. The frontend and backend code may be used to access both the content 142 and third-party data 143 to display information as part of the websites 141 rendered in a browser. In some embodiments, websites 141 may have content included along with the frontend code. The frontend and backend code in websites 141 may refer to the design rules 131, building elements 133, and templates 134. A website of the websites 141 may create a copy of the building elements 133 and templates 134 to be used within the website. In some embodiments, the websites 141 may share some of the frontend and backend code, the content 142, or the third-party data 143.

Content 142 may include all the content displayed on a website viewed by (or accessible to) users 170. The content 142 may include textual content directly included along with building elements 133 associated with websites 141 or content accessed by reference from a website. For example, an image or video content may be present in an image or video file which is referenced by a URL. In another scenario, the content could be calendar data that is populated in a calendar widget building element. Content 142 may include uploaded by users 170 or imported by website building system 110 from other sources. The content 142 may be generated dynamically upon accessing websites 141 and can be updated by users 170. For example, a user viewing a website of websites 141 may update a calendar entry in a calendar widget included in the website. In another scenario, a website with a forum section may allow a user to respond to previous questions on the forum and include new questions. All these updates may be stored in content 142. Content 142 may be used in generating new content by external platform 180 as discussed below. The content generated on the external platform 180 may use the content 142 by wrapping it in a container. For example, a product demonstration video and a link to purchase the product sold on a website of websites 141 hosted by website building system 110 may be used together and put in a HTML <iframe></iframe> and presented by external platforms 180 (e.g., such as an advertising platform, as in the case of third-party platform 390) to promote the product on their own platforms and other websites.

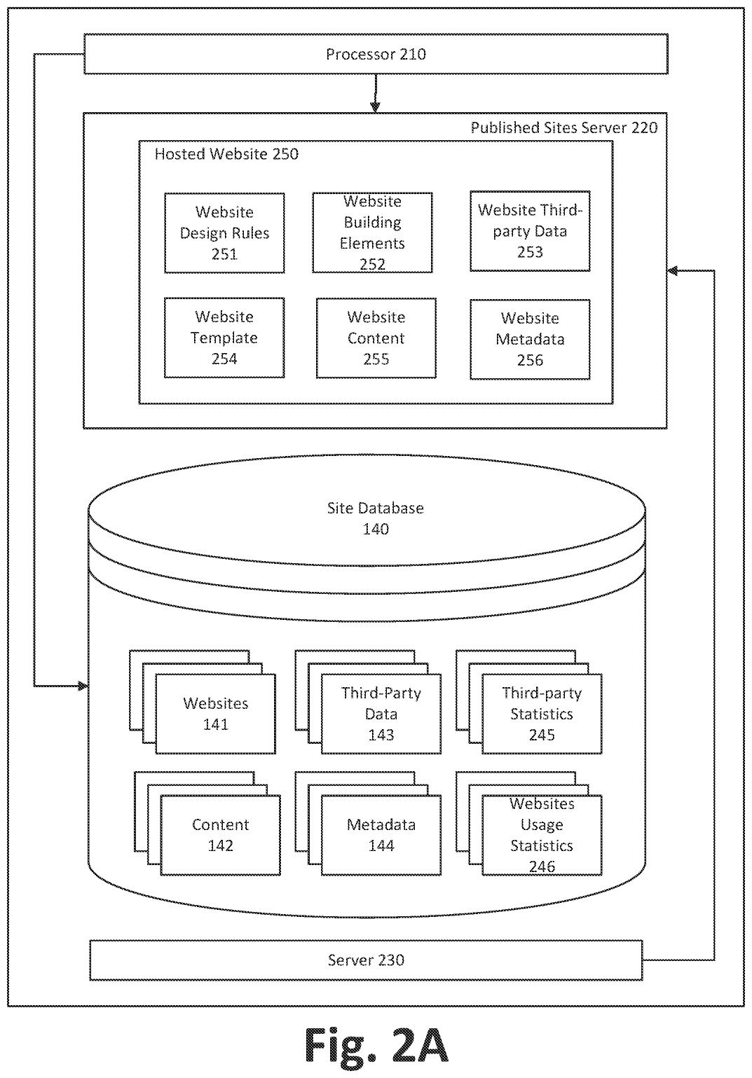

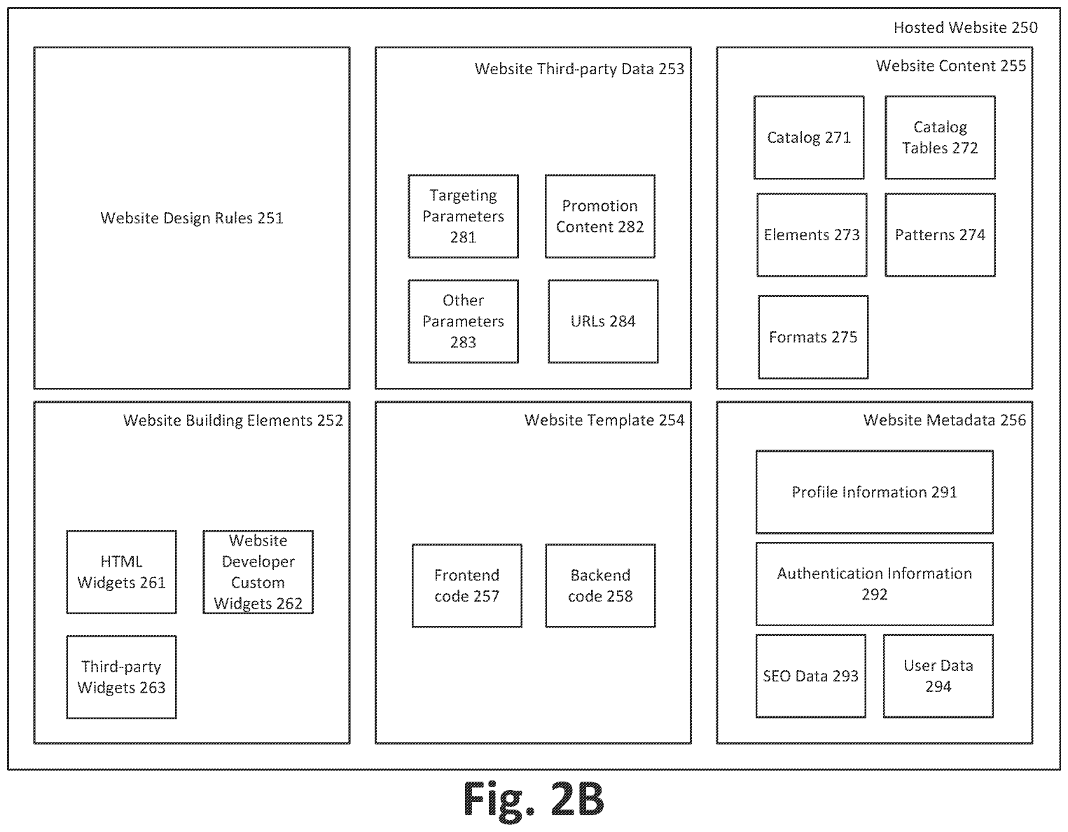

Third-party data 143 may include data related to sources external to the website building system 110, such as external platforms 180. A website may also consider data received from other websites within the website building system 110 to be third-party data 143. The third-party data 143 may include both information to access data (for example, login and other authentication information such as certificates and keys) from external platforms 180. Third-party data 143 may also include information to generate new data on external platforms 180. In some embodiments, the third-party data 143 may reside outside of the website building system 110 and be accessible over network 160. The third-party data 143 may act as a cache and temporarily store the data from the external sources. Third-party data 143 associated with a website is described in detail in FIG. 2B below.

Metadata 144 may include data that is used by software code stored in site database 140 to access other data such as content 142 and third-party data 143. For example, the metadata 144 may be authentication information used to access third-party data 143 from external platforms 180. In some embodiments, the metadata 144 may be generated by the activities of the users of websites 141. For example, the usage statistics of a website and analytics generated from the usage data may be stored as metadata 144. Metadata 144 may also include information that may be displayed on the websites 141. For example, a website of websites 141 being viewed by a user of users 170 may show the number of visitors and locations of visitors currently online on the website.

In some embodiments, the metadata 144 may be supplied by external platforms 180 accessible over network 160. The metadata 144 may also be generated based on the content 142 and third-party data 143 associated with the websites 141. In some embodiments, the metadata 144 may be based on the design rules 131, the building elements 133, and the templates 134 chosen in building a website. Metadata 144 associated with a website is described in detail in FIG. 2B below.

The metadata 144 may also include metadata about the modifications/updates to the websites 141. The updates may include edits and updates to the content 142 over time, design rules 131, templates 134, and building elements 133 associated with the websites 141. For example, the website developer 172 may modify the website content 255 of the hosted website 250, causing the website building system 110 to save the edit history to website metadata 256. In another scenario, the website developer 172 may modify the website building elements 252 of the hosted website 250 by either developing/updating website developer custom widgets 262 or adding and removing HTML widgets 261 and third-party widgets 263 from the widget repository of building elements 133. It is to be understood that, in various disclosed embodiments, the site database 140 and published sites server 220 may be a single database, a combined database, or separate databases. The publication of websites, and editing of websites, may occur in any of the above configurations.

The edit history in metadata 144 may be used by the website analyzer 153 to determine when and what changes have occurred. Such tracking may help determine which recommendations made by decision maker engine 154 have been conducted by the website developer 172 or automatically by the website building system 110 upon users 170 accessing websites 141.

Website building system 110 may include software utilities 150 to manage the information in the system database 130 and site database 140. The software utilities may include the content generator 151, the WBS editor 152, the website analyzer 153, and the decision maker engine 154, among potentially others.

The content generator 151 may generate promotional content utilized by the websites 141 to promote the products, services, and the information presented on particular websites or individual webpages. The content generator 151 may also be used to generate content to embed in templates 134 chosen to build a website of websites 141. The content generator 151 may receive input from users 170 to generate the content. In some embodiments, the received input may be combined with content 142 to generate new content. The generated new content may be third-party data shared with external platforms 180. For example, the content generator 151 may receive some target parameters for the promotional content and may use the products or services listed in content 142 to generate promotional content saved as third-party data to promote the products or services on external platforms 180. In another scenario, the third-party data may also be used by the content creator 182 in order to generate the promotional content. For example, an e-commerce site wanting to promote their new products on a social media external platform 180 may use the product names, images, and videos saved as content 142 in the site database 140, and format and styling allowed by the social media platform saved as third-party data 143, to generate promotional posts. These promotional posts may be shared on external platforms or other websites in the website building system 110.

WBS editor 152 includes features to edit and update websites 141. WBS editor 152 may also include a graphical user interface to communicate with external platforms 180. WBS editor 152 may be used to trigger software utilities such as content generator 151, website analyzer 153, and decision maker engine 154. WBS editor 152 may include a WYSIWYG editor to develop websites using the contents of the system database 130. WBS editor 152 may also include an integrated development environment to both develop and debug the code in addition to providing (for example) the WYSIWYG user interface for element placement and parameter setting.

Website analyzer 153 may aid in analyzing the website to determine the components of a website. The website analyzer 153 may run regularly to analyze the websites 141 and to determine potential improvements. Website analyzer 153 may analyze the websites 141 to determine the design rules 131, building tools 132, building elements 133, and/or templates 134 used to build the websites 141. As discussed further below, website analyzer 153 may generate analytics regarding the performance of websites 141 using some or all of these website inputs, or machine learning models, to determine which website inputs are most effective for particular verticals of websites, particular categories of websites, etc.

Decision maker engine 154 helps in recommending changes to websites 141 to aid in the promotion of services, products, and events listed on websites 141. The decision maker engine 154 generates recommendations that may include the generation of search engine optimization data recommendations to improve the visibility of the website in search results (e.g., inclusion or omission of particular keywords in the websites 141 that search engines may pick up in searches). The website analyzer 153 may share its results with decision maker engine 154 to make recommendations for updating the website. The decision maker engine 154 may recommend updates to the website to include certain building elements 133 or update the website to match a certain template in templates 134. The recommendations may be based on an analysis of similar websites in the same business vertical or same class of users 170. The decision maker engine 154 may employ a machine learning model to analyze and make recommendations, as discussed further below.

The decision maker engine 154 may include an artificial intelligence or machine learning model to both optimize the website and the content generation and distribution through a campaign management process, as described further below. The machine learning model may be utilized to predict behaviors through a simulation process. For example, the machine learning model may evaluate the needs of the website developer 172 in order to promote their website (e.g., the hosted website 250) and predict the costs of promotion. The needs may not be provided by the website developer 172 in all cases. The needs may be automatically determined by the website building system 110 using the machine learning model, and a prediction of costs may be calculated and presented as information as part of the recommendations made by decision maker engine 154. The machine learning model may be part of a repository of models stored in system database 130, such as part of building tools 132. The WBS admin 171 may determine which machine learning models can be utilized in optimizing content 142 and third-party data 143 and predicting results upon optimizations or other modifications to the content 142 and third-party data 143. The machine learning models in building tools 132's repository may be available for website developer 172 and determined based on the design rules 131, templates 134, and other questions answered by website developer 172 upon initiating the website creation or editing process.

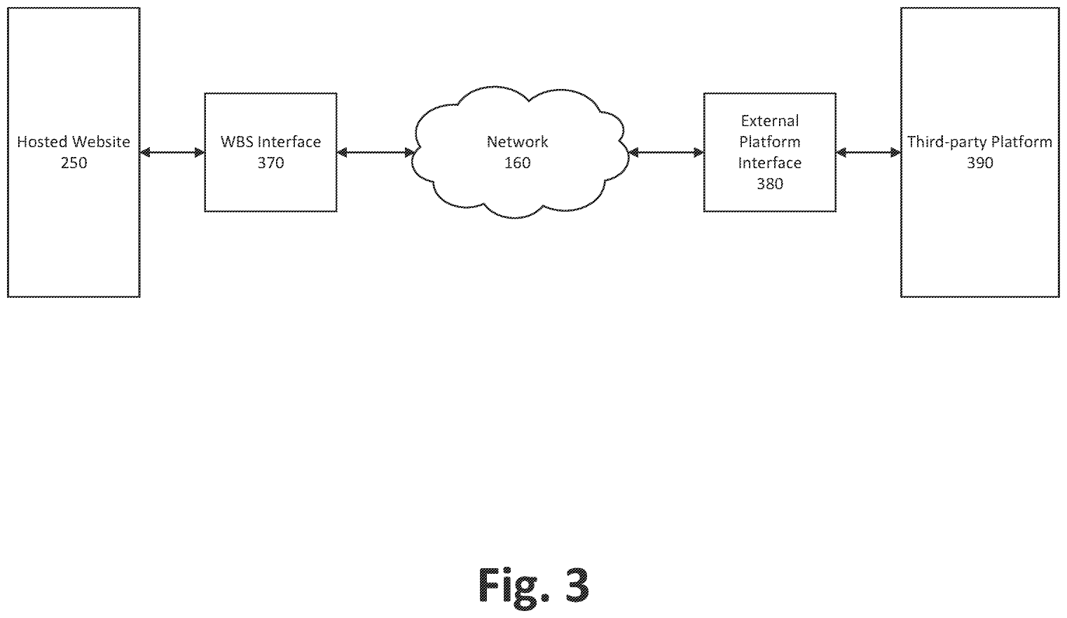

Users 170 may include various users of website building system 110 that access and update websites 141. The users 170 may also include individuals who administer and develop the website building system 110 used to develop and host websites 141. Users 170 developing website building system 110 may include those who develop website building system 110 itself and those who provide components to build the website (such as the templates 134, building elements 133, etc.). Users 170 may access website building system 110 over network 160. In some embodiments, users 170 may need to provide authentication information to access content and software code in website building system 110. Users 170 communicating with website building system 110 is described in detail in FIG. 3 below.

External platforms 180 may include various online sources of content generation and promotion. The external platforms 180 may include electronic advertising platforms to help generate advertisements to promote the websites 141 and the products, services, and the events listed on the websites 141. External platforms 180 may include online resources to be used by users of the platforms to generate promotional content. For example, external platforms 180 may include social media platforms such as Twitter™, Google™, YouTube™, Instagram™, and Facebook™ to create promotional posts or embedded media viewed by users of the social media platform. The external platforms 180 may also include search engines such as Google™, which list promotional content generated on the website hosted by website building system 110 itself based on search engine optimization data generated by website analyzer 153 and decision maker engine 154. External platforms 180 may also include both current and future platforms that allow for communications or social interaction (e.g., WhatsApp™, Facebook Messenger™ WeChat™, Zoom™, TikTok™, WebEX™, Microsoft Teams™, etc.). External platforms 180 are sources of information that may be accessed by users 170 of promotion system 100 through the tools provided in website building system 110. External platforms 180 may be web services communicated by website building system 110 using a web services API. For example, website building system 110 may have a unique API for each of external platforms 180. In some cases, the APIs may be generated and provided by the external platforms 180 themselves, while in other embodiments website building system 110 may custom generate its own APIs to interface with external platforms 180. The web services interfaces used to communicate with external platforms 180 are described in detail in connection with FIG. 3 below.

FIG. 1B is a block diagram depicting various classes of users interacting with the website building system 110, according to some embodiments of the present disclosure. As illustrated in FIG. 1B, several classes of users may interact with the website building system 110 directly or through external platforms 180. The users 170 may interact with the components of website building system 110 for generating and revising websites stored and hosted by the website building system 110. The users 170 may include website developer 172, website user 173, and WBS admin 171. The website developer 172, website user 173, and WBS admin 171, may interact with the website building system 110 using the website developer device 192, the website user device 193, and the WBS admin device 191, respectively. In some embodiments, the website developer 172, the website user 173, and the WBS admin 171 may be the same individual in different roles based on the device being used. The different devices 190 used by users 170, i.e., website developer device 192, website user device 193, WBS admin device 191 may be a single device emulating different devices. The emulation of different devices may be achieved using different logins to the website building system 110 as different classes of users 170. The different classes of users 170 may access the same website of websites 141 at the same time. The devices 190 may be a standard desktop computer, personal computers, mobile device, laptop computers, tablets, server devices, IoT devices, etc. In some embodiments, the devices 190 may need to be authorized to be allowed to access the website building system 110.

The external users 181 may access the external platforms 180 or interact with content from a third-party platform 390. The interaction may include being visible in the general information on the Internet accessed by the external users 181. For example, an external user of external users 181 may be browsing a website and may view content from the third-party platform 390 inserted into the website (e.g., an advertisement or promotion). The website may be part of the websites 141 hosted by website building system 110.

The external users 181 may be members of the third-party platform 390 and may interact with the content from the third-party platform 390. The content from the third-party platform 390 may be generated by a subset of external users 181. The content may also be created by third-party platform 390 upon a request from the website building system 110. For example, as discussed below, third-party platform 390 may generate advertisements or other promotional content for distribution online. As another example, third-party platform 390 may be a social media platform such as Facebook™ or Twitter™ that may publish content of other resources on the web (e.g., posts, images, videos, etc.) created by the members of the social media platform or others.

In some embodiments, the external users 181 may generate, view, or engage with content from, or derived from, the website building system 110 through external platforms 180. The external users 181 may access part of the content transferred from the website building system 110 to the external platforms 180. The external platforms may transform the content from website building system 110 or generate new content based on the received information from the website building system 110. In some embodiments, one of the external users 181 may generate content used on the external platforms and is seen by other users. Content creator 182 may generate content related to one or more websites 141 to be viewed by the content viewer 183. The content creator 182 may generate content using content creator device 186, and the content viewer 183 may view the generated content using content viewer device 187. The content creator 182 and content viewer 183 may act as the content creator and content viewer, and vice versa. In some embodiments, the content creator 182 may act as content viewer 183 of their own content. As an illustration, if a targeted advertisement is created for a website based on data provided by website building system 110, as discussed further below, content viewer 183 may view or engage with the advertisement. In some embodiments, users 170 and external users 181 may be the same individuals accessing the website building system 110 using devices 190 or devices 185. Content creator device 186 and content viewer device 187 may take various forms, such as personal computers, desktop computers, laptop computers, mobile devices, tablets, server devices, IoT devices, etc.

The content generated by content creator 182 may be accessible on other external platforms 180. In some embodiments, the content generated is transferred to the website building system 110 through an external platform. The website building system 110 may transfer the generated content to another external platform. In some embodiments, the generated content may be presented on a website hosted by the website building system 110. For example, an external platform which is an advertisement exchange server may be used to generate an advertisement of a website in the website building system 110 and the advertisement may then be published on a blog hosted on an external blogging platform or one of the other websites hosted on the website building system 110 as part of a cross campaign. Various other formats and media of advertisements are possible as well, consistent with below embodiments.

Content presented on the external platforms 180 may be automatically generated. The website building system 110 may generate and provide the content associated with websites 141 to be presented on the external platforms 180. The external platforms 180 may themselves automatically generate the content associated with a website of the websites 141 and viewed by content viewer 183. The external platforms 180 may include a subset of websites 141 hosted by the website building system 110. FIG. 3 describes in detail exemplary communication between the websites 141 hosted by the website building system 110 and a platform of the external platforms 180.

FIG. 2A is a block diagram depicting promotion system 100 hosting the hosted website 250, according to some embodiments of the present disclosure. As discussed above, the promotion system 100 may host websites 141 in addition to helping build the websites 141 using the system database 130. The websites 141 hosted by the promotion system 100 may be copied to published sites server 220. The hosted website 250 of websites 141 may be copied to published sites server 220 upon receiving a request to host the website or access a web page in the hosted website 250. A website may transition to a hosted state upon a request from the user of the website. For example, when the website user 173 of website user device 193 accesses a website using a URL typed into the address bar of a browser, the promotion system 100 may copy the website in site database 140 into published sites server 220 as hosted website 250. The copy process may include copying information from one or both of system database 130 and site database 140. The process of copying websites 141 from the site database 140 to published sites server 220 may include generation of HTML, CSS, and JavaScript and other relevant frontend code or data structures. The copying process may also involve generation of backend code. In some embodiments, the copying process may involve compiling the generated code or the code of websites 141 present in site database 140 to generate object code, executable code or underlying data structures.

Hosted website 250 may include the front end and backend code needed to render the webpages and also the content included within a website. The hosted website 250 thus may include the web site design rules 251 of design rules 131 and website template 254 of templates 134 copied to the published sites server 220. In some embodiments, a copy of website design rules 251 and website template 254 may already exist in websites 141 in site database 140. The website building system 110 may also copy some or all of the content 142 associated with hosted website 250 as website content 255 into published sites server 220. Similarly, third-party data 143 and metadata 144 may be copied as website third-party data 253 and website metadata 256.

Hosted website 250 may include all of the content 142, third-party data 143, and metadata 144 or may copy partially for the webpages which are currently being accessed by users 170. Access requests to hosted website 250 may be handled by server 230. Server 230 may be a web server handling the requests to access the information presented by the hosted website 250. Server 230 may be a separate computing device from the device hosting the hosted website 250. The hosted website 250 may allow updates to both code and data 251-256 by users 170. The processor 210 may execute instructions for managing the hosted website 250's content and the website's copy in site database 140. Processor 210 may instruct site database 140 to update the code and data 141-144 upon receiving updates to the hosted website 250. Processor 210 may also record the access requests to hosted website 250 by users 170 and external users 181 through external platforms 180 in websites usage statistics 246 and third-party statistics 245, respectively.

FIG. 2B is a block diagram depicting elements of the hosted website 250, according to some embodiments of the present disclosure. As illustrated in FIG. 2B, each of the elements 251-256 associated with the hosted website 250 has one or more sub-components. The sub-elements forming the hosted website 250 may be software code or data in the form of text, image, audio, and video as well as other database field data types (such as numbers and dates as well as composite types) and other data or component types detailed above. The elements can be complex widgets such as containers for one or more widgets, galleries, repeaters, etc.

As illustrated in FIG. 2B, the website building elements 252 may include HTML widgets 261, website developer custom widgets 262, third-party widgets 263, and other widgets or plugins. The website building elements 252 may be references by the website template 254, frontend code 257, and backend code 258, or maybe part of custom webpages of the hosted website 250 developed by website developer 172. The website building elements 252 may include style details of in-built widgets such as HTML widgets 261. The custom styled HTML widgets 261 configured by the website developer 172 may be stored as website developer custom widgets 262. Website developer custom widgets 262 and third-party widgets 263 may include one or more widgets, such as HTML widgets 261, combined to form a reusable component. In some embodiments, the reusable components may need additional frontend code 257 and backend code 258. For example, a shopping cart system and a payment gateway may be reusable components used by various templates and design rules 131 associated with e-commerce websites included in website developer custom widgets 262 or third-party widgets 263. Third-party widgets 263 may be building elements which match the profile of widgets supported by the website template 254. The third-party widgets 263 may be purchased by a website developer from a different vendor and imported into the website building system 110.

As illustrated in FIG. 2B, the website content 255 may include catalog 271, catalog tables 272, elements 273, patterns 274, and formats 265. The website content 255 may include a copy of the relevant parts of content 142 associated with the hosted website 250. The website content 255 may include information presented in website building elements 252, such as catalog 271. The relationship between entities within catalog 271 may be described using catalog tables 272. Catalog tables 272 schema may be defined based on website design rules 251. For example, in some embodiments, the catalog tables 272 may be defined based on the website template 254. For example, the presentation of products part of a catalog in an e-commerce website template may determine the schema of catalog tables 272. In some embodiments, the user may upload or import content into the website, which is saved in catalog 271. In some embodiments, the hosted website 250 structure may be analyzed using website analyzer 153 to generate the catalog tables 272. The website analyzer 153 may analyze the website template 254, website design rules 251, and website building elements 252 to determine the structure of the hosted website 250. The catalog tables 272 may be updated upon updates to the website structure by either changing the website template 254 or custom web page structure. Thus, such changes may result in updates to the structure or schema of the catalog 271. In other embodiments, the actual content of the catalog 271 may be automatically updated (e.g., if the catalog 271 is linked or reflected to an external database, such as a product inventory database, a product description database, etc.). The website developer 172 may not be aware of the catalog 271 being maintained by website building system 110. The website developer 172 may import content for catalog 271 as files into the website building system 110. The uploaded files may be imported as database table entries (e.g., based on SQL, Oracle™, etc.) in tables defined by catalog tables 272 schema. Alternatively, other catalog formats may be used too (e.g., proprietary formats). The catalog 271 may also be external and directly accessed by the websites 141 through web services or other remote communication protocols. The external source may maintain the catalog 271 in non-database formats.

As illustrated in FIG. 2B, the website content 255 may also include information used to describe the presentation of website building elements 252, such as elements 273, patterns 274, and formats 275. For example, the website content 255 may include the background patterns to use certain portions of a website described using CSS code. In another scenario, formats 275 may define an image, video, or audio format to use within a HTML widget (<img></img>, <video></video>, <audio></audio>). In yet another scenario, the elements 273 of website content 255 may describe the type website building element button (e.g., HTML or a JavaScript version) to use as a submit button for a form based on the capabilities of the device (e.g., the website user device 193) used for viewing the hosted website 250.

As illustrated in FIG. 2B, the website third-party data 253 may include targeting parameters 281, promotion content 282, other parameters 283, and URLs 284, etc. The website third-party data 253 includes information to generate content on external platforms 180. The targeting parameters 281 may aid in determining where and who should have access to the generated content on external platforms 180. The promotion content 282 may be the example content generated on the external platforms 180. The promotion content 282 may provide examples of successful promotion campaigns that may be reused to generate new promotional content. The promotion content 282 may be associated with a subset of targeting parameters 281. Website third-party data 253 may also include other parameters 283 used to provide details about the hosted website 250 to generate content on external platforms 180. URLs 284 may include addresses of external platforms 180 accessed to generate content.

As illustrated in FIG. 2B, the website metadata 256 includes profile information 291, authentication information 292, SEO Data 293, and user data 294. The website metadata 256 may be used to both generate and access information from various sources, such as external platforms 180. The hosted website 250 may use profile information 291 about the hosted website 250 to generate content. For example, the profile information 291 of the website may be used by the decision maker engine 154 to provide recommendations to revise the website to generate new content. Such new content may act as better promotional content on the external platforms 180, as discussed below.

The website metadata 256 may also include generated and accessed information about the hosted website 250. For example, the SEO data 293 includes the search engine optimization data generated about the hosted website 250. The SEO data 293 may be generated by the website building system 110 using the website analyzer 153.

The website metadata 256 may be used to generate information for the hosted website 250. For example, the authentication information 292 may include information to login and access the hosted website 250 in edit mode. The hosted website 250 accessed in edit mode may allow for revising the website building elements 252 (e.g., the website developer custom widgets 262), the website template 254, and the website content 255. The authentication information 292 may also include login information (or other access credentials) to access content generation and distribution services offered by the third-party platform 390. The authentication information 292 may be supplied along with targeting parameters 281 and other parameters 283 to generate content. The authentication information 292 supplied along with the parameters may be reviewed by the third-party platform 390 to authorize content creation and budget settings for a promotion campaign. In some embodiments, the authentication information 292 for the website building system 110 to access websites 141 may be separated from authentication information 292 for accessing third-party platform 390's services. In some embodiments, this authentication information 292 may be transmitted to a separate fourth-party service (such a separate authorization server, such as a security-as-a-service provider).

The user data 294 may include all the user access information, including the timestamps, geolocations, and other attributes defining the website users (e.g., the website user 173). The user data 294 may also include user edit data of the websites 141 as performed by the developers of websites 141 (e.g., the website developer 172).

The website template 254 provides one or more templates from templates 134 associated with the hosted website 250. The website template 254 may include frontend code 257 and backend code 258 that define the actions and interactions among content of the hosted website 250, as well as potentially external content (e.g., external data sources). The website template may include place holder text, images, video, and audio that may be replaced by information in website content 255. The frontend code 257 may also include a placeholder for building elements that may be linked to website building elements 252. In some embodiments, the placeholder location for building elements may also include a provision for customizing website content 255 and website building elements 252 using WBS editor 152.

FIG. 3 is a flow diagram depicting exemplary communications between a hosted website 250 of promotion system 100 and third-party platform 390, according to some embodiments of the present disclosure. The third-party platform 390 may be one of the external platforms 180 accessed by the hosted website 250. As described herein, external platforms 180 may include various types of platforms, of which third-party platform 390 is one type. For example, external platforms 180 include e-commerce systems, third-party application development systems, or external databases, which may be distinct from third-party platform 390. As described herein, third-party platform 390 may be a particular platform (e.g., advertising or promotional platform) with which promotion system 100 specifically integrates to perform the techniques described below. Accordingly, third-party platform may be, for example, an advertising provider (e.g., Facebook™, Google™, etc.), a social media service (e.g., Twitter™, Instagram™, etc.), a communications or social interaction service (e.g., WhatsApp™, Facebook Messenger™ WeChat™, Zoom™, TikTok™, WebEx™, Microsoft Teams™, etc.), or various other types of platforms separate from promotion system 100. The hosted website 250 may communicate with the third-party platform 390 over network 160. As discussed above, this involve one or more APIs used by website building system 110 that are associated with third-party platform 390. The hosted website 250 and the third-party platform 390 may both include an interface to send and receive information (e.g., raw metrics such as site views, user identifiers, IP addresses of users, content viewed, content selected, actions taken on web pages (e.g. like/share), items purchased, calendar data, catalog data, demographic targeting data, etc.).

The website building system 110 may provide WBS interface 370 for hosted website 250 to send and receive communications with the third-party platform 390. The WBS interface 370 may include an API to communicate with the third-party platform 390, as discussed above. For example, if the third-party platform 390 is Facebook™, the API may include one of the Marketing APIs that Facebook™ makes available to developers, or a modified or proprietary API. In some embodiments, the WBS interface 370 may include a graphical user interface to provide the input to be sent from the hosted website 250 to the third-party platform 390. The graphical user interface may be integrated into the web pages of the hosted website 250. For example, the graphical user interface may be a search bar that takes an input search string and passes the search string to the third-party platform 390 via the API (or otherwise), which may be a search engine service. The inputs to the WBS interface 370 may be both automatic and manual. For example, the authentication information required for the search engine to begin communication may be automated, but the search string may be input manually. The input may be provided automatically by the hosted website 250 or the website building system 110. Various other forms of the graphical user interface as possible as well, such as drop-down menus of selectable features (e.g., advertising targeting parameters), content selection or upload tools (e.g., for images, calendars, catalogs, videos, etc.), and more.

The WBS interface 370 may also include a graphical user interface to provide authentication information to authorize a particular user (e.g., one of users 170) before hosted website 250 may communicate with the third-party platform 390. The authentication information provided using WBS interface 370 may be stored in metadata 144 in the site database 140.

The graphical user interface of the WBS interface 370 may be downloaded from the third-party platform 390 (or rendered based on data from third-party platform 390), allowing the latest version of the interface available for communication at WBS interface 370. For example, if the parameters to be inputted for communication are updated by the third-party platform 390, then the third-party platform 390 may provide a new WBS interface 370 to the hosted website 250. The WBS interface 370 may have a version number (or another identifier) associated with it. The hosted website 250 may include a list of compatible WBS interface 370 version numbers. The third-party platform 390 may provide the WBS interface 370 based on the list of compatible versions. The version number may be used to determine the compatible external platform interface 380 used to bridge the communication with the third-party platform 390. The external platform interface 380 and the WBS interface 370 may, in some situations, be the same interface or different interfaces. In some embodiments, the external platform interface may transform the information supplied by the hosted website 250 through WBS interface 370. For example, a social media platform (e.g., Twitter™, Instagram™, etc.) may generate a promotion post with a video or image of a product in catalog 271 of the hosted website 250 by updating the format of the catalog website content 255. As discussed above, catalog 271 may include data regarding products or services offered by a particular website, such as the hosted website 250 (e.g., product names, SKUs, prices, unique identifiers, locations, inventory status, images, photos, renderings, videos, audio content, etc.).

The WBS interface 370 may be configured by, for example, website developer 172 using website developer device 192. The WBS interface 370 may be configured by providing targeting parameters 281, other parameters 283, and URLs 284 associated with the hosted website 250 as input for the parameter values to be shared with the third-party platform 390. The website developer 172 may provide the input using website developer device 192. The WBS interface 370 may transform the output content generated and transmitted by the third-party platform 390 to be compatible with the hosted website 250 components such as website building elements 252 and website template 254.

It is to be understood that the communications illustrated in FIG. 3 allow for native data from website building system 110 (or data based on such native data, such as reports, compilations, trends, machine-learning outputs or statistics, etc.) to be provided to third-party platform 390, which may greatly enhance the ability of third-party platform 390 to perform operations such as advertisement generation and targeting. Vast data regarding the structural attributes of websites (e.g., based on their associated website design rules 251, website building elements 252, website template 254, website content 255, and website metadata 256) may thus be used by third-party platform 390 to perform highly nuanced and customized advertisement generation and targeting. Likewise, the communications of FIG. 3 allow website building system 110 to receive unique information from third-party platform 390, which may be used by website building system 110 to allow for optimization of websites and their content. These techniques of using native data from website building system 110 and third-party platform 390 are discussed further below in various embodiments.

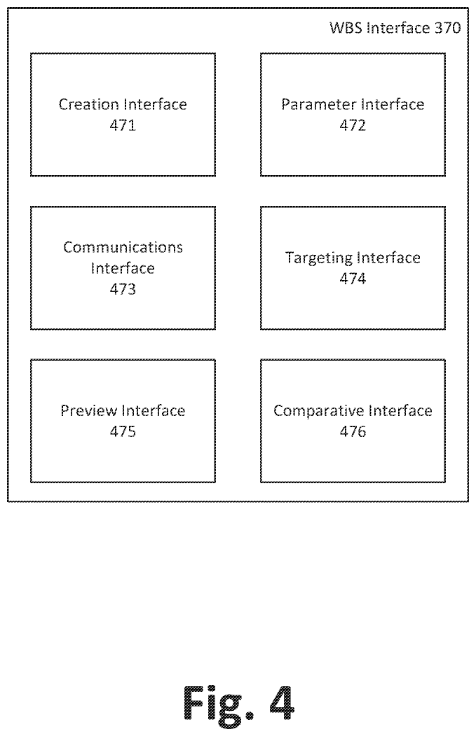

FIG. 4 is a block diagram of a WBS interface 370 used to communicate with the external platforms 180, according to some embodiments of the present disclosure. The WBS interface 370 may be a collection of multiple interfaces used to communicate with various external platforms 180. As illustrated in FIG. 4, the WBS interface 370 may include creation interface 471, parameter interface 472, communications interface 473, targeting interface 474, preview interface 475, and comparative interface 476, among potentially others. Interfaces 471-476 may be used for more than one purpose and may be included within the other interfaces or work in collaboration with other interfaces.

The various interfaces 471-476 may include their own user interface (UI) which interfaces with users 170, or may be an interface engine and let the website building system 110 provide the required UI. Such Uls may be integrated with the website building system 110's own UI (e.g., the WBS editor 152 UI or component property sheets), or may be visually separate, and may also include modifications to existing website building system UI elements.

The creation interface 471 may include a graphical user interface to create a request to generate content (e.g., text, images, videos, audio clips, catalog data, calendar data, etc.) on the third-party platform 390. The creation interface 471 may include an editor to graphically edit the content to be requested to be promoted on the third-party platform 390. The editor may be also be used for viewing remote content being rendered on the third-party platform. The edits made to the content using the editor may be sent across the network 160 to the third-party platform 390, as discussed above.

The parameter interface 472 may be an API providing the ability to set or adjust parameters for the third-party platform 390 to generate content (e.g., text, images, videos, audio clips, catalog data, calendar data, etc.) for viewing at third-party platform 390 and other external platforms 180. The parameter interface 472 may be used in combination with creation interface 471 to generate content based on certain parameters. The parameters for the parameter interface 472 may be manually supplied by the website developer 172. In some embodiments, the website building system 110 may generate parameters automatically based on goals set by the website developer 172, or based on the parameters being used by other websites hosted or built by website building system 110. The goals may include increased visitors, subscribers to services, buyers of products listed on the hosted website 250, scheduling of appointments, increased engagement, increased time spent on the website, increased likes, increased shares of content from the website, increased reads, increased clicks, increased inter-visiting of other webpages of the website, etc.

The communications interface 473 may be an API for providing continuous updates between the hosted website 250 and the third-party platform 390. The communications interface 473 may be an additional parameter or method called as part of the calls using the creation interface 471 to generate or distribute content (e.g., text, images, videos, audio clips, catalog data, calendar data, etc.) on the third-party platform 390. The communications interface 473 may provide insights on the content generated and distributed on the third-party platform 390. The insights obtained via the communications interface 473 may be stored by the hosted website 250 in the third-party statistics 245, as discussed above.

The targeting interface 474 may be used to target content related to a website (e.g., the hosted website 250). The targeting interface 474 may supply the targeting parameters 281 associated with a website or its associated business. The targeting parameters 281 may indicate the description of users currently accessing the hosted website 250 (e.g., age group, gender, interests, geographic location, wealth, social status, profession, subscriptions, activity history, nationality, and many more). The targeting interface 474 may help target users of the third-party platform 390 by matching the description of the users provided by the hosted website 250 in the targeting parameters 281. In some embodiments, the targeting parameters 281 may map to a new class of users to whom the website developer may intend to expand the offerings (products, services, and the events) of the hosted website 250, as discussed further below.

The preview interface 475 may be used to preview the content generated using creation interface 471. The preview interface 475 may be used to request a third-party platform (e.g., third-party platform 390) to create a preview of the content generated by it. The preview interface 475 may also display a preview of the content generated by the website building system 110 as will be visible on the third-party platform (e.g., third-party platform 390). The preview interface 475 may provide a default version of the content that may be generated on the third-party platform 390 and updates to the content as it is configured using the creation interface 471, parameter interface 472, and targeting interface 474.

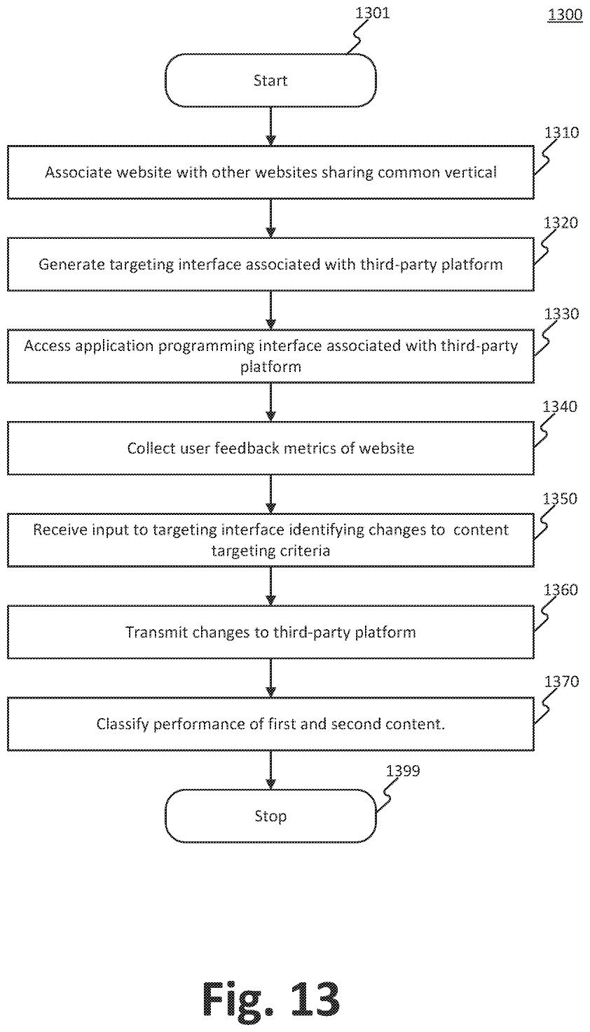

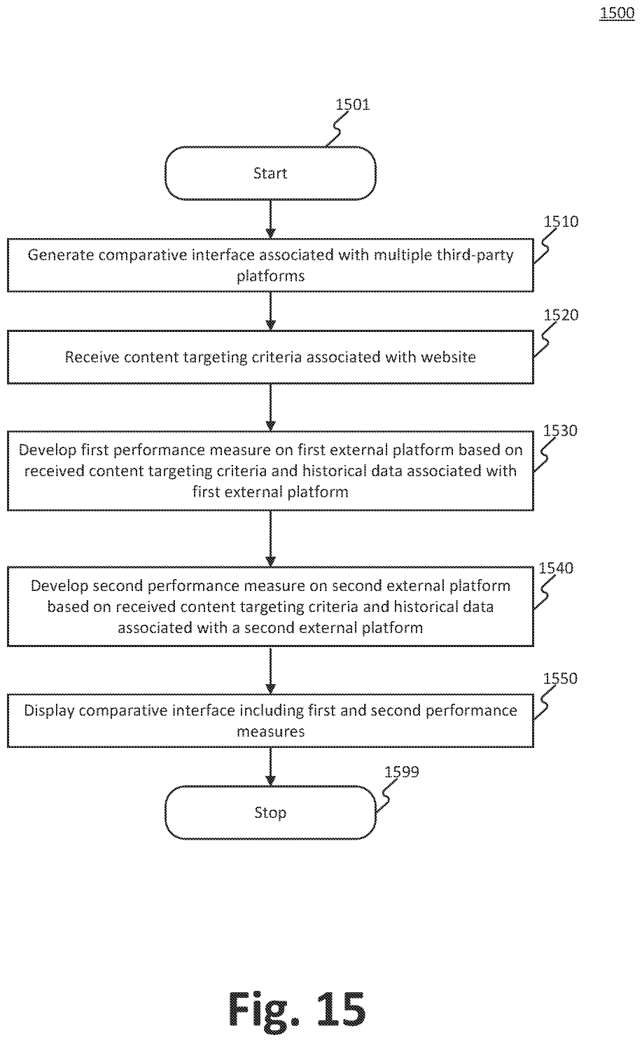

The comparative interface 476 may extract information to show the performance of content related to the hosted website 250 generated and distributed on the third-party platform 390. As discussed further below, comparative interface 476 may be used to display the results of comparisons in performance that are determined using the techniques of, for example, FIG. 13 or 15. In some embodiments, the performance information may include a comparison table showing various metrics of the generated content (e.g., views, unique views, average views, clicks, downloads, scheduled appointments, purchases, subscriptions, etc.). As discussed further below, these metrics may also be broken down by website vertical, category, demographic, geographic region, product or service, etc. The comparative interface 476 may also be used to evaluate the most promising content based on the various performance metrics. The comparative interface 476 may further be used to optimize new content's performance utilizing the determined performances of previously generated content.

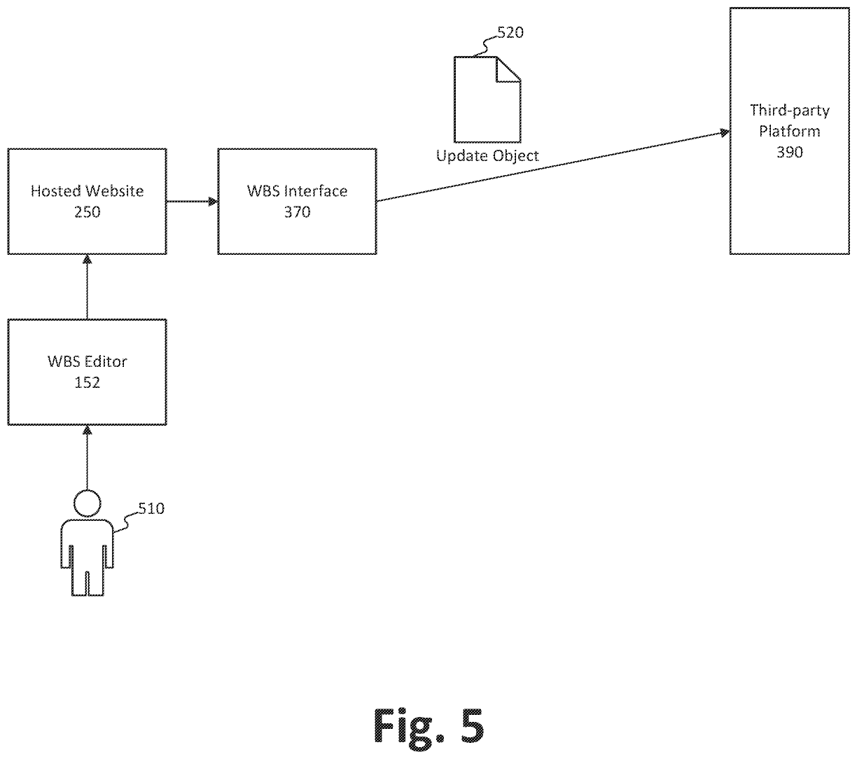

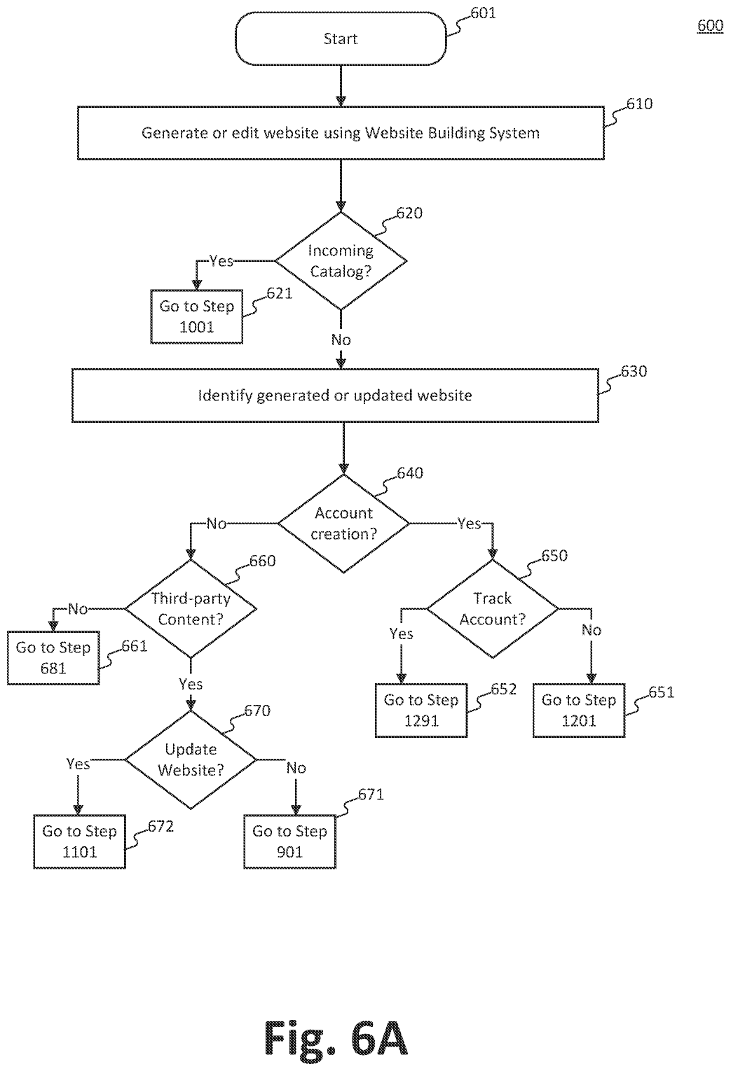

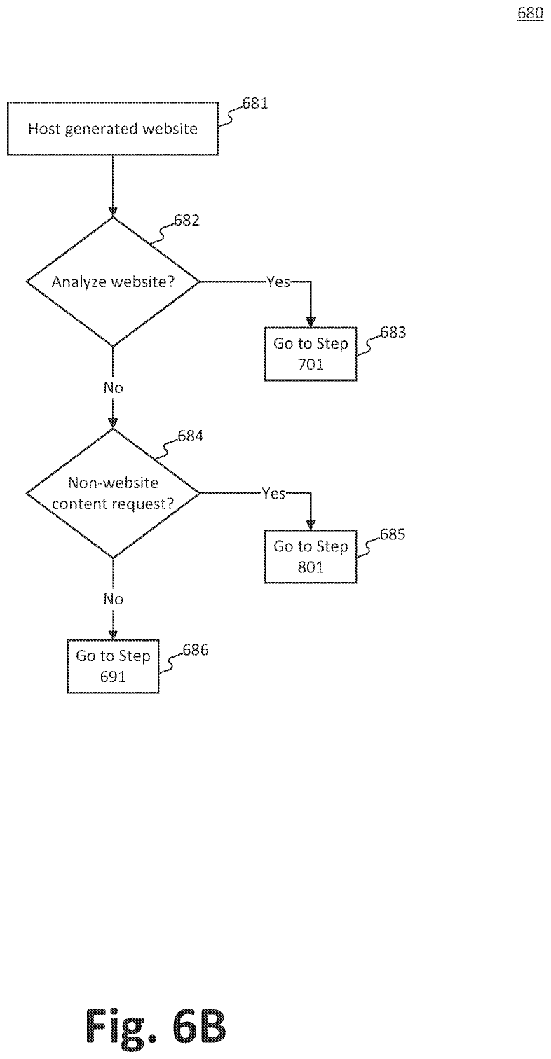

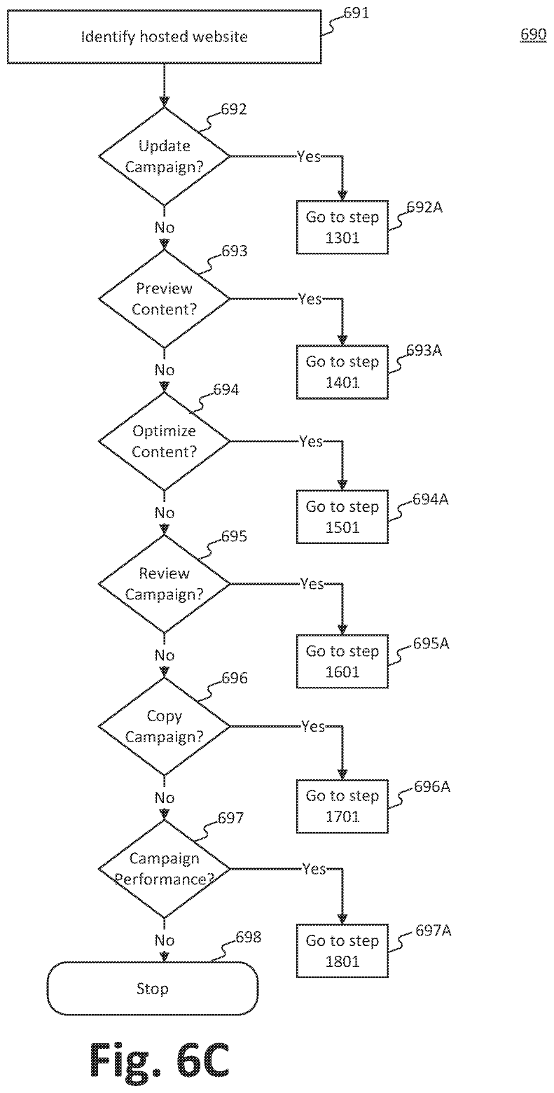

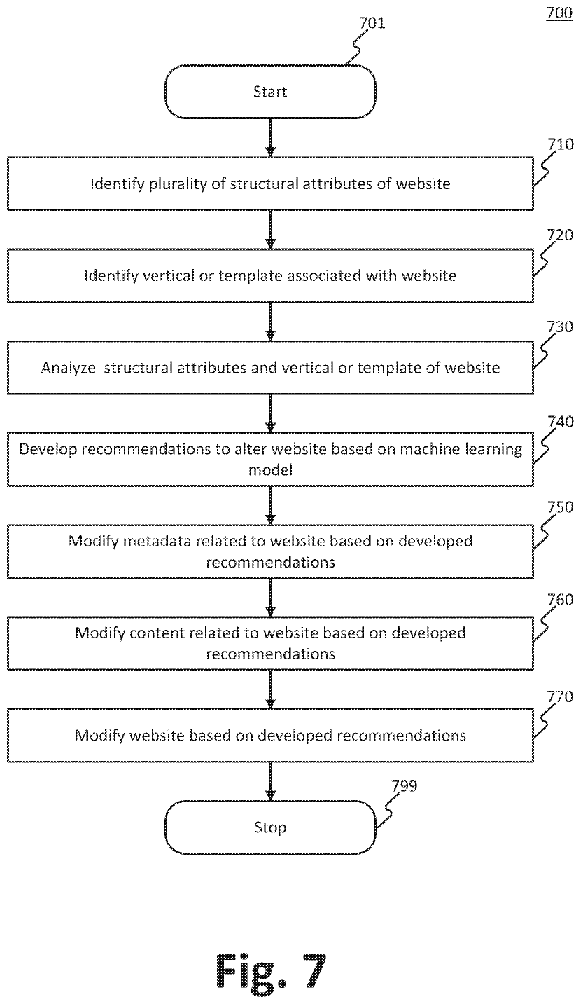

FIG. 5 is a schematic diagram of a user action triggering promotion system 100 operations, according to some embodiments of the present disclosure. Of course, while the operations of FIG. 5 may in some embodiments trigger operations of promotion system 100 (e.g., as discussed below in connection with FIGS. 7-18), in other embodiments the operations of FIG. 5 may not be used as triggers. For example, the operations of FIGS. 7-18 may occur separate from any triggers described in FIG. 5. User 510's actions may trigger operations on the website building system 110 (not shown in FIG. 5). Various possible website building system 110 operations are identified in the descriptions of FIGS. 6A-C below. The website building system 110 operations may be triggered on a website that is currently hosted and accessible to all users 170 (e.g., hosted website 250). In some embodiments, the website building system 110 operations may be triggered only by WBS admin 171 or website developer 172 actions or both.

The operations may be triggered upon editing the hosted website 250 by a user 510. User 510 may be any of the users 170. User 510 may edit the hosted website 250 using WBS editor 152 to trigger website building system 110's operation. In some embodiments, the user 510 may edit the hosted website 250 using other building tools 132 (not shown in FIG. 5). The website editing may include updates to website content 255, website design rules 251, website building elements 252, and website template 254, and thus may include both edits to code (such as through a code editing widget or interface of website building system 110), and layout of the web page and information presented on the webpages (such as products in a catalog, images, etc.). The edits to the hosted website 250 may directly trigger the website building system 110's operations. In some embodiments, the edits may be analyzed by software utilities 150 of website building system 110 to trigger website building system 110's operations. The software utilities 150 may review the edits in real-time or periodically. For example, the user 510 may update the website building elements 252 or website content 255, resulting in website analyzer 153 analyzing the revised version of the hosted website 250 to trigger operations that may result in the generation of recommendations for the transformation of the hosted website 250. In some embodiments, the website building system 110 may automatically transform the hosted website 250. Transformation recommendations of hosted website 250 may include recommendations to add, delete, or update building elements 133 to the hosted website 250 as website building elements 252. Additionally, transformation recommendations may include suggesting that design rules 131 be changed (e.g., moving elements up, down, left, or right; changing the relative or absolute size of elements; resizing text, etc.). In some embodiments, the transformation recommendations may include a recommendation to update website template 254 or website content 255. The transformation recommendations may be based on a similar matching website 144 in the website building system 110 (e.g., sharing a common vertical or sub-vertical). The recommendations may be provided based on a machine learning model, such as a trained machine learning system, as discussed below. A detailed description of the transformation recommendations operation is discussed in FIG. 7 below.

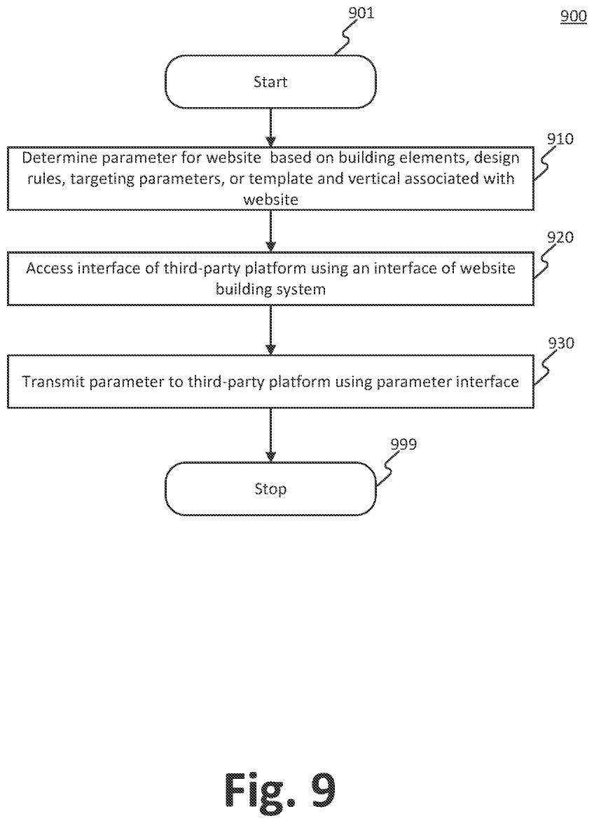

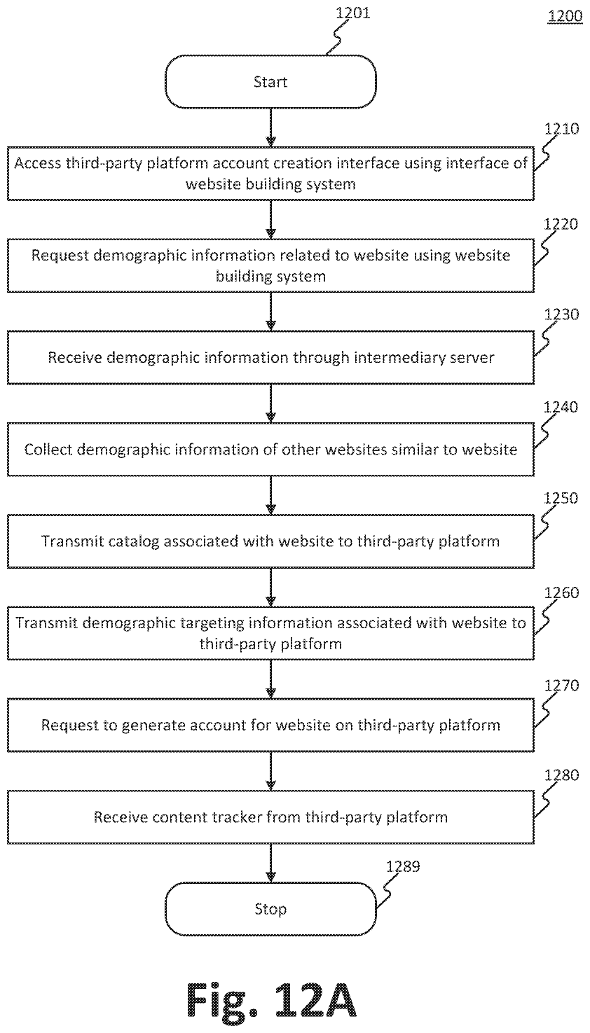

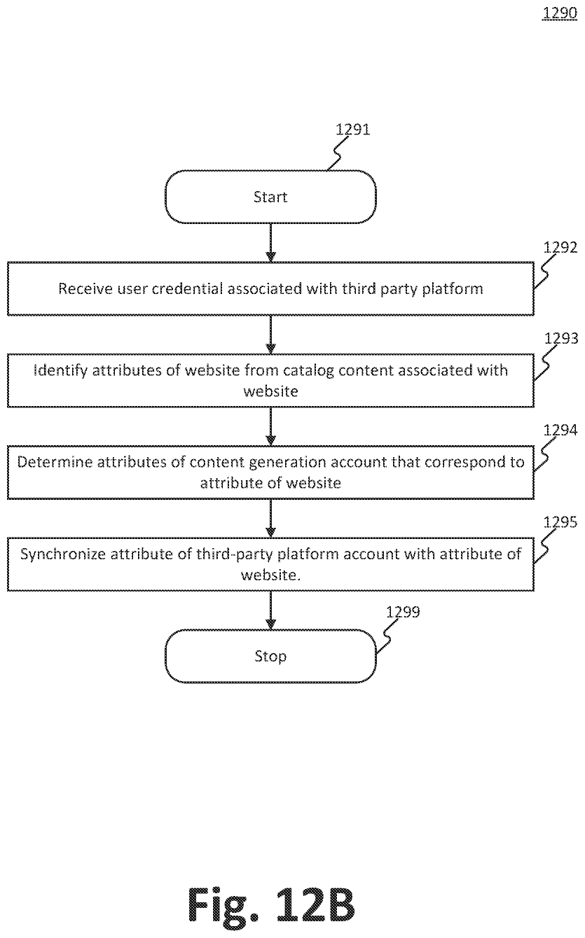

The website building system 110 operations may result in website building system 110 interacting with third-party platform 390. The website building system 110 may interact with the third-party platform 390 through WBS interface 370, as described in connection with FIG. 3 above. The edits to the hosted website 250 may be sent to the third-party platform 390 as an update object 520 (e.g., HTML file, Java file, a proprietary data format, etc.). In some embodiments, the edits may be transformed before sharing them with the third-party platform 390. For example, the user 510 may update the website third-party data 253 of the hosted website 250 resulting in new parameters (e.g., the other parameters 283) for content (e.g., the promotion content 282) generation, or new targeting parameters 281 to change the targeting criteria for promoting a generated content. A detailed description of operations triggered by updates to website third-party data 253 is provided in FIGS. 9 and 12A-B below.

FIG. 6A is an exemplary flowchart of a method 600 performed by the promotion system 100 upon generation of a new or updated website using the website building system 110, according to some embodiments of the present disclosure. The steps of method 600 may be performed by the promotion system 100 for purposes of illustration. It will be appreciated that the illustrated method 600 can be altered to modify the order of steps, skip steps, and to include additional steps.

Method 600 may begin with step 601, and at step 610, the promotion system 100 may receive a request to generate a website using the website building system 110. According to some embodiments, this may include the initial generation of a website at website building system 110. In other embodiments, the promotion system 100 may receive edits to an existing website (e.g., the hosted website 250) to generate a new version of the existing website. Editing a website may include a request to add, delete or update webpages, as well as the content of webpages. The updates to a web page may include the addition of content or updates to the structure of the website, or any other changes originating from the website building system 110 (e.g., component definitions being modified, etc.). For example, the website developer 172 may update the structure of the website by adding building elements 133 to the website. The website developer 172 may update the website by adding or updating the website content 255 associated with the website 250. Consistent with the above discussion, some or all of the elements discussed in connection with FIG. 2A, including published sites server 220 and sites database 140, may be used with the website. In additional embodiments, step 610 may include a request to change the website that does not come through WBS editor 152 (e.g., the request may be based on an automatic update to the website, based on a linked or reflected database that populates content into the website, etc.).

In some embodiments, the update to the website may include the addition of non-content metadata (e.g., website metadata 256) associated with the website (e.g., the hosted website 250). The other non-content updates may include website third-party data 253 associated with the website, or other updates.

In step 620, the promotion system 100 may determine if the received input to generate a new or updated website is new content in the form of a catalog. For example, as discussed above, a catalog may be a listing or data structure representing the products or services offered by a particular website or its associated business. In various embodiments, the catalog may be in a format such as CSV, TSV, or XML (RSS/ATOM). Further, the catalog may in some embodiments be dynamically linked to a data source of a website such as an inventory management application, such that when the inventory of a particular product in the catalog changes, the catalog may be automatically updated as a result. If the incoming update is not a catalog update in step 620, then the method 600 may jump to step 630.

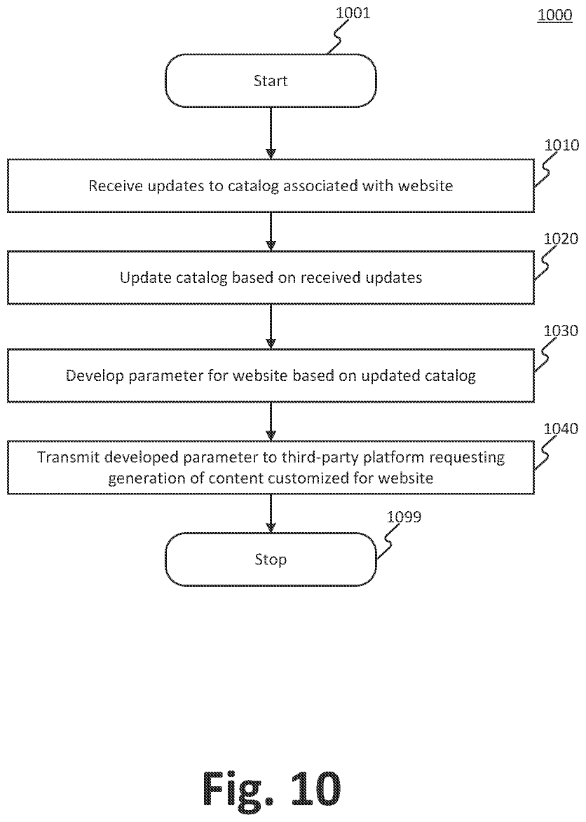

If the answer in step 620 is yes, then the method 600 may proceed to step 1001 of method 1000 described in detail in FIG. 10, below.

In step 630, the promotion system 100 may identify the generated or updated website. The identification of a website may include querying the site database 140 at regular intervals to identify the newly generated or updated websites. The querying may include identifying the latest timestamp of updated websites. In some embodiments, the website updates may be continuously monitored by a website analyzer 153. The WBS editor 152 may report updates to websites 141 to a software daemon tracking the updates. Alternatively, step 630 may include receiving updates from the site database 140 automatically when updates occur.

In step 640, the promotion system 100 may determine if the requested update is for the creation of an account on a third-party platform (e.g., the third-party platform 390). If the answer is no, then the method 600 may jump to step 660.

If the answer in step 640 is yes, then the method 600 may proceed to step 650. In step 650, the promotion system 100 may determine if the requested operation is to track the account created on the third-party platform and in turn track the promotional content associated with the identified website. If the answer is yes, then the method 600 may jump to step 652.

If the answer in step 650 is no, the method 600 may proceed to step 651. In step 651, the promotion system 100 executing method 600 may jump to step 1201 of method 1200 described in detail in connection with FIG. 12A, below.

In step 652, the promotion system 100 executing method 600 may jump to step 1291 of method 1290 described in detail in connection with FIG. 12B, below.

In step 660, which may be followed when the result of step 640 finds that the requested update is not for creating an account, the promotion system 100 may determine whether the update is to third-party content (e.g., the promotion content 282). If the answer is yes, then the method 600 may jump to step 670.

If no, then method 600 may jump to step 681 of method 680 described in detail in connection with FIG. 6B, below.

In step 670, the promotion system 100 may determine whether the operation requested was to update the website. If the answer is yes, then the method 600 may jump to step 672.

If the answer to step 670 is no, then the method 600 may proceed to step 671. In step 671, the promotion system 100 executing method 600 may jump to step 901 of method 900 described in detail in connection with FIG. 9, below.

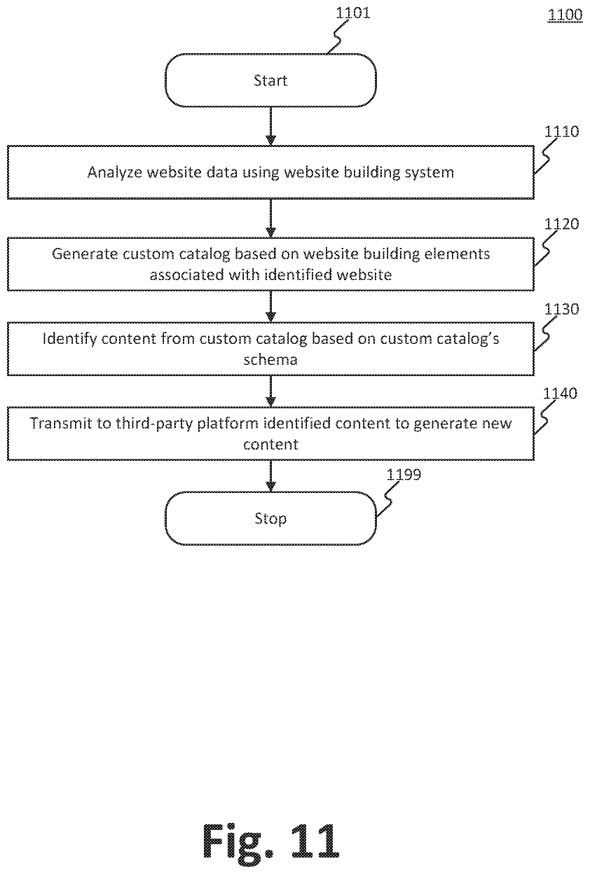

In step 672, the promotion system 100 executing method 600 may jump to step 1101 of method 1100 described in detail in connection with FIG. 11, below.

In some embodiments, the steps in method 600 are not necessary to trigger an operation defined in methods 800-1800. The promotion system 100 may trigger operation of these methods by, for example, directly accessing the methods 800-1800. For example, a campaign manager UI (not shown in the figures) may be used by a website developer 172 to create content and distribute the content on third-party platform 390 using the creation interface 471. In another scenario, the same campaign manager UI may be used to preview content generated and to be displayed or distributed by third-party platform 390 using the preview interface 475. The campaign manager UI may be part of the WBS editor 152 or maybe a separate tool, which is part of building tools 132.

FIG. 6B is a flowchart of a method 680 depicting operations performed by the promotion system 100 upon the hosted website (e.g., the hosted website 250) using the website building system 110, according to some embodiments of the present disclosure. The steps of method 680 may be performed by the promotion system 100 for purposes of illustration. It will be appreciated that the illustrated method 680 can be altered to modify the order of steps, skip steps and to include additional steps.

In step 681, the promotion system 100 may host a website (e.g., the hosted website 250) generated in step 610 of method 680. This may include, for example, storing a website among websites 141 in site database 140. Consistent with the above discussion, the website may be created using tools 150, and based on elements from system database 130.

In step 682, the promotion system 100 may determine if the requested operation is to analyze the website. If the answer is no, then the method 680 may jump to step 684.

If the answer to step 682 is yes, then the method 680 may proceed to step 683. In step 683, the promotion system 100 executing method 680 may jump to step 701 of method 700 described in detail in connection with FIG. 7, below.

In step 684, the promotion system 100 may determine if the requested operation is to generate content outside the website. If the answer is yes, then the method 680 may jump to step 685.

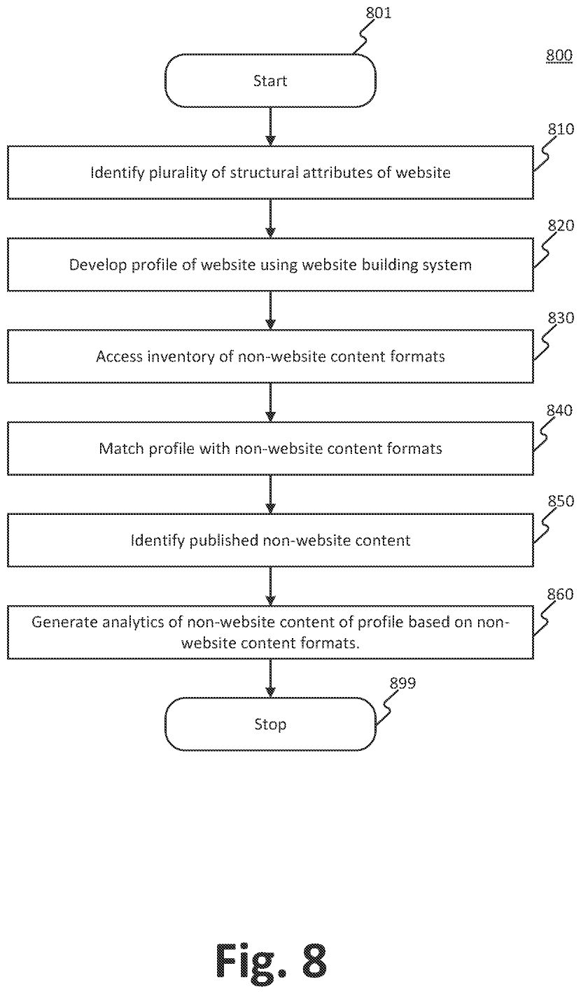

In step 685, the promotion system 100 executing method 680 may jump to step 801 of method 800 described in detail in FIG. 8, below.

In step 686, the promotion system 100 executing method 600 may jump to step 691 of method 690 described in detail in connection with FIG. 6C, below.

FIG. 6C is an exemplary flowchart of a method 690 depicting operations performed by the promotion system 100 using the hosted website 250 in the website building system 110, according to some embodiments of the present disclosure. The steps of method 690 may be performed by the promotion system 100 for purposes of illustration. It will be appreciated that the illustrated method 690 can be altered to modify the order of steps, skip steps, and to include additional steps.

In step 691, the promotion system 100 may identify the hosted website 250. Identification of the hosted website 250 may include accessing the hosted website 250 stored in site database 140 and adding it to published sites server 220 (unless already in published sites server 220).

In step 692, the promotion system 100 may determine if the received operation is a campaign update operation. If the answer is no, method 690 may jump to step 693.

If the answer to step 692 is yes, then the method 690 may proceed to step 692A. In step 692A, the promotion system 100 executing method 690 may jump to step 1301 of method 1300 described in detail in connection with FIG. 13, below.

In step 693, the promotion system 100 may determine if the received operation is a request to preview content. If the answer is no, the method may jump to step 694.

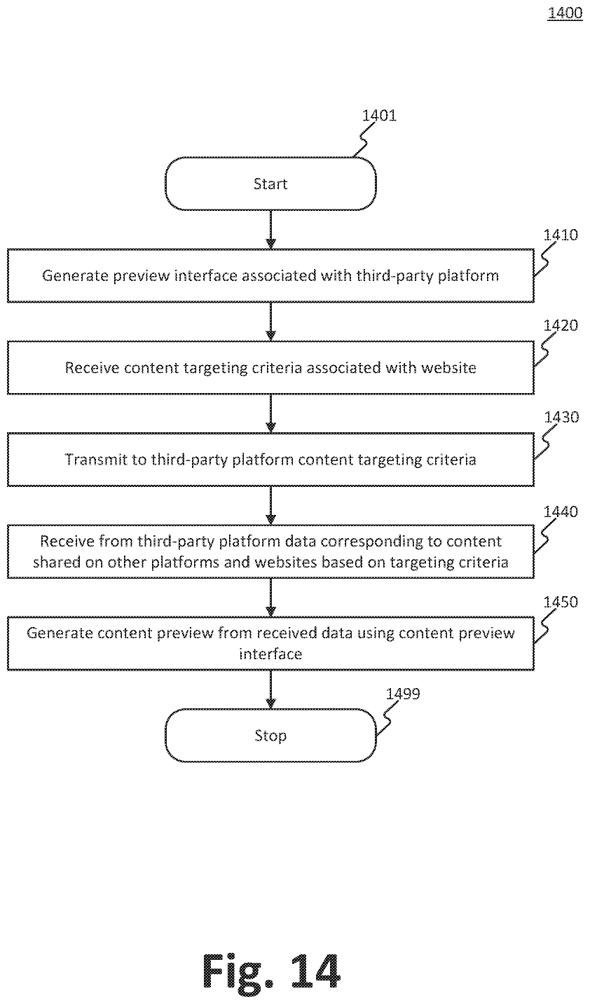

If the answer to step 693 is yes, then the method 690 may proceed to step 693A. In step 693A, the promotion system 100 executing method 690 may jump to step 1401 of method 1400 described in detail in connection with FIG. 14, below.

In step 694, the promotion system 100 may determine if the received operation is a content optimization operation. If the answer is no, the method may jump to step 695.

If the answer to step 694 is yes, then the method 690 may proceed to step 694A. In step 694A, the promotion system 100 executing method 690 may jump to step 1501 of method 1500 described in detail in connection with FIG. 15, below.

In step 695, the promotion system 100 may determine if the received operation is a campaign review operation. If the answer is no, the method may jump to step 696.

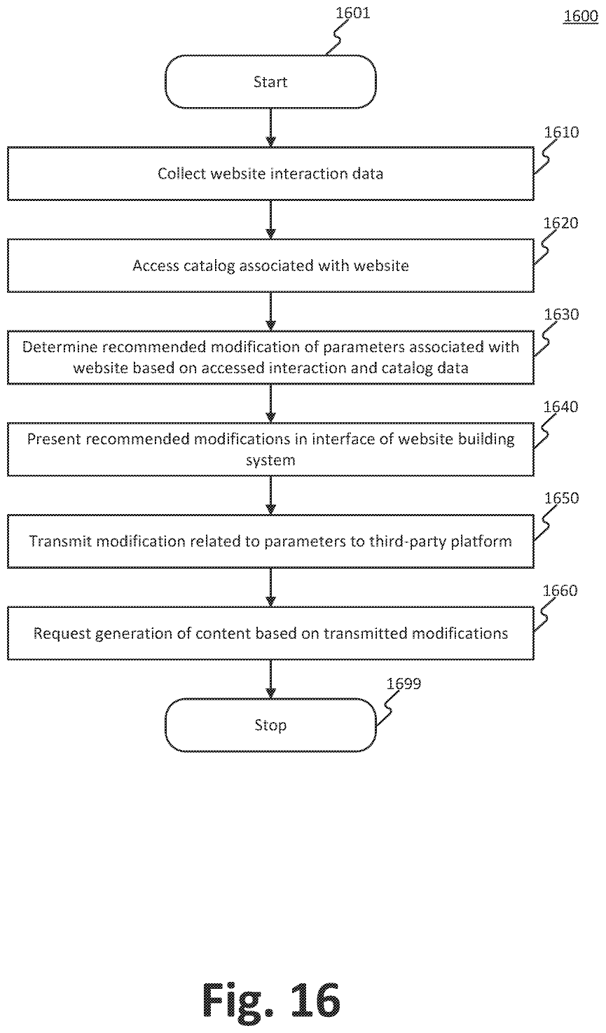

If the answer to step 695 is yes, then the method 690 may proceed to step 695A. In step 695A, the promotion system 100 executing method 690 may jump to step 1601 of method 1600 described in detail in connection with FIG. 16, below.

In step 696, the promotion system 100 may determine if the received operation is a copy campaign operation. If the answer is no, the method may jump to step 697.

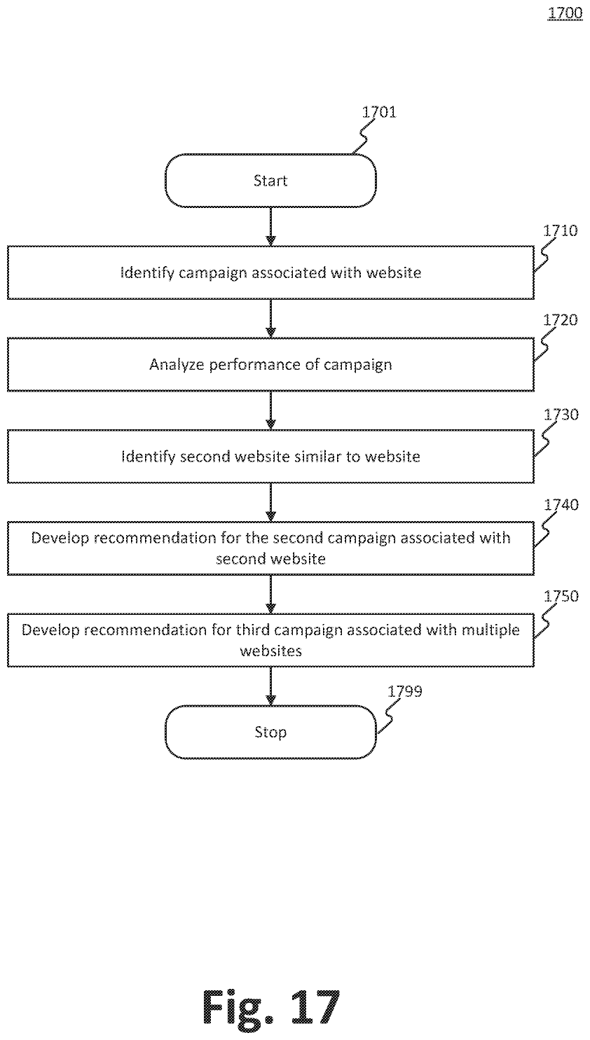

If the answer to step 696 is yes, then the method 690 may proceed to step 696A. In step 696A, the promotion system 100 executing method 690 may jump to step 1701 of method 1700 described in detail in connection with FIG. 17, below.

In step 697, the promotion system 100 may determine if the received operation is a campaign performance operation. If the answer is no, the method may jump to step 698 and end the method 690.

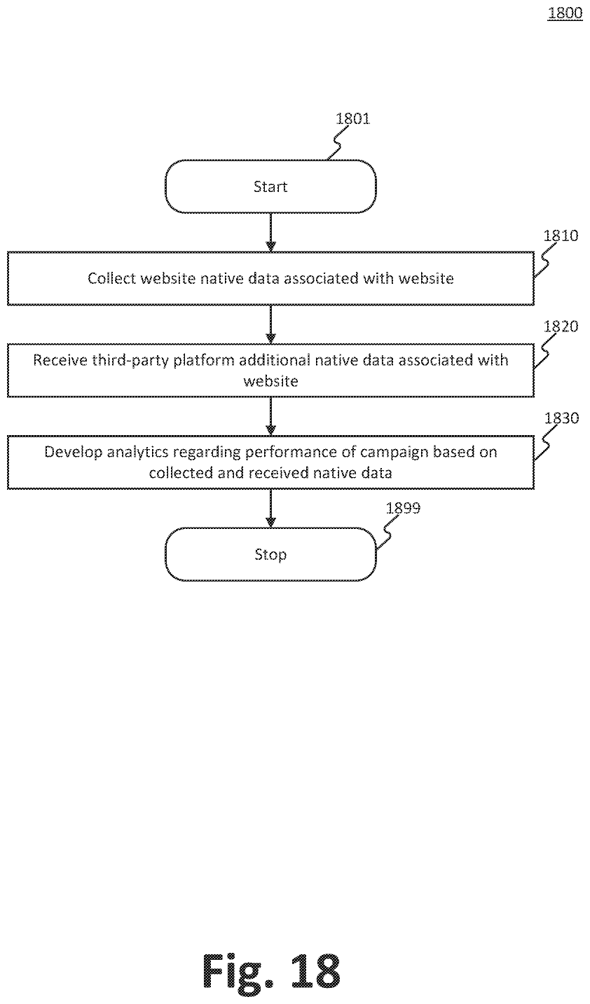

If the answer to step 697 is yes, then the method 690 may proceed to step 697A. In step 697A, the promotion system 100 executing method 690 may jump to step 1801 of method 1800 described in detail in connection with FIG. 18, below.

FIG. 7 is an exemplary flowchart of method 700 to generate recommendations to optimize a website (e.g., the hosted website 250), according to some embodiments of the present disclosure. The steps of method 700 may be performed by the promotion system 100 for purposes of illustration. It will be appreciated that the illustrated method 700 can be altered to modify the order of steps, skip steps, and to include additional steps.

Method 700 may begin at step 701, and at step 710, the promotion system 100 may identify the logical structure and attributes of the website (e.g., the hosted website 250). The structural attributes may include, for example, the organization of webpages of the website (e.g., the hierarchy of pages, links between pages, interrelationships or cross-references between pages, etc.). The structural attributes may also include various functionality added to the website. For example, the functionality could include chat functionality, social media functionality or e-commerce store functionality, payment functionality, calendar functionality, form-filling functionality, subscription functionality, reservation functionality, etc. Various other structural attributes may be gleaned as well (e.g., from the system database 130 or site database 140). Identification of such structural attributes of the website will aid in understanding the goals of the developer (e.g., the website developer 172) of the website and for generating recommendations for adding or removing functionality to/from the website.

The structural attributes of the website may include attributes that are visible only to the website developer 172 of the website. For example, the website building system 110 may analyze the presence of various types of pages such as a landing page, contact page, feedback page, and press release page, etc. In some embodiments, the attributes may include non-visible parts to an end user (e.g., the website user 173). The non-visible attributes may include software and data used to present the website to the end user, such as backend code 258, a backend database, calendar data, schedule data, catalog data 271, inventory data, reservation data, availability data, etc. Some of the invisible attributes may be stored in metadata 144 associated with the website (e.g., the hosted website 250), such as search engine optimization data 293, backend site profile information 291, and more.

In step 720, the promotion system 100 may identify a vertical or template associated with the website. The business vertical associated with the website (e.g., sports, exercise, news, florists, banking, cooking, restaurants, hospitality, etc.) may be determined by querying metadata 144 associated with the website (e.g., the hosted website 250). In some embodiments, the business vertical may be determined based on the structural attributes of the website. The business vertical determination may also involve other data associated with the website. The promotion system 100 may maintain a list of business verticals in the metadata 144. Each business vertical may be associated with a set of values. The promotion system 100 may access the structural attributes database (e.g., the system database 130) storing data representing such business verticals and corresponding structural attributes.

A website may be considered to belong to a particular business vertical by comparing the template or content used by the website with business verticals. The comparison may involve matching the website building elements or the template of the website with corresponding website building elements or templates of known verticals. In some embodiments, the comparison may involve identification of matching structural attributes of the websites identified in step 710 and the structural attributes of the template website representing the business vertical. The business vertical associated with each page of the website may vary (in other words, a particular website may have multiple webpages, each being associated with the same or different business verticals). In some embodiments, the business vertical may be determined using a machine learning model. Various machine learning tools may be used (e.g., TensorFlow™, Keras™ Amazon SageMaker™, etc.). For example, such machine learning tools may use a training set of websites that have associated verticals to train the machine learning system. Once the machine learning system has been trained with the training set of data, it may apply similar classifications of verticals to new websites that it analyzes. The training set of data may be based on, for example, manually linked verticals to particular websites (e.g., by website creators). In some embodiments, the training process may be interactive, such that an administrator can review proposed classifications of verticals that the machine learning system proposes, and either accept or reject (or correct) the proposals. This type of interactive training of the machine learning system may further enhance the accuracy of the system when it is used to classify verticals for new websites. Such interactive training may thus be based on feedback loop machine learning training as described in U.S. patent application Ser. No. 16/878,831, filed on May 20, 2020 by the common assignee of this patent application and which is incorporated in its entirety by reference.

The identification of a business vertical may also involve identification of the template used to build the website. The information about the template associated with the website may be stored in the metadata 144 of the site database 140. In some embodiments, the template associated with the website (e.g., the hosted website 250) may be determined based on the identified vertical associated with the website. In some embodiments, the template identification may require an evaluation of the structure of the webpages and the structure of the website. For example, the structure of a webpage of the website may be determined by understanding the placement of different components (such as a contact form, question and answer portion, images, text, and other multimedia objects, etc.), and the structure of the website may be determined by the composition of the web pages, the links between various web pages, the style of placement of components within a web page (infinite scrolling, pagination), etc. The color and font of the text and patterns used on the website may also be used to identify the template of the website. Similar to the above discussion, machine learning tools (e.g., TensorFlow™, Keras™, Amazon SageMaker™, etc.) may be used to identify templates for websites too. The machine learning tools may be developed through a training phase, which may include an interactive enhancement or correction process. The structure of the website may also be analyzed by the various analysis modules described in U.S. patent application Ser. No. 16/878,831 noted above.

In step 730, the promotion system 100 may analyze the structural attributes and business vertical or the template of the website. Analysis of the structural attributes may involve reviewing or performing analytics on the structural attributes identified in step 710, as well as any changes based upon interaction with the website (e.g., based on external users 181 accessing the website).

In step 740, the promotion system 100 may develop a set of recommendations based on a machine learning model. The machine learning model may analyze existing similar websites 141 on the website building system 110 to make the recommendations. Consistent with the above discussion, various machine learning tools (e.g., TensorFlow™, Keras™, Amazon SageMaker™, etc.) may be used in step 740. For example, such machine learning tools may be developed through a learning phase where websites in a particular vertical are compared to each other in terms of various performance measures. Examples of performance measures used in the machine learning may include clicks, views, subscriptions, purchases, followings, downloads, reservations, time spend during views, etc. The machine learning system may then associate particular attributes of websites in the vertical (e.g., based on some or all of the structural website data in system database 130) with the performance measures. The machine learning model will then classify certain structural attributes as being statistically associated with higher performance measures than other structural attributes. Based on these statistical predictors, recommendations may be developed in step 740 on how to alter the website to improve in terms of the performance measures. For example, if the website currently employs structural attributes statistically determined by the machine learning system to lead to weak or moderate performance in terms of the performance measures, step 740 may include providing recommendations for adopting new or revised structural attributes (e.g., a new contact page, new question and answer page, new shopping cart tool, refreshed graphics, images that match the particular season or a holiday, inclusion of video or audio content, use of backgrounds or templates, page layout changes, etc.).

In step 750, the promotion system 100 may modify the metadata (e.g., the website metadata 256) related to the website based on the recommendations developed in step 740.

In step 760, the promotion system 100 may modify the components (e.g., the website content 255, the website building elements 252, the website design rules 251, the website template 254, etc.) related to the website based on the recommendations developed in step 740. The modifications may include various changes to the website, as discussed above, such as adding, removing, or modifying content by the decision maker engine 154 of the website building system 110. The modifications may include adding, removing, or modifying the content such as images, widgets or plugins, integration with backend code or frontend code, etc. The recommended content modifications may include elements 273 (such as textual elements, graphical elements, video elements, etc.), as well as formats 275 (such as layout formats, color formats, background formats, etc.), and numerous other formatting and structural attributes.

In step 770, the promotion system 100 may modify the website based on the recommendations developed in step 740. For example, while step 760 may include making updates to content of the website, step 770 may include structural changes to the website itself. This may include, for example, adding or removing webpages, changing structural attributes of the website (e.g., catalogs, schedules or calendars, inventory data, templates, backgrounds, integration with particular advertising platforms, etc.). Various other changes to the website are possible as well, in accordance with the machine learning system and its recommendations from step 740. Method 700 may then end with step 799.

FIG. 8 is an exemplary flowchart of method 800 to develop and track cross-medium electronic advertisements, according to some embodiments of the present disclosure. The steps of method 800 may be performed by the promotion system 100 for purposes of illustration. It will be appreciated that the illustrated method 800 can be altered to modify the order of steps, skip steps, and to include additional steps.

Method 800 may begin at step 801, and at step 810 the promotion system 100 may identify a plurality of structural attributes of a website (e.g., the hosted website 250). As discussed above, the structural attributes may be identified based on various components that form the webpage. The components may include textual content used in the page and widgets added to the page, among various others. For example, the presence of terms like “FAQ,” “Contact Us,” or “Press” may help determine that the hosted website 250 includes a frequently asked questions page, a contact page, and a press release page. In another scenario, presence of JavaScript code for a chatbot may indicate the presence of a real-time communications interface. The chatbot widget may be identified without analyzing the JavaScript frontend code by recognizing the presence of a building element for communication. The promotion system 100 may also analyze the HTML code to identify HTML widgets such as image and video and in turn identify image content or video content. Of course, in some embodiments website building system 110 may also store higher-level representations or indications of the components forming the webpage. For example, the website building system 110 may store indications that particular pages contain “FAQ” pages, customer support chatbots, calendars, product galleries, etc. This may be native data stored by website building system 110. In such a case, it may be unnecessary to inter from terms in a webpage (e.g., “FAQ”) whether the webpage includes certain content, because the website building system 110 may also indicate that it does or does not.

The analysis of structural attributes may also include determining from the website building system 110 whether the website includes frontend code 257 and backend code 258, which may have functionality relating to communications between the website and the server 230. For example, the form submission frontend JavaScript code and backend code to handle form submission request may help determine the presence and use of fillable form content, form submission such as shopping cart data, and other form submission content in the website. The structural attributes may include at least one of the backend code, backend site profile information, a backend database, calendar data, schedule data, catalog data, or search engine optimization metadata, etc. These structural attributes of the hosted website 250 may be stored at the website building system 110 and available for access. Alternatively, if such structural attributes are not available, they may be observed through analysis of the hosted website 250.

In step 820, the promotion system 100 may develop a profile of the website based on website building elements 252, website design rules 251, and the structural attributes. The profile information 291 may be developed at least in part automatically by the website building system 110. In some embodiments, the profile information 291 may be configured by the user (e.g., the website developer 172) using the WBS editor 152. In some embodiments, the profile information 291 may identify the vertical for the website.

In step 830, the promotion system 100 may access the inventory of non-website content formats. The inventory of non-website formats may include the identification of, for example, influencers (e.g., individuals or enterprises that have large or committed social media followers). The influencers may be associated with a business vertical or template (e.g., the website template 254) of the website, associated with particular geographies, associated with particular languages, associated with particular advertising or social media platforms, etc. The influencers' association with a website may be determined by the geolocation of the influencers. For example, an influencer in China may be better suited for a Chinese audience. The Chinese influencer may be considered for websites hosted outside of China if the audience is culturally similar to the followers of the influencer. In some embodiments, the inventory of non-website content formats may include contacting customers, identification of advertisement creation firms, and advertising agencies. In some embodiments, the non-website advertisement formats may be offline formats (e.g., identifying and approaching influencers to advertise for the company (e.g., on sites like YouTube™, Instagram™, or in live or real-world performances), scheduling meetings with customers, sending communications to customers, etc.). In further embodiments, non-website advertisement formats may include formats other than electronic advertising (e.g., the non-website advertisement formats may include television advertising, augmented or virtual reality advertising, smart personalized billboards or wall signage, smart home appliance advertising, in-vehicle advertising, public transportation advertising, etc.). In some embodiments, the non-website advertisement formats may include air-gapped advertisements that are generated by individuals on other websites not related to the website being advertised. Information about such air-gapped advertisements is collected and evaluated by the website building system 110. As referred to herein, air-gapped advertisements refer to a separation between the medium of the hosted website 250 and the medium of the advertisement (e.g., which may be in-person human communications or other non-website advertising or promotion). For example, influencers on a social media platform may be encouraged to promote a website as part of an advertisement campaign. The promotion may include writing a review on a third-party website. Such content generated on a third-party platform (e.g., the third-party platform 390) may be used to understand the effectiveness of an advertisement campaign. In accordance with the discussion above, certain machine learning techniques (e.g., using tools such as TensorFlow™, Keras™, Amazon SageMaker™, etc.) may be used to statistically analyze the effectiveness of advertising campaigns based on various criteria.

In step 840, the promotion system 100 may match the profile with non-website content formats. The matching of the profile with the inventory of non-web site content formats may include applying an artificial intelligence algorithm to the website building elements 252, a subset of website design rules 251, and structural attributes, etc.

In step 850, the promotion system 100 may identify published non-website content. For example, once non-website content has been posted to a social media platform, or once an influencer has performed their assigned promotional task, the completion of that event may be observed.

In step 860, the promotion system 100 may generate analytics of non-website content of profile based on non-website content formats. Consistent with the above discussion, this may involve tracking various performance measures based on the performance of the non-website advertising or content. As discussed above, machine learning tools such as TensorFlow™, Keras™, Amazon SageMaker™, etc.) may be used to track performance measures for non-website advertising, such as website or webpage views, unique views, average views, clicks, downloads, scheduled appointments, purchases, subscriptions, etc. As discussed above, these metrics may also be broken down by website vertical, category, demographic, geographic region, product or service, etc. In this manner, the machine learning system may correlate the effectiveness of certain non-website advertising formats (e.g., influencers, appointments, non-website advertising, etc.) with the performance measures. The machine learning tools may then be able to statistically classify the most successful non-website advertising techniques, which may be performed in some embodiments within a specific vertical. Method 800 may then end with step 899.

FIG. 9 is an exemplary flowchart of a method 900 to request to generate and distribute content on a third-party platform (e.g., the third-party platform 390) using the website building system 110, according to some embodiments of the present disclosure. The steps of method 900 may be performed by the promotion system 100 for purposes of illustration. It will be appreciated that the illustrated method 900 can be altered to modify the order of steps, skip steps, and to include additional steps.

The techniques of method 900 may aid in the integration of external platforms 180 to aid in the promotion of content being accessed from the website building system 110 used to both create websites 141 and host them in published sites server 220 to be accessed by a website user 173 over a network 160. The third-party platforms 390 where promotional content may be generated or presented for a specific website (e.g., the hosted website 250) may use characteristics beyond the website content to have closer integration between the website 250 and the promotion content 282.

Method 900 may begin at step 901, and at step 910, the promotion system 100 may determine the parameters of the website based on building elements 133, design rules 131, and targeting parameters 281, among other data available in web site building system 110 as discussed above. In some embodiments, the website may also be based on website template 254 or a vertical associated with the website (e.g., the hosted website 250).

The website analyzer 153 may analyze the website structure and extract details about website building elements 252, website design rules 251, and website template 254. The website building elements 252 may include, for example, image content, textual content, and video content supported by various widgets that are part of HTML widgets 261, website developer custom widgets 262, and third-party widgets 263. For example, the HTML tags <img></img>, <video></video>, and <p></p> can be the HTML widgets 261 associated with the hosted website 250. In the example, the image content, textual content, and the video content are part of the frontend HTML code. The building elements may be built using frontend JavaScript code to generate website developer custom widgets 262 and third-party widgets 263. The determination of the website building elements 252 supporting image, textual, and video content may aid in determining what content of the website may be used in promotional content generated by the third-party platform. For example, the analysis of the website building elements 252 for holding video content may provide the video code details and/or video accessibility details from outside the website building system 110 to determine if the video can be used as content within the promotion content 282 generated by third-party platform 390 and accessible to the external users 181 of the external platforms 180 (which includes the third-party platform 390). In another scenario, analysis of a website building element holding image content may provide resolution and format details and help determine how to transform the content to be presented as part of the promotion content 282.

In some embodiments, the promotion system 100 may also access targeting parameters 281 generated previously or supplied by a website developer 172. The targeting parameters 281 may be used in combination with the other parameters determined in step 910 and supplied to the third-party platform 390. As discussed above, these targeting parameters 281 may be various attributes of users or visitors that can be used for targeted advertising (e.g., unique identifiers, cookie data, IP addresses, demographics, geographic locations, interests, activity, personal likes or dislikes, etc.). The promotion system 100 may also determine the current trends of other websites determined to be similar to the website (e.g., sharing a common vertical).

In step 920, the promotion system 100 may access the parameters (e.g., the targeting parameters 281, other parameters 283, etc.) using the parameter interface 472 of the website building system 110. In some embodiments, the promotion system 100 may modify a parameter format to match a third-party platform (e.g., the third-party platform 390) parameter requirements. For example, this may involve harmonizing data natively gathered by the website building system 110 into a format recognizable by the third-party platform 390. As an illustration, this may involve harmonizing words (e.g., words “age 35-55” may be translated to “middle aged” according to the terminology accepted by the third-party platform 390. As another illustration, if the third-party platform 390 only accepts images in the JPEG format, the promotion system may convert a GIF image into JPEG before making the image available to the third-party platform 390. Various other types of harmonization and conversion may be performed by promotion system 100 in order to interface properly with third-party platform 390.

In step 930, the promotion system 100 may transmit data (e.g., the data from step 910) to third-party platform 390 using the parameter interface 472. The promotion system 100 may receive electronic content customized for the website. The promotion system 100 may modify the format of received content using the website building system 110. The promotion system 100 may display received content on other websites. For example, if the third-party platform 390 is Google™, the third-party platform 390 may generate targeted advertisements and insert them into various webpages, search engines, etc. Similarly, if the third-party platform 390 is Instagram™, the targeted advertisements may appear on Instagram™ pages or on various other related webpages. Once the campaign is complete, method 900 may stop in step 999.

FIG. 10 is an exemplary flowchart of a method 1000 to request to generate content (e.g., advertisements of various different types and formats) on a third-party platform based on the updates to a website using the website building system 110, according to some embodiments of the present disclosure. The steps of method 1000 may be performed by the promotion system 100 for purposes of illustration. It will be appreciated that the illustrated method 1000 can be altered to modify the order of steps, skip steps, and to include additional steps.

Method 1000 may begin at step 1001, and at step 1010, the promotion system 100 may receive updates to a catalog (e.g., the catalog 271, as discussed above) associated with the website (e.g., the hosted website 250). The catalog may be based on a catalog schema. For example, as discussed, the catalog may be based on file formats such as CSV, TSV, or XML (RSS/ATOM) or stored in a database or repository (such as Oracle™, MySQL™, Redis™, etc.). The storage may be local or remote (e.g., cloud-based storage, through AWS™, Azure™, etc.). The user may provide edits to the catalog by editing products identified on the first website, services identified on the first website, inventory identified on the first website, or events identified on the first website. Further, in some embodiments, the catalog may be automatically updated (e.g., the catalog may be linked to a product inventory system, such that changes in product inventory automatically cause updates to the catalog).

The promotion system 100 may identify the changes to the content (e.g., in content 142) associated with a website (e.g., in websites 141). The website building system 110 may aid in identifying the changes to the website content (e.g., providing automatic updates identifying changes). The update may include the promotion system 100 allowing upload or import of a catalog into the site database 140. The updates may occur automatically without any user edits, or may occur manually.

In step 1020, the promotion system 100 may update the catalog 271 based on received updates. The promotion system 100 may update the catalog automatically based on changed content associated with the website. The promotion system 100 may update catalog 271 format based on the requirements of the third-party platform. Further, in embodiments where the catalog 271 is linked to another database (e.g., an inventory database), changes to the linked database may result in automatic updates to the catalog 271 itself. For example, if an inventory database is updated to replace a current product with a new product, that update may be reflected automatically in the catalog 271 to replace the current product with the new product. Similarly, the catalog 271 may be linked to a calendar to allow for automatic updates. For example, if the catalog 271 indicates services provided by personal trainers in a fitness facility, the catalog 271 may be linked to a schedule or calendar of the trainers, such that changes in the schedule or calendar automatically causes corresponding changes to the catalog 271. A catalog 271 may also be linked to both a schedule and a calendar. For example, when offering products with seasonal availability (such winter coats), the calendar may dictate different products being shown or emphasized.

In step 1030, the promotion system 100 may develop parameters for the website based on the updated catalog 271. The promotion system 100 may automatically update the parameters based on updates to the automatic update to the catalog. For example, in some embodiments, a portion of a webpage may be configured to display content from the catalog (e.g., a product image, text, etc.). In accordance with the website building system 110 described above, when the catalog 271 is updated in step 1020, that may then automatically cause updates to parameters of the website, such as where content from the catalog 271 is shown on the webpage and what content to show. For example, if the webpage automatically shows a product designated in the catalog 271 as a “lead” or “primary” product, and that product changes in the catalog, then the change to the catalog 271 may result in a new “lead” or “primary” product being shown in the webpage.

Developing a parameter for the website may also include converting the updated catalog into a format accepted by the third-party platform. The development of the parameter may include the application of an artificial intelligence algorithm to data from the updated catalog. The promotion system 100 may transmit developed parameters to the third-party platform 390 requesting generation of content customized for the website.

FIG. 11 is a flowchart of a method to request to generate content (e.g., various types of advertisements) on a third-party platform 390 based on the updates to website content (e.g., catalog 271) using the website building system, according to some embodiments of the present disclosure. The steps of method 1100 may be performed by the promotion system 100 for purposes of illustration. It will be appreciated that the illustrated method 1100 can be altered to modify the order of steps, skip steps, and to include additional steps.

Method 1100 may begin at step 1101, and at step 1110, the promotion system 100 may analyze the data of a website using the website building system 110. The data associated with a website (e.g., the hosted website 250) may include components used to build the website such as website design rules 251, website building elements 252, website template 254. The data associated with the website may also include information displayed on the website, such as the website content 255 and website building elements 252. In some embodiments, the website data may also include data gathered from other sources such as website third-party data 253, metadata 144, third-party statistics 245, and websites usage statistics 246. The website may be analyzed in terms of all of the native data (e.g., structural data) available at the website building system 110 (e.g., from the system database 130 and site database 140).

In step 1120, the promotion system 100 may generate a schema (e.g., the catalog tables 272) for a custom catalog of items based on the website data identified in step 1110. The schema may include each website building element associated with items in a separate table. In some embodiments, the generated schema may include items identified in multiple website building elements to be part of the same table. The promotion system may begin by including items of multiple website building elements in a single table and then splitting the tables as part of database normalization. The generation of catalog schema may also be determined by other data associated with the website. For example, the catalog schema for the hosted website 250 may depend on the website usage statistics. If certain website building elements are not used, then the items associated with those website building elements may be in a separate table to avoid unnecessarily grabbing information that is not needed.

The promotion system 100 may generate a custom catalog 271 based on website building elements associated with the website identified in method 600 before jumping to step 1101. The catalog 271 may be a list of text items and/or images and/or other multimedia objects associated with the building elements. For example, the website building elements 252 of the hosted website 250 may include a menu with a list of items to purchase and thus can create a catalog 271 of items to be purchased. Each menu item upon selection may show an image building element with an image of the product being sold and a set of radio buttons from the website building elements showing various size or placement options. The additional website building elements (e.g., images and radio buttons, etc.) may also be included in the catalog. In some embodiments, the catalog schema of the custom electronic catalog 271 may have been previously created and only modified in the generation step. For example, operation 1120 may involve accessing a default catalog schema (e.g., from building tools 132 or templates 134) and modifying it based on the website data of the website. Further, in some embodiments, there may be different default catalog schema for different web site verticals. For example, a default catalog for shopping or fashion vertical may include elements such as SKU, product name, price, image, etc., while a default catalog for a fitness trainer vertical may include elements such as trainer's name, trainer's experience, trainer's availability, etc.

The generation of catalog schema may be performed by applying an artificial intelligence or machine learning algorithm to the website data. For example, consistent with above embodiments, machine learning tools such as TensorFlow™, Keras™ Amazon SageMaker™, etc. may be used to generate custom catalog schema for individual websites. This may include, for example, training the machine learning system using a learning set of data where existing websites have existing catalog schema. Further, the machine learning system may be fed learning data of websites and catalog schema within individual verticals. In this matter, the machine learning system may learn what types of catalog schema are statistically most likely to be used (or are most effective in terms of performance measures) for a particular website in a particular vertical.

In step 1130, the promotion system 100 may identify content from custom catalog 271 based on the custom catalog 271's schema (e.g., the catalog tables 272). The identification of content from the catalog 271 may be performed based on a parameter associated with the first website. In some embodiments, the identification of content from the catalog 271 may be performed based on a vertical or template associated with the website. The identification of content from the custom electronic catalog 271 may be performed by applying an artificial intelligence or machine learning algorithm to data from the catalog schema. For example, the catalog schema may include the reference (e.g., URL) to the page with potential resources (e.g., images, videos, and audio) to use as catalog data and the AI algorithm may select the appropriate resource to be used as content.

In step 1140, the website building system 110 may help transmit the identified content to a third-party platform 390 to generate new content. The generated new content may be at least one of an image, a video, textual content, or an event. For example, if the third-party platform 390 is Facebook™ or Google™, the third-party platform 390 may receive the catalog schema data from step 1130 and use data from it (e.g., a particular product name, image, and price) to automatically generate a customized advertisement for the website. That advertisement may then be distributed throughout the advertising network of the third-party platform 390. As another example, if the catalog schema identifies a particular hotel room available at a particular price from the website (e.g., a hotel website), that data may be used to create a custom advertisement (e.g., banner ad, textual ad, video ad, etc.) to be distributed throughout an advertising network. Once the data has been transmitted to the third-party platform 390 in step 1140, method 1100 may end in step 1199.

FIG. 12A is an exemplary flowchart of a method 1200 to prepare an account for content campaigns on the third-party platform 390 using the website building system 110, according to some embodiments of the present disclosure. The steps of method 1200 may be performed by the promotion system 100 for purposes of illustration. It will be appreciated that the illustrated method 1200 can be altered to modify the order of steps, skip steps, and to include additional steps.

Method 1200 may begin at step 1201, and at step 1210, the promotion system 100 may access the third-party platform 390 account creation interface 471 using interface 370 of the website building system 110. As discussed above, this may involve using an API specific to the third-party platform 390 (e.g., a Facebook™ or Google™ API). The API may allow communications between the promotion system 100 and the third-party platform 390.

In step 1220, the promotion system 100 may request demographic information related to the website (e.g., hosted website 250) using the website building system 110. Alternatively, such data may already be stored by promotion system 100 (e.g., automatically stored and updated over time as users visit the hosted website 250). Consistent with the discussion above, demographic data may take various forms (e.g., age, gender, location, interests, likes, dislikes, activities, purchase history, nationality, etc.). In some embodiments, the demographic data may be coded into the website (e.g., stored as metadata 144). Alternatively, in some embodiments, the demographic data may be gleaned from observing visitors to the website, and such acquired demographic data may then be stored in metadata 144.

In step 1230, the promotion system 100 may receive demographic information through an intermediary server. In some embodiments, step 1230 may be performed as an alternative to step 1220. For example, either of the two steps may be performed. Step 1230 may be performed in situations, for instance, where a proxy server or other intermediary server collects or reports demographic data regarding visitors to a particular website.

In step 1240, the promotion system 100 may collect demographic information of other websites similar to the website. For example, as discussed above, website building system 110 may determine that websites sharing a common vertical are deemed similar to each other. In embodiments with even more granularity (e.g., sub-verticals within a vertical), step 1240 may look to websites sharing a common sub-vertical (e.g., “watches” may be a sub-vertical within the vertical of “jewelry,” and “power lifting” may be a sub-vertical within the vertical of “fitness”). The promotion system 100 may also identify a similarity based on the underlying parts (e.g., the templates, the building elements, and other website metadata such as user data 294) of the websites. In accordance with the discussion above, website building system 110 may have access to such vertical data, and the various demographic data of websites 141, through metadata 144. Additionally, website building system 110 may identify websites as being similar based on other attributes, such as use of similar or the same templates 134, analysis of web site content 142 (e.g., common webpage titles or headings), geographical considerations (e.g., owner's location), etc.

In step 1250, the promotion system 100 may transmit the catalog 271 associated with the website to the third-party platform 390. For example, this may occur substantially as discussed above in connection with FIG. 11.

In step 1260, the promotion system 100 may transmit the demographic targeting information associated with the website to the third-party platform 390. Consistent with above embodiments, this may involve transmitting the demographic targeting data using an API specific to the third-party platform 390. Additionally, the other attributes discussed in step 1240 may be transmitted to third-party platform 390 as well.

In step 1270, the promotion system 100 may request to generate an account for a website (e.g., the hosted website 250) on the third-party platform 390. For example, this may trigger an account generation process at the third-party platform 390. This may involve creating a new advertising account (e.g., Facebook™ advertiser account, Google™ advertiser account, etc.) with the third-party platform 390 itself. Thus, in an efficient and seamless process for the owner of the website hosted by website building system 110, they may have an advertising account automatically created for them at third-party platform 390. This account may be populated with details from the website building system 110, such as the website owner's name, URL, website vertical, demographic targeting data, etc. In some embodiments, demographic targeting data (as discussed above) and catalog 271 data may also be used to generate the account, although they may be transmitted later and are not required to generate an account.

In step 1280, the promotion system 100 may receive a content tracker from the third-party platform 390. For example, in some examples this may be a tracking pixel, such as a Facebook™ pixel or Google™ Tag Manager tracking code. The pixel may be code that is inserted into an advertisement, or into a website. The pixel's code may collect data that helps track conversions from particular advertisements, facilitates in optimizing advertisements, building targeted audiences for future advertisements, and allowing remarketing of advertisements to people who have already taken some kind of action on the website. Method 1200 may then end at operation 1289.

FIG. 12B is an exemplary flowchart of a method 1290 to access and track the content campaign accounts on a third-party platform 390 using the website building system 110, according to some embodiments of the present disclosure. The steps of method 1290 may be performed by the promotion system 100 for purposes of illustration. It will be appreciated that the illustrated method 1290 can be altered to modify the order of steps, skip steps, and to include additional steps.

Method 1290 may begin at step 1291, and at step 1292 the promotion system 100 may receive user credentials associated with the third-party platform (e.g., the third-party platform 390). In some embodiments, the credentials may be already stored in the website (e.g., hosted website 250) as authentication information 292. The authentication information 292 may be saved from a previous interaction with the third-party platform 390. Alternatively, the authentication information 292 may be entered manually or on-demand.

In step 1293, the promotion system 100 may identify attributes of the website from the catalog content (e.g., the catalog 271) associated with the website. For example, as discussed above, attributes from the catalog 271 may include particular products, SKUs, pricing information, availability information, sale or discount information, etc.

In step 1294, the promotion system 100 may determine attributes of content generation account that correspond to the attributes of the website. The content generation account attributes may include authentication information 292. For example, the content generation account at the third-party platform 390 may indicate parameters for particular content to be used in advertising at the third-party platform 390. As an illustration, the account may specify that advertisements for the website shall be based on whatever product is designated in the catalog as a “lead” or “priority” product. In this situation, a product name, image, and price for the “lead” or “priority” product may be transmitted from the web site building system 110 to the third-party platform 390, based on that setting in the account.

In step 1295, the promotion system 100 may synchronize attributes of the third-party platform 390 account with the attributes of the website. For example, in the above example, the third-party platform 390 may update its advertising campaign for the website if the “lead” or “priority” product to be advertised for a website changes. This may include replacing existing banner or text ads for the website to display the new “lead” or “priority” product, including its name, image, and price. Such new advertisements may then be distributed throughout the advertising network of third-party platform 390 (e.g., Facebook™ or Google™). Method 1290 may then end at step 1299.

FIG. 13 is an exemplary flowchart of a method 1300 for adjusting targeting criteria parameters using the website building system, according to some embodiments of the present disclosure. The steps of method 1300 may be performed by the promotion system 100 for purposes of illustration. It will be appreciated that the illustrated method 1300 can be altered to modify the order of steps, skip steps, and to include additional steps.

Method 1300 may begin at step 1301, and at step 1310 the promotion system 100 may associate a website (e.g., hosted website 250) with other websites sharing common vertical. For example, as discussed above, website building system 110 may maintain (e.g., in metadata 144) vertical information for websites 141. In some embodiments, both vertical data and sub-vertical data may be maintained for websites 141. Websites 141 sharing a common vertical (or sub-vertical) may thus be associated by website building system 110.

In step 1320, the promotion system 100 may generate an advertising targeting interface 474 associated with the third-party platform 390. The targeting interface 474, as discussed above in connection with FIG. 4, may include a plurality of pre-configured options for selecting the targeting criteria (e.g., demographics, locations, interests, likes, dislikes, purchase activity, viewing activity, etc.). The targeting interface 474 may further include user feedback metrics for the website. The feedback metrics may include at least one of: likes, dislikes, recommendations, referrals, comments, redistribution, sharing, among various others.

In step 1330, the promotion system 100 may access the API associated with the third-party platform 390. For example, as discussed above in connection with FIG. 4, WBS interface 370 may include APIs (e.g., from communications interface 473) that allow website building system 110 to communicate with third-party platform 390.

In step 1340, the promotion system 100 may collect user feedback metrics of the website. This may include various data for the website or a particular webpage, such as visitors, unique visitors, average visitors, subscriptions, downloads, sign-ups, registrations, purchases, posts, etc. This data may be natively available and stored by website building system 110, as discussed above.

In some embodiments, method 1300 may also include accessing an advertising budget for a particular website (e.g., hosted website 250). The budget may indicate, for example, a weekly, monthly, yearly (or other) period of time and corresponding amount of money the website is willing to spend on advertising. As discussed below, the website may optimize its invested money in advertising through the disclosed techniques.

In step 1350, the promotion system 100 may receive input to targeting interface 474 identifying changes to the content targeting criteria (e.g., based on targeting parameters 281). For example, an owner of the website may choose to update or adjust the targeting options for their website. In accordance with above embodiments, this targeting parameter data may be stored natively in website building system 110 and may also be made available (via communications interface 473 or targeting interface 474) to third-party platform 390.

In step 1360, the promotion system 100 may transmit changes in the targeting criteria to the third-party platform 390. The transmitted changes may include accessing an API associated with the electronic advertisement platform, such as communications interface 473 or targeting interface 474. Once the third-party platform 390 receives the updated advertising targeting criteria from promotion system 100, it may store the updated criteria (e.g., in association with the advertising account generated for the website).

In step 1370, the promotion system 100 may classify the performance of first and second content generated by the external platforms 180 and performance data stored in site database 140 as third-party statistics 245. The classification of first and second content performances may be in terms of vertical associated with the first website. The first website may be associated with a second website sharing a common business vertical. As an illustration, the first content may be a particular advertisement for a first product offered by the hosted website 250, and the second content may be an advertisement for a second product offered by the hosted website 250. Based on the targeting criteria selected by the user in steps 1350-1360, the third-party platform 390 may then run two different advertising campaigns for the different products. Consistent with the discussion above, the performance of the first and second advertisement campaigns may be tracked in terms of performance measures (e.g., clicks, impressions, conversions, purchases, registrations, subscriptions, sign-ups, etc.). Step 1370 may involve comparing the performance of the two different advertisement campaigns to determine which product was more successfully advertised.

As an alternative, step 1370 may in some embodiments involve two different advertisement campaigns for the same product offered by the website. For example, one advertisement campaign may be run by a first third-party platform 390 (e.g., Facebook™) and the second advertisement campaign may be run by a different third-party platform 390 (e.g., Google™). By tracking the performance of each advertisement campaign, step 1370 may allow the owner of the website to determine whether Facebook™ or Google™ is a more effective advertisement mechanism for its product and under what campaign parameters. Method 1300 may then end at step 1399.

Consistent with above techniques, step 1370 may also include providing specific recommendations to the website (e.g., hosted website 250) in terms of their advertising budget. For example, using the machine learning techniques above as applied to websites deemed to be similar, promotion system 100 may determine various settings of advertising campaigns that are determined to perform well and fall within the allocated budget for the website. For example, for a website having a relatively low budget, promotion system 100 may determine through the machine learning model that certain image-based advertisements on Google™ are the most effective type of advertising in terms of drawing users to the website and converting the users into purchasers. For another website with a somewhat higher budget, promotion system 100 may determine that video-based advertisements on Facebook™ and Instagram™ are the most effective way to increase website traffic and purchases. Consistent with the above discussion of machine learning techniques, the promotion system 100 may provide recommendations for advertisements to meet a particular budget according to various types of advertising attributes (e.g., advertiser, advertisement type, geographical location, language, product or service pricing, particular imagery or colors to use, particular templates or styles to user, text or buzzwords to use, frequency of advertisements, time period during the campaign, and many more.)

FIG. 14 is an exemplary flowchart of a method 1400 to preview content generated by external platforms 180, according to some embodiments of the present disclosure. The steps of method 1400 may be performed by the promotion system 100 for purposes of illustration. It will be appreciated that the illustrated method 1400 can be altered to modify the order of steps, skip steps, and to include additional steps.

Method 1400 may begin at step 1401, and at step 1410 the promotion system 100 may generate a preview interface 475 associated with the third-party platform 390 on the website building system 110 in association with a website (e.g., the hosted website 250). The preview interface 475 may include a web interface showing a simulation of the third-party platform 390 user interface. That is, promotion system 100 may provide an actual user interface from third-party platform 390 that a user would interact with if they were actually logged in directly at third-party platform 390. In accordance with the present techniques, however, this third-party platform 390 interface is made available to the user in the promotion system 100 itself, without requiring the user to separately access, log-in to, and access, third-party platform 390. Efficiency and user-friendliness are thus greatly enhanced. In some embodiments, the preview interface 475 may also include a preview of the promotional content to be generated on the third-party platform. For example, this may include a rendering of an actual advertisement that third-party platform 390 has created for the website, before the advertisement is disseminated throughout the advertising network of third-party platform 390. The rendering may show the actual look of the advertisement, such as its image content, textual content, size, shape, colors, video material, etc.

In step 1420, the promotion system 100 may receive content targeting criteria associated with the website. As discussed above, the website developer 172 may supply the targeting criteria to generate the preview of the website (e.g., hosted website 250). The targeting criteria may be supplied through a targeting interface 474, as discussed above in connection with FIG. 4. The targeting criteria may be based on the structural attributes of the website, demographics, or various other data. The targeting criteria may be automatically provided by the website building system 110, or may be gleaned from visitors actually visiting the website. The attributes of the first website may include at least one of a website parameter, a template, a template hint, a vertical or template category, a demographic classification, or a geographic location. Various other options are possible as well.

In step 1430, the promotion system 100 may transmit to third-party platform 390 content targeting criteria. The promotion system 100 may transmit the targeting criteria using a targeting interface 474, as described above. The targeting criteria may be based on one or more of the plurality of website building elements 133 associated with the website (e.g., hosted website 250). The targeting criteria may be based on one or more of the plurality of website design rules 131 associated with the website.

In step 1440, the promotion system 100 may receive from third-party platform 390 data corresponding to content shared on other platforms and websites based on targeting criteria defined using targeting parameters 281 and supplied via targeting interface 474.

In step 1450, the promotion system 100 may generate a visual content preview from the received data using content preview interface 475, as discussed in connection with FIG. 4. The preview interface 475 may provide a simulation of an interface of the third-party platform 390. The preview version of the content may be a rendering, within the preview interface 475, of an interface of the third-party platform 390 itself consistent with how the third-party platform 390 natively generates advertisement previews. The preview version of the content may be generated by an API in communication with the advertising platform (e.g., communications interface 473 or preview interface 475), as discussed above. The API may be implemented in various technologies, including as web services over HTTP, remote method invocation such as Java RMI, CORBA, etc. Method 1400 may then end at step 1499.

FIG. 15 is an exemplary flowchart of a method 1500 to optimize campaign performance across discrete external platforms 180, according to some embodiments of the present disclosure. The steps of method 1500 may be performed by the promotion system 100 for purposes of illustration. It will be appreciated that the illustrated method 1500 can be altered to modify the order of steps, skip steps, and to include additional steps.

Method 1500 may begin at step 1501, and at step 1510 the promotion system 100 may generate comparative interface 476 based on data from multiple third-party platforms of external platforms 180. The comparative interface 476 may include the third-party platforms already associated with the website (e.g., the hosted website). In some embodiments, the comparative interface 476 may include all third-party platforms of external platforms 180 (e.g., in one example, Facebook™ and Google™ platforms, as two discrete advertising platforms). The third-party platforms included in the comparative interface 476 may be configured by a website developer (e.g., the website developer 172). In some embodiments, the WBS admin 171 may configure which third-party platforms may be accessible in the comparative interface 476.

The comparative interface 476 may be a tabular interface with third-party statistics 245 of various platforms associated with the website. The comparative interface may also display or allow setting of parameter data associated with each of the third-party platforms. In some embodiments, a subset of third-party platforms may not have any website third-party data 253 or third-party statistics 245 associated with the website (e.g., hosted website 250). The comparative interface 476 may be a simulation of the performance of a promotion content generated on various platforms (e.g., in the above illustration, both Facebook™ and Google™). The comparative interface 476 may show the parameters needed by different third-party platforms to generate the same performance of a campaign stored in third-party statistics 245. In order to generate the performance comparison, as discussed above, various performance measures may be used (e.g., clicks, impressions, downloads, registrations, sign-ups, appointments, purchases, etc.).

In step 1520, the promotion system 100 may receive content targeting criteria associated with the website (e.g., hosted website 250). The content targeting criteria may be supplied to the third-party platform 390 using targeting interface 474, as discussed above. The targeting criteria may include the performance targets to achieve with promotional content on the third-party platform 390. In some embodiments, the targeting criteria may include supplying parameters using parameter interface 472 to achieve certain targets or performance statistics for the performance of content generated on third-party platform 390. The website developer 172 may provide the targeting criteria for a campaign using a WBS editor 152 or another tool including the interfaces such as creation interface 471, targeting interface 474, and preview interface 475 to create and manage content for targeted criteria. The targeting criteria may be provided by filling a form, selecting radio button options, selecting default criteria, modifying default criteria, etc. In some embodiments, the targeting criteria may be selected from a set of pre-defined criteria. The predefined criteria may be a set of criteria provided by default in the website building system, 110 or configured by WBS admin 171. The pre-configured targeting criteria may be generic and applicable to all external platforms 180 or may be different for different third-party platforms. As discussed above, machine learning techniques (e.g., TensorFlow™, Keras™, Amazon SageMaker™, etc.) may be used to recommend certain targeting criteria to use. Such machine learning techniques may involve training a machine learning system using training data, and may further involve interactive training conducted by a user.

In step 1530, the promotion system 100 may develop a first performance measure on a first external platform based on received content targeting criteria. For example, the first external platform in the above illustration may be a Facebook™ advertising platform.

In some embodiments, the development of first performance measures may include the promotion system 100 filtering historical data associated with first and second external platforms based on targeting criteria.

In some embodiments, the development of first performance measures may include simulating content generation based on targeting criteria on the first external platform. For example, the third-party platform 390 may prepare promotional content (e.g., an advertisement with an image) meeting the parameters. The generated promotional content may match the previously generated content with similar parameters and/or performance criteria. In some embodiments, the third-party platform 390 may use existing promotion content 282 to simulate a campaign to meet the targeting criteria provided in step 1520. The simulation step may generate parameters for the third-party platform based on the targeting criteria. Each third-party platform may generate a different set of parameters based on the targeting criteria provided by website developer 172 in step 1520.

The promotion system 100 may measure first content performance based on at least one of: impressions, clicks, purchases, conversions, or actions, among various other options as discussed above. The first content performance measure may be regarded as a key performance indicator for the first website. The key performance indicator may be developed by at least one of the third-party platforms 390.

In step 1540, the promotion system 100 may develop a second performance measure on a second external platform 390 based on received content targeting criteria. In some embodiments, the promotion system 100 may simulate content generation based on targeting criteria on the second external platform. In the above illustration, the second external platform 390 may be, for example, a Google™ advertising platform.

In step 1550, the promotion system 100 may display a comparative interface 476, including first and second performance measures. The first content performance measure and the second content performance measure may be displayed at mediator resource (e.g., part of promotion system 100). The mediator resource may be configured to translate the format of the first content performance measure and the second content performance measure. For example, if one of the performance measures (e.g., Facebook™) extends across a time period of three months, and the other performance measure (e.g., Google™) only covers two months, this may involve shortening the Facebook™ performance data to cover the same time period as the Google™ performance data, to allow for a direct and even comparison. In some embodiments, the promotion system 100 may conform first and second performance measures to a unified format (e.g., clicks, unique visitors, purchases, purchase amounts or currencies, dates, etc.). The mediator resource may be a module within decision maker engine 154 aiding in determining what next steps need to be taken. Method 1500 may then end at step 1599.

In some embodiments, this comparative interface 476 may be applied to suggest advertisements for multiple different websites. For example, if characteristics regarding a first website are known (e.g., revenue amounts, user demographics, vertical, sub-vertical, geographic region, etc.), and the advertisement performance for that website is also known, the promotion system 100 may recommend that a similar advertising channel or method be utilized for a second website sharing the same characteristics. In other words, if the promotion system 100 determines that an advertising channel or method performs well for one site, it may also determine that a similar advertising channel or method will perform well on a similar site (e.g., sharing a common business vertical or sub-vertical). For example, if the first site is a sporting goods site with revenue of $1M to $5M annually, and has an advertisement for basketball shoes that is currently performing well, the promotion system 100 may recommend to a different sporting goods site with comparable revenue that it also run advertisements for basketball shoes using similar channel or method. The privacy and property rights of websites and their users are maintained by using the information of the website (e.g., characteristics of the first website and performance measures of the advertisements) for advertising optimization purposes only and not sharing the information with other parties. In some embodiments, the recommendations may be based on statistical (e.g., aggregated) information of the characteristics gathered for several websites. The statistical information may be determined using statistical analysis models as well as machine learning models (e.g., TensorFlow™, Keras™, Amazon SageMaker™, etc.), as discussed above.

FIG. 16 is an exemplary flowchart of a method 1600 to update content (e.g., various forms and types of advertisements) based on updates to targeting parameters using the website building system 110, according to some embodiments of the present disclosure. The steps of method 1600 may be performed by the promotion system 100 for purposes of illustration. It will be appreciated that the illustrated method 1600 can be altered to modify the order of steps, skip steps, and to include additional steps.

Method 1600 may begin at step 1601, and at step 1610 the promotion system 100 may collect website interaction data. The interaction data may include all of the actions performed by a user (e.g., the website user 173) accessing the website (e.g., hosted website 250). The interactions may be associated with interactions on an external platform (e.g., the third-party platform 390). For example, a promotion post on a social media platform may be clicked, resulting in redirection to a webpage on the website. The pages navigated upon entering the website may all be grouped together as an interaction. In some embodiments, such interactions may be broken down into multiple interactions based on the type of activity performed. For example, upon redirected to the website, the user may view multiple webpages organized under different tabs, where pages visited under each tab may be considered a different interaction. The interactions may be identified based on the actions taken on the website. For example, the website is an e-commerce website where viewed products forming a browsing history may be considered one action, items added to the wish list may be considered one action, items added to cart and purchased one or two separate interactions. In another scenario, the website may offer digital services and a subscription to a mailing list or other digital delivery service (e.g., a podcast, newsletter, shows, movies). In yet another scenario, the website may be presenting services offered in person and have a form to fill for appointments and calendars to select to schedule appointments.

The interactions may be determined based on various actions initiated on an external platform (e.g., the third-party platform 390). For example, a promotional post about the website on a third-party platform 390 may include a different set of buttons for several actions to take upon being redirected to the website. The user (e.g., the content viewer 183) may select one of the available actions or maybe automatically presented based on the previous interaction data associated with the user.

These interaction data may determine what needs to be presented for continued and improved interaction of a user on the website. The interaction data may include viewing data, clicking data, shopping cart data, purchase data, or download data, among various other possibilities.

In step 1620, the promotion system 100 may access a catalog 271 associated with the website. The website building system may query the site database 140 to access the catalogs associated with the website stored in the content 142. In some embodiments, the catalog 271 may be copied to the published sites server 220 as part of the hosted website 250. In some embodiments, the catalog 271 is determined in run-time by analyzing the website. The determined catalog may be stored as content 142 in the site database 140. Further, as discussed above, in some embodiments, the catalog 271 may have a schema that is developed through machine learning techniques or is predefined based on a website template 254 or website design rules 251, and may be linked to a separate database (e.g., an inventory tracking database) for automatic updating.

The accessed catalog 271 data may include items associated with different types of interactions on the website. For example, the catalog 271 may include products showcased on the website, services listed on the website, or events listed on the website. The website building system 110 may use website analyzer 153 to identify these various types of catalog 271 items. The website analyzer may determine the presence of one of the types of catalog 271 items based on website template 254 and website building elements 252. Based on the structure of the web page as defined by the website template 254 or the type of widgets (i.e., website building elements 252), the content is associated with. For example, a calendar widget (website building element) populated with the availability data (i.e., website content 255) may reveal the existence of a service appointment. The labels associated with the calendar widget may reveal the name of the service. In another scenario, a form that is standardized for appointment scheduling may include a drop-down menu (HTML Widgets 261) that lists available services. Such identified services may form the catalog 271.

In some embodiments, the collected interaction data may be used to access the catalog 271. The interaction data may reveal the presence of various catalog 271 items. The navigation data may be analyzed to determine the presence of catalog 271 items, including products, services, or events. The collection of catalogs may also include collecting any other assets (for example, figures and videos) associated with the catalog item. The website analyzer 153 may be utilized in analyzing the various website building elements surrounding the widgets to get further information associated with the catalog item. For example, a product page may include an option to add to cart the described product and include pictures and video and text description of the product. All this information may also be extracted as part of the identified catalog 271 item.

In step 1630, the promotion system 100 may determine the recommended modification of parameters associated with the website based on the collected interaction data and catalog data in steps 1610 and 1620. The promotion system 100 may modify parameters to generate promotional content on external websites linking to content on the website. For example, the modified parameters may result in a new advertisement campaign to be created using an external advertising platform (third-party platform 390). The modified parameters associated with the website based on interaction data may include the demographic data of the users interacting with the website. For example, based on the demographic data of the users (e.g., the website user 173) of the website (e.g., the hosted website) a similar set of users (e.g., the content viewer 183) of the external platforms (e.g., the external platforms 180) may be requested to be shown the promotional post. The modification parameters may also include the content itself shown in the promotional post.

The recommended modification may include identifying a recommended vertical or template for an advertisement. The recommended modification may pertain to at least one of age range, topic of interest, gender, economic status, income, race, education level, purchase history, browsing history, personality, attitudes, opinions, lifestyle interests, or geographic location. The modifications may be determined by applying an artificial intelligence or machine learning algorithm to the collected diversity of different types of interaction data and the catalog data, using the techniques discussed above.

In step 1640, the promotion system 100 may present recommended modifications in an interface of the website building system 110. The website building system 110 may interact with a user of the interface as described in FIG. 3 above to share the modified parameters. The website building system 110 may use the parameter interface 472 to present the modified parameters.

In step 1650, the promotion system 100 may transmit modifications related to parameters to the third-party platform 390. The transferred parameters may be advertising parameters shared with an advertising platform. Upon receipt, the third-party platform 390 may then store the updated parameters in association with the website.

In step 1660, the promotion system 100 may request the generation of content based on transmitted modifications. The transmitted modifications may include the parameters to target a specific set of users. The modified parameters may also include new images, video, and text describing the catalog item to generate the promotional post (e.g., various forms of advertising content). In some embodiments, there may be more one promotional post generated for the same catalog item to identify which set of parameters perform better. The modified parameters transmitted to the third-party platform 390 may result in the creation of multiple promotional posts.

The advertising platform (e.g., third-party platform 390) may be configured to generate the advertisement based on the recommended modification to the advertising parameters. The third-party platform 390 may receive the modified parameters and replace the existing parameters with the new parameters. In some embodiments, the modified parameters may indicate the actual modification. The third-party platform 390 may transform the modified parameters before applying the parameters to generate content. Method 1600 may then end at step 1699.

FIG. 17 is an exemplary flowchart of a method 1700 to adapt a second advertising campaign based on an evaluation of a first advertising campaign, according to some embodiments of the present disclosure. The steps of method 1700 may be performed by the promotion system 100 for purposes of illustration. It will be appreciated that the illustrated method 1700 can be altered to modify the order of steps, skip steps, and to include additional steps.

Method 1700 may begin at step 1701, and at step 1710 the promotion system 100 may identify a campaign associated with the website. For example, the promotion system 100 may locally store (e.g., in site database 140) information about current or historical advertising campaigns for a particular website (e.g., hosted website 250). Alternatively, the promotion system 100 may obtain this information about current or historical advertising campaigns from third-party platform 390.

In step 1720, the promotion system 100 may analyze the performance of the campaign. This performance analysis may occur, as discussed above. For example, various performance metrics may be used to determine the effectiveness of the advertising campaign (e.g., clicks, impressions, conversions, subscriptions, purchases, sign-ups, appointments booked, etc.). This may involve looking at the performance over a period of time to gauge any trend in the performance of the campaign.

In step 1730, the promotion system 100 may identify a second website similar to the website. Two or more websites belonging to the same business vertical (or sub-vertical) may be considered to be similar websites, as discussed above. The promotion system 100 may determine the similarity of the websites using website analyzer 153, which may be configured to compare vertical or sub-vertical data for websites 141. In some embodiments, the similarity between websites 141 is determined by comparing the native data (e.g., structural data) associated with the websites 141. The website analyzer 153 may analyze the structure of the websites 141 to determine the native data associated with websites 141.

In step 1740, the promotion system 100 may develop recommendations for the second campaign associated with the second website. The developed recommendation may be based on at least the targeting criterion and the vertical or template criterion. The developed recommendation for the second campaign may be based on the first website and the second website sharing a common vertical or template criterion. In some embodiments, the first and second campaigns may share a common targeting criterion. As discussed above, the recommendation may take various forms, and may be based on a machine learning technique that statistically analyzes the performance of different websites 141 in a given vertical or sub-vertical. For example, the recommendation may be to adjust a structural element of the website (e.g., adding or removing webpages, adding or removing widgets or plugins, changing a vertical, adding chat tools, or other elements, etc.). Further, the recommendation may be to adjust content within webpages (e.g., templates, backgrounds, images, designs that match a holiday or season, etc.).

The website building system 110 may host a plurality of other websites 141, which may be built based on at least a third subset of the plurality of website building elements 133 and a third subset of the plurality of website design rules 131, as discussed above.

In step 1750, the promotion system 100 may develop recommendations for the third campaign associated with multiple websites. Consistent with the above embodiments, this may involve determining that a third advertising campaign should be applied to multiple websites within a given vertical or sub-vertical. For example, based on the application of machine learning techniques, as discussed above, promotion system 100 may determine that a particular type of advertisement campaign (e.g., focusing on specific products, types of products, geographic locations, demographics, formats, etc.) is more effective than other campaigns within the vertical or sub-vertical. Based on that statistical classification by the machine learning system, as discussed above, the third advertising campaign may be recommended across a group of multiple websites. For example, the promotion system 100 may send a recommendation (e.g., visual prompt, selectable prompt, email, etc.) to owners of the group of websites to implement the third advertising campaign. Owners of the websites may then choose to implement the third advertising campaign (e.g., by selecting a selectable prompt). The third advertising campaign may then be implemented for such websites, consistent with the above embodiments. Method 1700 may then end at step 1799.

FIG. 18 is an exemplary flowchart of a method 1800 to generate analytics of content (e.g., various types and forms of advertisement) campaigns based on native data of a website (e.g., hosted website 250), according to some embodiments of the present disclosure. The steps of method 1800 may be performed by the promotion system 100 for purposes of illustration. It will be appreciated that the illustrated method 1800 can be altered to modify the order of steps, skip steps, and to include additional steps.

Method 1800 may begin at step 1801, and at step 1810, the promotion system 100 may collect website native data associated with a website (e.g., the hosted website 250). The native data associated with a website may reside in memory within a hosted website (e.g., the hosted website 250) or the site database 140, as discussed above. The native data may include the actions performed by a user (e.g., the website user 173) on the website or indirectly recorded by the website building system 110 based on actions performed by a content creator 182 and/or content viewer 183 on an external platform (e.g., the third-party platform 390). In some embodiments, the collection of native data may include querying a database. In some embodiments, the collection of native data may include parsing files. For example, the website building system 110 hosting a website (e.g., the hosted website 250) may parse the access log of visitors (e.g., the website user 173) to a website. The collection of native data may occur in real-time using a tracker. A tracker may be embedded in a website (e.g., the hosted website 250) that may include a unique ID, which is tracked on every action performed on the website. Some of the information related to the tracker may be stored in the website usage statistics 246.

Website native data may further include, as discussed above, web page structure data, website structure data, embedded content, label data, vertical data, search engine optimization data, post data, comment data, and transaction data.

The website native data associated with the website (e.g., the hosted website 250) may further be communications data from a communications interface of the first website, shopping cart data from a shopping cart component of the hosted website, booking data from a booking component of the hosted website, or conversion data indicating users who became paying customers of the hosted website.

In step 1820, the promotion system 100 may receive additional native data associated with the website. The additional native data associated with the website may be stored on the external platforms 180, where the content related to a website (e.g., the hosted website 250) may be generated and viewed by users of an external platform (e.g., the third-party platform 390). In some embodiments, there may be additional native data external to a third-party platform. The additional native data may be collected periodically and stored in third-party statistics 245. In some embodiments, the third-party statistics 246 may be updated in real-time.

The third-party platform 390 may be one of television, an augmented reality platform, a virtual reality platform, or a video game platform, among various others. Third-party platform 390 native data may include, for example, demographic data, impression data, click data, action data, post data, and cookie data, etc. Third-party platform 390 native data may be collected by a separate platform based on a cookie developed by the separate platform. The data further may be collected by the separate platform based on a tracking pixel (e.g., Facebook™ pixel, Google™ Tag Manager tracking code, etc.). In some embodiments, the data is collected by the separate platform based on a tracking unique identifier. In some embodiments, the third-party platform 390 may support the various non-website advertisement formats as described in connection with step 830 of method 800 above. Third-party platform 390 may, in some embodiments, generate and then distribute content.

The third-party platform 390 may support both managing and distributing and viewing content on its own platform (for example, social media sites such as Facebook™ Twitter™, etc.) or may be distributed onto other resources (for example, an advertisement exchange server supported by Google™). Third-party platform 390 may also include the capability to generate content that can be inserted into other multimedia (for example, as pre-roll, post-roll, and intermediary display, or overlay on viewable content such as videos, music, podcasts, etc.). In some embodiments, the content insertion may occur in the websites, mobile applications, and other applications in set positions or as floating overlay options (including location-based promotion, e.g., in mapping and navigation applications). The insertion of the content onto other multimedia content may be determined by the third-party platform 390 or delegated to other intermediary cache servers such as content delivery networks (CDN) or platforms hosting websites such as website building system 110. In some embodiments, the insertion of the content may be determined by the client, such as website building system 110 or the website itself. The content insertion may be pre-approved and automatic based on rules set by a website developer 172 or WBS admin 171. For example, the content insertion may be reliant on the location of the user of the content, including analysis of page layout to determine insertion position, and use of dynamic layout or responsive design to allow insertion of the content while fitting the existing layout and design. Such techniques are described in U.S. patent application Ser, No. 16/879,350 noted above. Other areas of content insertion may be in chat conversations, audio and video phone calls, and peer-to-peer networks.

In step 1830, the promotion system 100 may develop analytics regarding the performance of the campaign based on the collected and received native data. The analytics may be developed by correlating the actions performed by a user (e.g., the content creator 182 or the content viewer 183) on an external platform (e.g., the third-party platform 390) with the resultant actions in the promotion system 100. For example, the third-party platform 390 may be a social networking website, including a post generated by a user of the hosted website 250. The action performed on the hosted website 250 may be a like or comment or other actions performed on the social media platform post. Some of the users of the social media platform may visit the hosted website 250 by clicking on the post and visit one or more web pages of the hosted website 250. The actions on the hosted website 250 may also involve further viewing items in a catalog 271 associated with the hosted website 250 and placing an order for one or more items.

The example post on the social media platform described above may be generated automatically in the form of a promoted post or as an advertisement. A website developer (e.g., the website developer 172) may request one or more promotional posts to be generated and shared on the social media platform. The social media platform may then pass on the actions performed on the promotional posts by users of the social media platform. The native data on the social media platform may include all the viewers of the post and the native data on the website of those viewers who visited the website and took action, such as purchasing an item listed in the catalog and shown as part of the promotional post. The analytics generated by the website building system 110 may include the performance of the promotion post resulting in the purchase of items in the catalog listed on the website. Other analytics may include which promotional posts of different catalog items performed better or what catalog items were reviewed by the user of the website.

The website building system 110 may store the developed analytics in websites usage statistics 246. The storage of the developed analytics may be in real-time or maybe a batch process. For example, a batch program may be run every night to evaluate what promotions went well and what items to stock the next day or next week. Such analytics may also help determine changes to be made to the future promotional posts.

In some embodiments, the promotional post generated on the social media platform may be posted on another website hosted by the website building system or a different server accessible over network 160. The additional native data related to the promotional post may be passed by the other website to the social media platform. In some embodiments, the other website may directly communicate with the promotion system 100. Method 1800 may then end with step 1899.

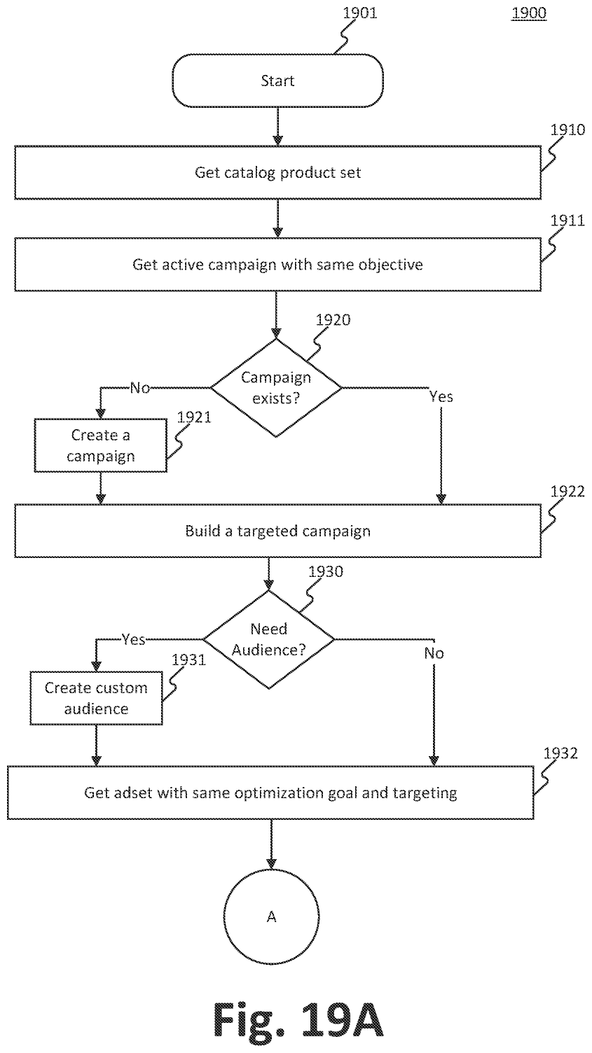

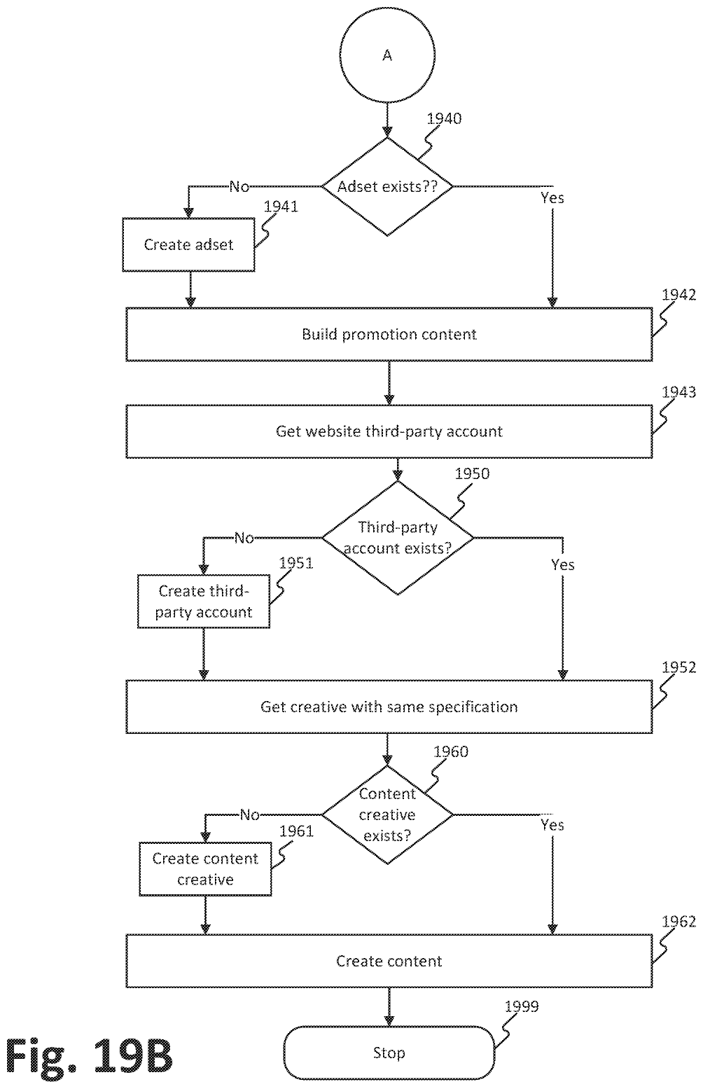

FIGS. 19A-B are an exemplary flowchart of a method 1900 to manage a promotional campaign, according to some embodiments of the present disclosure. The steps of method 1900 may be performed by the promotion system 100 and/or third-party platform 390 for purposes of illustration. It will be appreciated that the illustrated method 1900 can be altered to modify the order of steps, skip steps, and to include additional steps.

Method 1900 may begin at step 1901, and at step 1910 the promotion system 100 may obtain a catalog product set from the website content portion of a website (e.g., the hosted website 250). The promotion system 100 may aid in optimizing the campaign to generate and distribute promotional content using the external platforms 180. The catalog product set may come from catalog 271, as discussed above.

In step 1911, the promotion system 100 may review the existing and previous promotion campaigns for the website (e.g., based on an identity of a user who owns the website, or an account for the website) to identify a campaign with a matching catalog product set and campaign objective. The matching campaign objective may be determined by requesting input from the website developer 172 and the expected goals of the campaign. As discussed above, expected goals may include increasing site traffic, time spent on the site, clicks, views, downloads, subscriptions, posts, purchases, etc.

In step 1920, the promotion system 100 may determine whether a campaign with the same objective exists. The existence of a campaign may be determined by accessibility. For example, the campaign may not be accessible when it is being used by another website. In some embodiments, the campaign may have been authorized for public access.

If the answer to step 1920 is no, then method 1900 may proceed to step 1921. In step 1921, the promotion system 100 may create a campaign to meet the objective as provided by the user or identified by website building system 110 for the website to be promoted. Otherwise, method 1900 may proceed to step 1922.

In step 1922, the promotion system 100 may develop a targeted campaign by optimizing the campaign for the potential target audience. The promotion system 100 may determine the campaign optimization of various products of a third-party platform automatically (e.g., the third-party platform 390) using decision maker engine 154. For example, the promotion system 100 may optimize an advertisement campaign to promote one or more offerings (e.g., products, services, events, mailing lists, etc.) on FacebookTM products such as Instagram™, Facebook Messenger, WhatsApp™, etc. The promotion system 100 may optimize the promotion campaign for a single offering or multiple offerings through advertisements created by the third-party platform 390.

Campaign optimization may at least include determining what content associated with the offerings needs to be displayed on various media of the third-party platform 390. Campaign optimization may occur automatically using a machine learning model. The machine learning model, as discussed above, may provide feedback to the user (e.g., the website developer 172) in the form of recommendations. The promotion system 100 may optimize a campaign using a machine learning model that makes decisions based on other similar campaigns identified by another machine learning model. The optimization changes may be for a specific type of campaign, specific product, specific website vertical, specific geographic, specific season, etc. For example, the machine learning model may make recommendations for changes to a campaign or to create a new campaign for increasing the number of customers, visitors, subscribers, users, etc. In another scenario, the machine learning model may optimize the campaign to acquire a new group of customers by optimizing for the individuals who are not part of a cohort of members or subscribers of the offerings.

In some embodiments, the machine learning model may also be used for prediction. The model can predict revenues for users before starting a campaign based on other campaigns. For example, as discussed above, the machine learning model may consider other websites deemed to be similar to the website being analyzed, and may determine how such other websites performed through their advertising campaigns. Website promotion system 100 may receive such data from website building system 110 and/or third-party platform 390. Based on identifying other similar websites that have been successful in their advertising campaigns (e.g., increasing revenue), recommendations may be generated for the website being analyzed. As discussed above, the recommendations may relate to various attributes, including the advertising campaign itself. For example, a recommendation may be to include more images in advertisements, use particular colors, use videos, increase or decrease frequency, increase or decrease prices, target particular users or demographics, use particular keywords or buzzwords in advertisements, etc.

The machine learning model may also predict the costs of executing a campaign and allow WBS admin 171 to set pricing for the use of the promotion system 100 to set up a promotion campaign using website building system 110. The decision maker engine 154 may also make other campaign budget investment decisions to allocate benefits from the third-party platform 390 to the website developer 172. For example, the decision maker engine 154 may determine the best time to offer a discount in advertisements generated by the third-party platform 390, to generate and distribute content promoting offerings of a website (e.g., the hosted website 250), etc.

The machine learning model used to optimize a campaign or predict the costs and outcomes of a campaign may make determinations based on one or more input signals associated with the website (e.g., the hosted website 250) for which campaign optimization and predictions are to be made. The input signals may include an analysis of the entire website (e.g., the hosted website 250) or parts of the website (e.g., the website building elements 252, such as a store, a payment gateway, etc.). For example, information about the hosted website 250 or part of the hosted website 250 supplied to the machine learning model may include the total number of products, number of approved products to be listed on the website's store, ratio of approved products to the total number of products, total number of available products, ratio of available products to the approved products and total products, total number of new products included in the store during a set period of time before the campaign or during a campaign, number of people who added products or services to the website's shopping cart, number of people who initiated the checkout process on the website, number of people who purchased something, number of people who viewed the content, total revenue, total spend, etc.

Input signals may also include information about the hosted website 250 generated and presented on other websites and the external platforms 180. The information about the hosted website 250 on the external platforms 180 may include dedicated and/or curated pages and posts associated with the hosted website 250 or aggregations of posts by external users 181. For example, the information about the hosted website 250 posted on the external platforms 180 may include information posted on a social media platform (for example, Facebook™) such as check-ins, fan count, overall rating, rating of the dedicated page provided by the external users 181 or automatically calculated from the engagements on the dedicated page by the external users 181, number of people talking about the hosted website 250 on the Facebook™ platform using posts associated with the hosted website 250 (or mentioning the hosted website 250, or the hosted website 250's offerings or linking the website's dedicated page on the Facebook™ platform), number of visitors to the dedicated page(s) associated with the hosted website 250 or posts about the hosted website 250 or visits to the hosted website 250 from the Facebook™ platform, the total number of media resources (e.g., images, videos, and audio, etc.) posted on the dedicated page of the hosted website 250 or the posts by external users associated with the website, total number of followers of the website's dedicated page, etc. In some embodiments, the input signals to the machine learning model may include information about the hosted website 250 generated through the external platforms 180 and reside in the website building system 110. For example, the website usage statistics 246 may store the number of visitors to the hosted website 250 from the external platforms 180. The input signals to the machine learning model may also include information generated through the hosted website 250 and reside in the external platforms 180. For example, the total number of followers of a dedicated page of the hosted website 250 on the Facebook™ platform may include the website user 173 who clicked the follow button on the web pages of the website.

Information about the hosted website 250 being supplied as input signals to the machine learning model may also include data generated from previous campaigns to promote the hosted website 250 and the website's offerings. A subset of the previous campaigns with matching objectives, as described in step 1911, only may be considered in some embodiments. The data generated during the previous campaigns may include various activities performed on the website, such as viewing product and service pages, adding various offerings on a website to a shopping cart, adding payment information, completing the purchase of the offerings, reviewing the purchased offerings by providing ratings, etc. The obtained information from previous campaigns may include activities performed on the websites as a result of the campaign and all activities occurring during the campaign but may not be related to any of the previous campaigns. For example, the information obtained during the previous campaigns related to activities on the hosted website 250 may include the total number of people who added payment information during a campaign, total number of people who clicked on offerings and other resources (e.g., images, videos, web pages, forms, etc.) on the hosted website 250 during the campaign, total number of people who added comments during the campaign, total number of people who viewed the landing page of the hosted website 390, total page views of the hosted website 250 during the previous campaign. In some embodiments, the hosted website 250 activity associated with previous campaigns may also include activities that already occurred during the currently executing campaign. The information generated during the campaign based on the activities on the hosted website 250 may include the metadata generated as part of the activities.

Additionally, the machine learning model input signals of information generated during a previous or current campaign may include information generated based on activities on external platforms 180. For example, the information generated during a campaign on external platform 180 during a campaign may include the total count of posted posts (e.g., images, videos, files, text describing the website, URLs to the pages and offerings on the website, etc.) on the external platforms 180, such as Facebook™, the total count of engagements (share/reshare/retweet, comment) on posted posts, the total count of reactions (likes, dislikes) to the posts, the total count of posts saved by the external users 181 of external platforms 180, the total number of orders of the offerings on the hosted website 250 generated by clicking on the URL links to website offerings or ordering directly on the external platforms 180, etc.

In some embodiments, some of the information generated during a campaign may be based on activities that may occur either on the hosted website 250 or the external platforms 180. For example, the total number of people who added comments during the campaign may include people who added comments on the hosted website 250 or the third-party platform 390, or both. In some embodiments, the information may come from activities initiated on the external platforms 180 but end on the hosted website 250, or vice versa. The information generated during the campaign input to the machine learning model may also include data about the campaign itself. For example, input signals to the machine learning model may include the total amount of money and time spent on the promotion campaign, the total number of people reached during the campaign, etc.

In some embodiments, information during a campaign supplied to the machine learning model as input may include information about the people who were involved in the activities on the hosted website 250 during the campaign. For example, this may include the total number of people who clicked a link during the campaign, the total number of people who were converted as customers/members offsite during the campaign, the total number of people reached during the campaign, etc.

Further, the information generated during a campaign and inputted later to the machine learning model may be restricted to information specific to the campaign. For example, activities that can be identified to be due to a campaign occurring on the hosted website 250 or the external platforms 180, or initiated on one and ending on the other, may be considered to be information specific to the campaign. The association of an activity to a specific campaign may be determined by analyzing the URL parameters to determine if it is a referral link generated for the campaign. In some embodiments, a form field requesting source for the generation of activity may include a campaign name listed. Information specific to a campaign may include the total count of people who added payment information due to the campaign, total count of people who added products and/or services to the shopping cart provided by the hosted website 250 due to the campaign, total number of comments added due to the campaign, total count of people who initiated checkout due to the campaign, total count of people who viewed the landing page of a website due to the campaign, total count of link clicks due to the campaign, total count of pages engaged (e.g., liked on the external platforms 180, shared on the external platforms 180, liked on the website, etc.) due to the campaign, total count of posted posts due to the campaign, total count of engagements of posted posts on the external platforms 180 and pages of the hosted website 250 due to the campaign, total count reactions to the posted posts on the external platforms 180 due to the campaign, total count of posted posts saved due to the campaign, etc.

In some embodiments, the information generated during a campaign and/or associated with a campaign may include information targeted at a particular group of individuals. For example, the total count of products/services added to a shopping cart by omnichannel acquired customers during the campaign, total count of products/services initiated for checkout by omnichannel acquired customers during the campaign, total count of products/services purchased by omnichannel acquired customers during the campaign, total count of content viewed by omnichannel acquired customers during the campaign, total count of products/services added to the cart by omnichannel acquired customers due to the campaign, total count of products/services initiated for checkout by omnichannel acquired customers due to the campaign, total count of products/services purchased by omnichannel acquired customers due to the campaign, total count of content viewed by omnichannel acquired customers due to the campaign, etc.

Further, in some embodiments, input signals to the machine learning model may include aggregated information related to the offerings on the hosted website 250 associated with the activities occurring during or due to the campaign. For example, aggregated information of offerings during or due to a campaign may include total purchases of various offerings of the website, total value of the products/services added to a shopping cart on the hosted website 250 or the third-party platform 390 hosting the website's shopping cart, total value of products/services initiated for checkout on the hosted website 250 or the third-party platform 390 hosting the website's store, total value of products/services added to the shopping cart by omnichannel acquired customers, total value of products/services initiated for checkout by omnichannel acquired customers, total value of purchased products/services by omnichannel acquired customers, total value of viewed content by omnichannel acquired customers, return on advertisement spend from products/services purchased by omnichannel customers, total sales from a campaign, total return on campaign spend from the purchase of offerings, number of leads, number of leads who messaged, etc.

In some embodiments, the information targeted to specific individuals, or due to the campaign and the during the campaign, may be combined before supplying it as input to the machine learning model. For example, combined information may include the ratio of the total number of products sold to users acquired through a campaign to the total number of products sold during the period of the campaign, the ratio of total sales of products sold to users acquired through a campaign to the total sales during the period of the campaign, the ratio of orders attributed to the promotion campaign to the total orders during the promotion campaign period, the ratio of revenues attributed to the campaign to the total revenues generated during the campaign, the ratio of page views due to a promotion campaign versus the overall page views during a promotion campaign period, etc.

Information may also include details about the campaign during the time it was active. For example, this may include duration of campaign, campaign end date, frequency of the campaign, last timestamp of the campaign update, last timestamp of the creative update, last timestamp of targeting criteria update, the total cost per click by a user, total click-through rate, total number of impressions count, campaign balance, campaign budget cycle, campaign budget spend start and end dates, available budget for the lifetime of the campaign, etc.

In some embodiments, the information obtained from an active campaign input to the machine learning model may be based on the information provided via a tracker. For example, information obtained via tracker may include the total count of people identified by a tracking pixel who have added a delivery method, total count of people identified by the tracking pixel who have added shipping details, total count of people identified by the tracking pixel who have added payment information, total count of people identified by the tracking pixel who have added products/services to cart, total count of people identified by the tracking pixel who have clicked on a social media (e.g., Facebook™) post, total count of people identified by the tracking pixel who have initiated checkout of products/services, total count of leads identified by the tracking pixel, total count of pageviews identified by the tracking pixel, total count of people identified by the tracking pixel who purchased products/services offered by the website, total count of people identified by pixel who viewed content, etc.

Information gathered from the activities on the hosted website 250 or the external platforms 180 and associated with the hosted website 250 may be processed and then supplied as input to the machine learning model. For example, processed information supplied to the machine learning model as input may include conversion rate ranking where conversion is converting a user (e.g., the website user 173) to a member by subscribing to a mailing list or paying for a subscription, engagement rate ranking performance of a campaign against other campaigns resulting in engagements, quality ranking, the direction of performance (e.g., positive or negative or neutral/flat) of various activities on the hosted website 250 (e.g., such as orders, revenues, engagements, reactions to posts on social media, etc.), the gap between the actual performance versus expectation as predicted by the machine learning model based on previous campaigns, the slope of performance indicating the rate of change, the trend of performance indicating continuous change, improving consistently, etc. Such values may be generated before and after the current campaign or at set intervals. All this information may be supplied as input to the machine learning model to both optimize the current campaign and also predict the outcomes of the campaign.

The promotion system 100 may monitor data received from the external platforms 180 and related analytics, such as the website usage statistics 246 and third-party statistics 245. The promotion system 100 may monitor the incoming data over network 160, and generate the website usage statistics 246 and stores the access information in site database 140. Based on the website usage statistics 246, the promotion system 100 may be able to determine if a certain promotion campaign is being effective.

The promotion system 100 may employ a machine learning model to analyze the website usage statistics 246 to take further steps towards optimizing an advertising or promotional campaign and/or predicting next steps. A machine learning model part of decision maker engine 154 may, as discussed above, learn whether the performance of the campaign matches the performance of campaigns for similar websites in the past. The signals obtained in the analysis may help the machine learning model make decisions (e.g., based on training data, which may be provided in a guided training). For example, a type of promotional campaign may start to perform well starting the second day/month of the campaign. If the current campaign matches this trend, then the machine learning model may predict similar results as previously successful campaigns (e.g., where the set objectives were met or exceeded) and continue spending money on the promotion campaign. Otherwise, the campaign may be analyzed and optimized for improving the performance or dropping the campaign. The machine learning model may recommend changes to the campaign, include modifying content (such as advertisements) or the complete campaign (such as an adset) and targeting criteria. The changes to the campaign may be stored similar to changes to the website in user data 294. The modification history to the campaigns may be stored in promotion content 282 as version history along with the promotion content 282. In some embodiments, the user data 294 may be used for storing changes to the website promotional campaign.

In some embodiments, the promotion system 100 may also perform A/B tests to detect the effectiveness of the campaigns, as discussed above in various embodiments. For example, a given website (e.g., the hosted website 250) with Instagram™ and Facebook™ presence may run campaigns in both Instagram™ and Facebook™ to detect which third-party platform of the external platforms 180 positively affects sales of products/services offered on the website. The A/B test campaign may also be used to run first campaign (e.g., Instagram™ campaign) targeted at one set of people and a second campaign (e.g., Facebook™ campaign) targeted at another set of people to measure the separate effect of each campaign. The A/B test campaigns may also use browser referrer information to detect the origin of user. For example, the origin may be determined as Facebook™/Instagram™/web/Search engine (such as Google™). This way, campaigns can be related to their effect.

The machine learning model may output in a ranked manner the changes in output performance of promotional campaigns by quality, segmented by the website's social performance in various external platforms 180. Through the quality ranking process, the promotion system 100 with the aid of the machine learning model may determine and output how much more influential did the hosted web site 250 get on each of the external platforms 180 (e.g., Facebook™ and/or Instagram™). The machine learning model may also determine and present how to further improve the brand value of the website in Facebook™ and/or InstagramTM. Such improvement may include parameters such as the number of followers (which also has a considerable value) in addition to actual sales arriving from each source provided to be supplied through the parameter interface 472 to improve the website's brand. The improvement in the website's brand may include the improvement of rating on the third-party platform 390. In some embodiments, the machine learning model of the promotion system 100 may also obtain information from offline sources by tracking activities originating from those offline sources. For example, tracking activities may include click-to-call which may cause an offline sale or lead.

In step 1930, the promotion system 100 may determine the audience that was reached by the matching promotional campaign. If there was no such campaign identified in step 1920, then there may be no matching audience, and there may be a need for the audience. If there is no need for the audience then the method 1900 may jump to step 1932.

If the answer to step 1930 is yes, then the method 1900 may proceed to step 1931. In step 1931, the promotion system 100 may create a hypothetical audience based on website usage statistics 246. The website usage statistics 246 may determine the types of users (e.g., the website user 173) who access the website (e.g., the hosted website 250). Members of third-party platform 390 matching the users of the website may be identified as the initial target audience.

In step 1932, the promotion system 100 may access the website third-party data 253 to determine the target parameters (e.g., the targeting parameters 281) associated with the matching promotion campaign content (e.g., the promotion content 282). The obtained promotional content may be considered as the adset with the same optimization goal and targeting. If the audience was created in the previous step, then a matching campaign may need to be obtained before identifying the adset (e.g., the promotion content 282) with the same optimization goal and targeting.

In step 1940, the promotion system 100 may check if an adset exists. An adset, consistent with above embodiments, may be a collection of promotional content generated collectively to achieve the objective identified in step 1921. For example, for a particular business, this may include image-based advertisements, video-based advertisements, and social media posts, among other options.

If the answer in step 1940 is no, then method 1900 may proceed to step 1941. In step 1941, the promotion system 100 may create an adset by collecting promotional content from promotional content 282, which matches the target audience. The target audience may include the individuals who interacted with the promotion content (e.g., the content viewer 183) or who are part of advertisement targeting criteria specified by the user, as discussed above in various embodiments.

In step 1942, the promotion system 100 may build promotion content using the collection of content identified either in steps 1932 or 1941. As discussed above, the promotional content may take various different forms and be rendered in various different media.

In step 1943, the promotion system 100 may request access to third-party platform 390 account details to create promotional content. The website building system 110 may look up account details based on, for example, authentication information 292. The authentication information 292 may include user credentials, as discussed above. In some embodiments, a certificate to access third-party platform 390 services may have been provided. The website building system 110 may need to verify the status of the certificate. In some embodiments, the website building system 110 may need to verify with the third-party platform 390 to determine the access authorization status of a website developer (e.g., the website developer 172) to request the creation of promotional content for a campaign.

In step 1950, the promotion system 100 may determine the existence of the account to access the third-party platform 390 as described in step 1943. If the answer to this determination is yes, then the method 1900 may jump to step 1952.

If the answer in step 1950 is no, then the method 1900 may proceed to step 1951. In step 1951, the promotion system 100 may request the creation of an account on the third-party platform 390. The account creation request may be accessed using an interface (such as external platform interface 380) as discussed above in connection with FIG. 3. The account creation request may involve the use of a graphical user interface for the website developer 172 to make the request.

In step 1952, the promotion system 100 may request for accessing the creative that matches the creative of a similar campaign identified in step 1911. The creative may be metadata describing the promotional content. The creative may include URLs of the images, video, and audio to be included in the promotional campaign content. The creative may also include visual attributes such as the positioning of the promotional content on the third-party platform 390 and other websites. The creative for the similar promotional campaign content may be stored along with promotional content 282.

In step 1960, the promotion system 100 may determine if the requested creative in the previous step 1952 exists. The determination may involve authorization to access the creative. In some embodiments, the creative may be restricted to certain website developers and/or certain periods of time. The creative may be locked for updates based on new determinations made by a machine learning model defined in step 1952. In some embodiments, the matching campaign's creative may have been marked for improvement based on recent failure when using the same campaign creative. The matching campaign may not have enough usage to be trusted. If in one of these and other potential scenarios the creative is accessible, then method 1900 may jump to step 1962.

If the answer to step 1960 is no, the method 1900 may proceed to step 1961. In step 1961, the promotion system 100 may create a creative for the promotional campaign content. The generated creative may be stored in website third-party data 253.

In step 1962, the promotion system may request the third-party platform 390 to create content using the creation interface 471. The promotion system 100 may provide the creative obtained in either step 1960 or 1961 to generate the content and begin the campaign. Method 1900 may then end with step 1999.

Various operations or functions are described herein, which may be implemented or defined as software code or instructions. Such content may be directly executable (“object” or “executable” form), source code, or difference code (“delta” or “patch” code). Software implementations of the embodiments described herein may be provided via an article of manufacture with the code or instructions stored thereon, or via a method of operating a communication interface to send data via the communication interface. A machine or computer readable storage medium may cause a machine to perform the functions or operations described and includes any mechanism that stores information in a form accessible by a machine (e.g., computing device, electronic system, and the like), such as recordable/non-recordable media (e.g., read only memory (ROM), random access memory (RAM), magnetic disk storage media, optical storage media, flash memory devices, and the like). A communication interface includes any mechanism that interfaces to any of a hardwired, wireless, optical, and the like, medium to communicate to another device, such as a memory bus interface, a processor bus interface, an Internet connection, a disk controller, and the like. The communication interface can be configured by providing configuration parameters and/or sending signals to prepare the communication interface to provide a data signal describing the software content. The communication interface can be accessed via one or more commands or signals sent to the communication interface.

The present disclosure also relates to a system for performing the operations herein. This system may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CDROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Embodiments of the present disclosure may be implemented with computer executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

Computer programs based on the written description and methods of this specification are within the skill of a software developer. The various programs or program modules can be created using a variety of programming techniques. For example, program sections or program modules can be designed by means of JavaScript, Scala, Python, Java, C, C++, assembly language, or any such programming languages, as well as data encoding languages (such as XML, JSON, etc.), query languages (such as SQL), presentation-related languages (such as HTML, CSS, etc.) and data transformation language (such as XSL). One or more of such software sections or modules can be integrated into a computer system, non-transitory computer readable media, or existing communications software.

The words “comprising,” “having,” “containing,” and “including,” and other similar forms are intended to be equivalent in meaning and be interpreted as open ended, in that, an item or items following any one of these words is not meant to be an exhaustive listing of such item or items, or meant to be limited to only the listed item or items. In addition, the singular forms “a,” “an,” and “the” are intended to include plural references, unless the context clearly dictates otherwise.

Having described aspects of the embodiments in detail, it will be apparent that modifications and variations are possible without departing from the scope of aspects of the invention as defined in the appended claims. As various changes could be made in the above constructions, products, and methods without departing from the scope of aspects of the invention, it is indented that all matter contained in the above description and shown in the accompanying drawings shall be interpreted as illustrative and not in a limiting sense.

What is claimed is:

1. A website building system configured for analyzing and recommending improvements for structural attributes of websites, the website building system comprising:
one or more website building databases storing at least:
a plurality of website building elements, and
a plurality of website design rules; and
one or more processors configured to execute software instructions to perform operations for analyzing the structural attributes of websites and developing recommendations for the websites, the operations comprising:
hosting a first website, the first website being built based on at least a subset of the plurality of website building elements and a subset of the plurality of website design rules,
identifying a plurality of structural attributes of the first website,
identifying a vertical or template associated with the first website, and
developing a recommended change to the first website based on the plurality of structural attributes of the first website and the vertical or template associated with the first website.

2. The website building system of claim 1, wherein the operations further comprise accessing a structural attributes database storing pluralities of verticals or templates and corresponding pluralities of structural attributes.

3. The website building system of claim 1, wherein the plurality of structural attributes of the first website includes at least one of: a landing page, a contact page, a feedback page, a questions page, a press release page, a real-time communications interface, fillable form content, shopping cart data, text content, image content, or video content.

4. The website building system of claim 1, wherein the plurality of structural attributes of the first website includes at least one of: backend code, backend site profile information, a backend database, calendar data, schedule data, catalog data, or search engine optimization metadata or keywords.

5. The website building system of claim 1, wherein the recommended change includes modifying search engine optimization metadata or keywords for the first website.

6. The website building system of claim 1, wherein the recommended change includes adding, removing, or modifying content to the first website.

7. The website building system of claim 1, wherein the content includes at least one of: textual elements, graphical elements, video elements, layout formats, color formats, background formats, or the plurality of structural attributes.

8. The website building system of claim 1, wherein the recommended change includes adding a web page to the first website.

9. The website building system of claim 1, wherein the recommended change includes adding a communications interface to the first website.

10. The website building system of claim 1, wherein the recommended change is developed based on application of an artificial intelligence algorithm.

11. The website building system of claim 1, wherein the recommended change is developed based on a date and/or time.

12. A non-transitory computer readable medium including instructions that, when executed by at least one processor, cause the at least one processor to perform operations for analyzing and recommending improvements for structural attributes of websites, the operations comprising:
hosting a first website, the first website being built based on at least a subset of the plurality of website building elements and a subset of the plurality of website design rules,
identifying a plurality of structural attributes of the first website,
identifying a vertical or template associated with the first website, and
developing a recommended change to the first website based on the plurality of structural attributes of the first website and the vertical or template associated with the first website.

13. A computer-implemented method for analyzing and recommending improvements for structural attributes of websites, the method comprising:
hosting a first website, the first website being built based on at least a subset of the plurality of website building elements and a subset of the plurality of website design rules,
identifying a plurality of structural attributes of the first website,
identifying a vertical or template associated with the first website, and
developing a recommended change to the first website based on the plurality of structural attributes of the first website and the vertical or template associated with the first website.

14. The computer-implemented method of claim 13, further comprising accessing a structural attributes database storing pluralities of verticals or templates and corresponding pluralities of structural attributes.

15. The computer-implemented method of claim 13, wherein the plurality of structural attributes of the first website includes at least one of: a landing page, a contact page, a feedback page, a questions page, a press release page, a real-time communications interface, fillable form content, shopping cart data, text content, image content, or video content.

16. The computer-implemented method of claim 13, wherein the plurality of structural attributes of the first website includes at least one of: backend code, backend site profile information, a backend database, calendar data, schedule data, catalog data, or search engine optimization metadata or keywords.

17. The computer-implemented method of claim 13, wherein the recommended change includes modifying search engine optimization metadata or keywords for the first website.

18. The computer-implemented method of claim 13, wherein the recommended change includes adding, removing, or modifying content to the first website.

19. The computer-implemented method of claim 13, wherein the content includes at least one of: textual elements, graphical elements, video elements, layout formats, color formats, background formats, or the plurality of structural attributes.

20. The computer-implemented method of claim 13, wherein the recommended change includes adding a web page to the first website.
